(19) United States
(12) Patent Application Publication
(10) Pub. No.: US 2024/0352214 A1
(43) Pub. Date: Oct. 24, 2024

(54) SYSTEM AND METHOD OF USING ENZYMES TO BREAK DOWN BIOPLASTICS IN A FOOD RECYCLER

(71) Applicant: Food Cycle Science Corporation, Cornwall (CA)

(72) Inventors: Matthew HOEKSTRA, Ottawa (CA); Myron L. SMITH, Ottawa (CA); Ali Hazem Shukri, Ottawa (CA)

(21) Appl. No.: 18/640,678

(22) Filed: Apr. 19, 2024

Related U.S. Application Data
(60) Provisional application No. 63/497,547, filed on Apr. 21, 2023.

(51) Int. Cl. C08J 11/10; B09B 3/35; B09B 3/60

(52) U.S. Cl. CPC C08J 11/105; B09B 3/35; B09B 3/60

(57) ABSTRACT

A waste recycler includes a processer; a vessel such as a bucket; a temperature control element; and a computer-readable storage medium storing instructions which, when executed by the processor, cause the processor to be configured to: receive an indication that an enzyme will be added to the vessel for processing waste in the vessel; select an enzyme-mediated waste processing cycle for processing the waste; and process, via the temperature control element, the waste and the enzyme in the vessel according to the enzyme-mediated waste processing cycle. Hydrolase enzymes are effective for use in waste or food recyclers. The waste processing cycle can be modified to include a pre-treatment phase, a specific temperature at a specific time to enable the enzyme to operate or denature the enzyme right before ending the cycle. Air flow changes and timing changes can be made as well to the cycle.

### PRIORITY CLAIM

The present application claims priority to U.S. Provisional Patent Application No. 63/497,547, filed on Apr. 21, 2023, the content of which is incorporated herein by reference.

### CROSS-REFERENCE TO RELATED APPLICATIONS

The present application is related to application Ser. No. 16/868,482, filed on May 6, 2020, and application Ser. No. 17/404,017, filed on Aug. 17, 2021, the contents of which are incorporated herein by reference.

### TECHNICAL FIELD

The present disclosure relates to recyclers and particularly to a design or system that enables a recycler to process not only food waste but bioplastics as well. Various aspects of a buffer/enzyme pouch embodiment as well as enzyme delivery systems being incorporated into recyclers are disclosed. The enzymes break down the bioplastics as part of an enzyme-mediated degradation recycling process that can include processing food waste. A waste recycler can include an enzyme in a vessel with waste that may or may not include an enzyme-mediated degradation recycling process to degrade parts of the waste during the recycling process. Modified enzymes and thermally stable enzymes are also disclosed as well as new processing cycles for the recycler when enzymes are present.

### BACKGROUND

Food recycling has become a positive activity in our society. Processing waste food in the traditional sense typically means simply throwing the food away and having it with other trash simply transported to a landfill. If waste food could be processed and broken down on site (i.e., the location where the food was prepared or consumed and where the waste food was thus generated), the resulting by product can be put in a garden or used for other purposes. The broken-down byproduct is much easier to transport and is essentially organic dirt. Many food recycling devices are being produced and used that grind down food and remove the water content of the food as part of its process. However, processing waste food still requires energy and physical appliances that receive the waste food and generate the byproduct.

Additionally, people throw away a large amount of plastic such as plastic bottles for water or other beverages. Typically, these plastic products are not put into a food recycler since they are not food and the recycling process for food recyclers is not designed to process plastics.

### BRIEF SUMMARY

This disclosure addresses the issues in the prior art and discloses a new use for enzymes that can break down one or more of food waste and bioplastics as well as other materials such as other types of plastics and fats, oils and grease. What is needed in the art of food recyclers is a new framework that incorporates the use of enzymes the enable the degradation of one or more of plastics, and fats, oils and grease (FOGs). This disclosure describes several different examples of such innovations as new food recyclers that include processing cycles configured to be adaptive to the use of enzymes to break down one or more component in addition to food waste. For example, a preprocessing time at a certain temperature may be provided to enable the enzyme in a bucket of food waste and plastics to break down the plastics before starting the traditional grinding and/or heating cycle to process the food waste. Any one of a temperature and a time associated with a waste processing cycle can be adjusted when an enzyme is included. Novel enzymes themselves are also disclosed which include characteristics for breaking down one or more types of plastic, fats, oils and grease as well as having thermal stability characteristics such that they enzyme does not denature during a heating portion of a processing cycle.

Furthermore, various delivery systems and uses of the enzymes are disclosed such as a pod or pouch that contains a cavity for a buffer solution or an anhydrous material and a cavity that contains an enzyme solution or lyophilized enzyme. The enzyme may be in solution or in a pellets/powder form to allow for better storage and handling conditions. The enzyme may be in pellet form in some aspects. The pod or pouch can be placed within a recycler that contains bioplastics as well as food waste. Then the recycling process can recycle all the material in a batch of food waste and bioplastics. There are various embodiments that are covered in this disclosure including an embodiment to a pod or pouch itself, processes that are performed by the recycling device or system to incorporate features associated with adding the ability to process bioplastics as well as additional changes to recycling device structures that incorporate enzyme delivery systems as part of a recycling process.

In some aspects, the techniques described herein relate to a waste recycler including: at least one processer; a vessel; a temperature control element; and a computer-readable storage medium storing instructions which, when executed by the at least one processor, cause the at least one processor to be configured to: receive an indication that an enzyme will be added to the vessel for processing waste in the vessel; select an enzyme-mediated waste processing cycle for processing the waste; and process, via the temperature control element, the waste and the enzyme in the vessel according to the enzyme-mediated waste processing cycle.

In some aspects, the techniques described herein relate to a method of operating a waste recycler that receives an enzyme in a vessel containing waste, wherein the enzyme causes a breakdown of at least part of the waste in the vessel, the method including: receiving an indication that an enzyme will be added to the vessel for processing waste in the vessel; selecting an enzyme-mediated waste processing cycle for processing the waste; and processing, via a temperature control element of the waste recycler, the waste and the enzyme in the vessel according to the enzyme-mediated waste processing cycle.

In some aspects, the techniques described herein relate to a waste recycler including: at least one processer; a vessel; a temperature control element; and a computer-readable storage medium storing instructions which, when executed by the at least one processor, cause the at least one processor to be configured to: determining, based on an indication, an enzyme-mediated waste processing cycle for processing a waste in the vessel, the vessel containing an enzyme of a hydrolase enzyme class; and process, via the temperature control element, the waste and the enzyme in the vessel according to the enzyme-mediated waste processing cycle.

In some aspects, the techniques described herein relate to a waste recycler including: at least one processer; a vessel; a temperature control element; and a computer-readable storage medium storing instructions which, when executed by the at least one processor, cause the at least one processor to be configured to: receive an indication that an enzyme will be added to the vessel for processing waste in the vessel; and process, via the temperature control element, the waste and the enzyme in the vessel according to an enzyme-mediated waste processing cycle that manages a temperature of the waste to cause the enzyme to denature at a completion of the enzyme-mediated waste processing cycle.

In some aspects, the techniques described herein relate to a method of managing a waste recycler having a vessel and a temperature control element, the method including: receiving an indication that an enzyme will be added to the vessel for processing waste in the vessel; and processing, via the temperature control element, the waste and the enzyme in the vessel according to an enzyme-mediated waste processing cycle that manages a temperature of the waste to cause the enzyme to denature at a completion of the enzyme-mediated waste processing cycle.

In some aspects, the techniques described herein relate to a waste recycler including: at least one processer; a vessel; a hydrolase enzyme; and a computer-readable storage medium storing instructions which, when executed by the at least one processor, cause the at least one processor to be configured to: process waste in the vessel according to a waste processing cycle, wherein the waste includes the hydrolase enzyme.

In some aspects, the techniques described herein relate to a pod or pouch including: a first cavity defined by a first material and containing a buffer solution or an anhydrous material; and a second cavity defined by a second material and containing an enzyme solution or a lyophilized enzyme that breaks down bioplastics, wherein the first material and the second material are configured to release the buffer solution or the anhydrous material and the enzyme solution or the lyophilized enzyme according to a food recycling process implemented in a food recycler.

Other additives could also be put in the first cavity such as the co-factors (e.g. calcium chloride) in with the buffer in the first cavity. The first cavity may also hold an anhydrous material as well. Reference to the “buffer solution” as used herein can also mean a buffer solution or an anhydrous material.

In some aspects, the techniques described herein relate to a pod, wherein the food recycling process includes a heating portion and wherein the first cavity and the second cavity release the buffer solution or the anhydrous material and the enzyme solution or the lyophilized enzyme according to heat applied in the heating portion of the food recycling process.

In some aspects, the techniques described herein relate to a pod, wherein the food recycling process includes a grinding portion and wherein the first cavity and the second cavity release the buffer solution or the anhydrous material and the enzyme solution or the lyophilized enzyme according to when the grinding portion of the food recycling process begins.

In some aspects, the techniques described herein relate to a pod, wherein first materials dissolves to release the buffer solution or the anhydrous material at a different time that the second material dissolves to release the enzyme solution.

In some aspects, the techniques described herein relate to a pod, wherein the first cavity contains between 1-20 cm² of buffer solution or anhydrous material and the second cavity contains between 1-20 cm² of enzyme solution.

In some aspects, the techniques described herein relate to a method including: receiving, in a bucket of a recycler, a hydrolytic pouch including a first cavity containing a buffer solution or an anhydrous material and a second cavity containing an enzyme solution; receiving food waste in the bucket of the recycler; receiving bioplastics in the bucket of the recycler; causing the hydrolytic pouch to release the buffer solution or the anhydrous material and the enzyme solution or the lyophilized enzyme into the bucket; breaking down the bioplastics via the enzyme solution; and processing the bioplastics and the food waste in the bucket of the recycler according to a processing algorithm.

In some aspects, the techniques described herein relate to a method, further including receiving user input via a user interface of the recycler and wherein the processing of the bioplastics is performed according to data received from a user via the user interface.

In some aspects, the techniques described herein relate to a method, wherein the processing algorithm is modified based on the receiving of the bioplastics in the bucket of the recycler.

In some aspects, the techniques described herein relate to a method including: receiving, in a bucket of a recycler, waste; determining from a sensor configured in the recycler that at least a portion of the waste includes bioplastics; causing, based on the inclusion of the bioplastic in the bucket and via a control system of the recycler, a release into the bucket of an enzyme solution or a lyophilized enzyme stored in a container configured within the recycler; breaking down the bioplastics in the bucket via the enzyme solution; and processing the bioplastics in the bucket of the recycler according to a processing algorithm.

In some aspects, the techniques described herein relate to a method, further including: modifying the processing algorithm based on the determining that the bioplastics are found in the bucket.

In some aspects, the techniques described herein relate to a method, further including: causing, based on the determining that the bioplastics are found in the bucket and via the control system of the recycler, a release into the bucket of a buffer solution or an anhydrous material stored in a buffer container configured within the recycler.

In some aspects, the techniques described herein relate to a recycler including: a processer; a computer-readable storage device; a bucket; a grinding mechanism configured within the bucket; a heating element; a storage container containing an enzyme solution; and a sensor connected to the processor, wherein the computer-readable storage device stores instructions for controlling the processor to perform operations including: determining from the sensor configured in the recycler that at least a portion of a waste deposited in the bucket includes bioplastics to yield a determination; causing, based on determination indicating the bioplastics are in the bucket, a release into the bucket of an enzyme solution or a lyophilized enzyme stored in the storage container such that the bioplastics in the bucket are broken down by the enzyme solution; and processing, via the grinding mechanism and the heating element, the bioplastics in the bucket of the recycler according to a processing algorithm.

In some aspects, the techniques described herein relate to a method including: receiving data indicating that bioplastics are included in a batch of waste received in a bucket of a recycler; modifying, based on the data, a food recycling algorithm stored in a control system of the recycler to yield a modified recycling algorithm; causing, based on the modified recycling algorithm, a release into the bucket of an enzyme solution or a lyophilized enzyme stored in a container configured within the recycler, the enzyme solution or the lyophilized enzyme causing a breakdown of the bioplastics in the bucket; and processing the bioplastics in the bucket of the recycler according to the modified recycling algorithm.

In some aspects, the techniques described herein relate to a method, wherein the data is received from a user via a user interface or sensed via a sensor configured in the recycler.

In some aspects, the techniques described herein relate to a method, further including: causing, based on the modified recycling algorithm, a release into the bucket of a buffer solution or an anhydrous material stored in a second container configured within the recycler.

In some aspects, the techniques described herein relate to a method, wherein the container is configured in one of a lid of the recycler and a housing of the recycler.

In some aspects, the techniques described herein relate to a method, wherein a control system in the recycler causes an enzyme delivery system to release the enzyme solution.

In some aspects, the techniques described herein relate to a system including: a processer; a computer-readable storage device; a bucket; a grinding mechanism configured within the bucket; and a storage container containing an enzyme solution, wherein the computer-readable storage device stores instructions for controlling the processor to perform operations including: receiving data indicating that bioplastics are included in a batch of waste received in a bucket of a recycler; modifying, based on the data, a food recycling algorithm stored in a control system of the recycler to yield a modified recycling algorithm; causing, based on the modified recycling algorithm, a release into the bucket of one or more of a buffer solution or an anhydrous material and an enzyme solution or a lyophilized enzyme stored in the storage container, the enzyme solution or the lyophilized enzyme causing a breakdown of the bioplastics in the bucket; and processing the bioplastics in the bucket of the recycler according to the modified recycling algorithm.

In some aspects, the techniques described herein relate to a system, wherein the storage container is configured within one of a lid of the system and a housing of the system.

In some aspects, the techniques described herein relate to a system, wherein the modified recycling algorithm causes the system to process waste including food waste and the bioplastics in the bucket.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

In order to describe the manner in which the above-recited and other advantages and features of the disclosure can be obtained, a more particular description of the principles briefly described above will be rendered by reference to specific examples thereof which are illustrated in the appended drawings. Understanding that these drawings depict only exemplary embodiments of the disclosure and are not, therefore, to be considered to be limiting of its scope. The principles herein are described and explained with additional specificity and detail through the use of the accompanying drawings in which:

FIG. 1 illustrates an example food recycler with an enzyme delivery, in accordance with some aspects of this disclosure.

FIG. 2 illustrates a spectrophotometric-based assay to quantify relative bioplastic degradation, in accordance with some aspects of this disclosure.

FIG. 3 illustrates a standard curve for quantification of bioplastic degradation using the spectrophotometric-based assay, in accordance with some aspects of this disclosure.

FIG. 4 illustrates various activities of various enzymes on degrading bioplastics in vitro, in accordance with some aspects of this disclosure.

FIG. 5 illustrates various analysis of various enzymes incubation time response to degrading bioplastics, in accordance with some aspects of this disclosure.

FIG. 6 illustrates microscopy images of enzyme-mediated degraded bioplastics, in accordance with some aspects of this disclosure.

FIG. 7 illustrates a quantification of a number of holes detected on bioplastic per a set area based on enzyme treatment, in accordance with some aspects of this disclosure.

FIG. 8 illustrates the effects of temperature and enzymes, and presence of co-factors and enzymes on the degradation of bioplastic, in accordance with some aspects of this disclosure.

FIG. 9A illustrates enzyme-mediated bioplastic degradation in the presence of various foods, in accordance with some aspects of this disclosure.

FIG. 9B illustrates degradation of food waste and a bioplastic for a period of time where enzyme degradation is used following a standard waste processing cycle, in accordance with some aspects of this disclosure.

FIG. 9C illustrates a period of time used for enzyme-mediated degradation followed by a standard waste processing cycle, in accordance with some aspects of this disclosure.

FIG. 9D illustrates use of a lipase MHA to degrade bioplastic in the presence of food waste, in accordance with some aspects of this disclosure.

FIG. 9E illustrates the application of lipase for temperature optimization while degrading bioplastic, in accordance with some aspects of this disclosure.

FIG. 9F illustrates the use of lipase MHA and bioplastics for temperature optimization, in accordance with some aspects of this disclosure.

FIG. 9G illustrates the use of a lipase MHA to evaluate loss in PHB-based bioplastic mass, in accordance with some aspects of this disclosure.

FIG. 10A illustrates data in a graph for lipase AY degradation of olive oil using a fats, oils and grease assay, according to some aspects of this disclosure.

FIG. 10B illustrates using a fats, oils and grease assay in an enzyme-mediated fats, oils, and grease (FOG) degradation graph for lipase AY degradation of food waste with fat, oil and/or grease content, according to some aspects of this disclosure.

FIG. 10C illustrates a lipase AY treatment of food waste with fat content waste graph for 15 grams of food with a comparison of no enzyme treatment and enzyme treatment and the reduction in FOGs, according to some aspects of this disclosure.

FIG. 10D illustrates a one gram graph that compares lipase AY treatment of food waste with fat content d waste with a comparison of no enzyme treatment and enzyme treatment, according to some aspects of this disclosure.

FIG. 10E illustrates a FOG degrading enzyme optimization related to buffer amount graph, according to some aspects of this disclosure.

FIG. 10F illustrates a FOG degrading enzyme optimization related to temperature graph, according to some aspects of this disclosure.

FIG. 10G illustrates an effect of calcium on lipase AY activity graph, according to some aspects of this disclosure.

FIG. 10H illustrates an incubation time graph that relates to FOG degrading enzyme optimization, according to some aspects of this disclosure.

FIG. 10I illustrates a graph of relative absorption over time for lipase MHA at 80° C., according to some aspects of this disclosure.

FIG. 10J illustrates a graph of a standard cure to detect olive oil with oil red, in accordance with some aspects of this disclosure.

FIG. 11A illustrates the example pouch, in accordance with some aspects of this disclosure.

FIG. 11B illustrates the example pouch with a side view, in accordance with some aspects of this disclosure.

FIG. 11C illustrates the internal structure of an example pouch, in accordance with some aspects of this disclosure.

FIG. 12 illustrates an example processing cycle for processing food waste plus one or more of a biodegradable plastic, and non-biodegradable plastic, fats, oils and grease, in accordance with some aspects of this disclosure.

FIG. 13 illustrates an example method, in accordance with some aspects of this disclosure.

FIG. 14 illustrates an example method related to the use of a sensor, in accordance with some aspects of this disclosure.

FIG. 15 illustrates an example method related to using a modified algorithm, in accordance with some aspects of this disclosure.

FIG. 16A illustrates an example method related to temperature control, in accordance with some aspects of this disclosure.

FIG. 16B illustrates an example method relative to airflow control, in accordance with some aspects of this disclosure.

FIG. 17 illustrates an example method, in accordance with some aspects of this disclosure.

FIG. 18 illustrates an example method, in accordance with some aspects of this disclosure.

FIG. 19 illustrates an example system for use in a waste recycler, in accordance with some aspects of this disclosure.

### DETAILED DESCRIPTION

This disclosure introduces new waste recyclers that can accommodate the inclusion of non-food items such as plastics, fats, oils and grease and associated enzymes that break down such non-food items. In some cases, the waste recyclers can adjust waste processing cycles in view of the use of enzymes to improve their performance of the waste. Certain enzymes exist that start the process of breaking down plastics for example in a landfill. Examples of such enzymes include hydrolytic enzymes that can be referred to as a hydrolase which is an enzyme that catalyzes the hydrolysis of a particular substrate. These enzymes split different groups of biomolecules such as esters, peptides and glycosides. Hydrolytic enzymes break down protein, lipids, nucleic acids, carbohydrate and fat molecules into their simplest units.

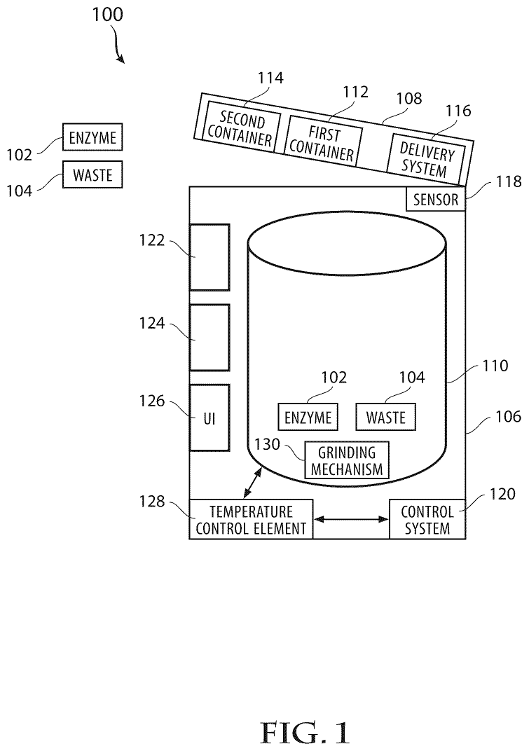

Generally, candidate enzymes for use in food recyclers or waste recyclers have been either isolated from bacteria associated with bioplastics in landfills, or are hydrolases shown to have ‘off-target’ activity towards bioplastics because of chemical structure-based homology with their natural substrates. For example, PLA (polylactic acid or polylactide) depolymerase is an enzyme isolated from soil samples in Japan that was shown to degrade bioplastics such as PLA and PBSA (poly butylene succinate-co-butylene adipate). Enzymes shown to have off-target activity towards pure bioplastics include cutinase-like enzymes, proteinase K, proteases, esterases and lipases. These are just example enzymes that can apply to the concepts disclosed herein. Other enzymes now existing or created in the future can apply as well. Hydrolase enzymes have been shown by the inventors to be more effective in a food recycler such as waste recycler 100 shown in FIG. 1 relative to other types of enzymes such as oxidoreductases, transferases, lyases, isomerases, and ligases. These other types of enzymes may or may not be efficient or work well within the environment of waste processing in the waste recycler 100.

Disclosed herein are various aspects or examples of waste recyclers and enzymes as well as enzymes that are modified to provide new or additional characteristics particularly with respect to their use in waste recyclers. The term “waste recycles” is also used specifically to avoid the concept that unit is used only to process waste food. As noted herein, there is a need to also provide processing for plastics (biodegradable plastics, compostable plastics, petroleum plastics, one-use plastics, or other plastics), as well as fats, oils and grease which can be associated with waste food. This disclosed focuses generally on various enzyme-mediated degradation of materials as part of a waste recycling process.

In some cases, these enzymes can increase the rate at which a bioplastic degrade. However, what is needed in the art is an improved waste recyclers that have a waste recycling process that combines food waste (which can include fats, oils and/or grease) and bioplastics (or other types of plastics) through the use of a new algorithm and infrastructure in a recycler to enable it to receive not only food waste but also these other materials. Different approaches to applying enzymes to the plastics can be provided such that both the food waste and the bioplastics can be processed and broken down into a byproduct through the use of the recycler.

FIG. 1 illustrates an example waste recycler 100 and enzyme 102 and waste 104. The waste recycler 100 includes a waste recycler housing 106 and a waste recycler lid 108 and a bucket 110. The waste 104 is a broad term that represents at least some non-food material and which can include plastics whether biodegradable or traditional plastics and can also include fats, oils and/or grease. Typically, the use of an enzyme 102 in a waste processing cycle of the waste recycler 100 indicates that the waste 104 includes some materials that would be desirable to break down or degrade via the application of the enzyme 102. The enzyme 102 can be a standard enzyme chosen for a particular purpose, a modified or chemically-engineered enzyme to be thermally stable and/or more efficient in breaking down a certain material and can include other components or additives such as calcium chloride or a buffer. The enzyme 102 can be an enzyme or an enzyme solution or a lyophilized enzyme that can include other components that can improve the degradation capability or efficiency of the enzyme and/or can include or improve on a thermal stability of the enzyme 102. In some cases, the reference to the enzyme 102 can also include the use of a buffer or buffer solution or an anhydrous material as described herein.

When non-food waste items are present in the bucket 110, and the enzyme 102 is also included in the bucket 110, then a waste processing cycle can be altered, modified or chosen to adjust for the additional time or changes to be made to enable the enzyme to degrade the non-food waste items which again can include plastics of various types, fats, oils, grease and so forth. The existence of the enzyme can be indicated through input from a user via a user interface 126 or determined by a sensor 118 on the waste recycler 100.

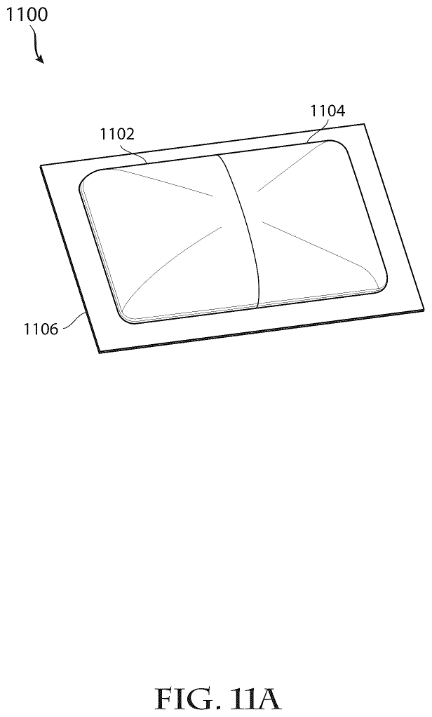

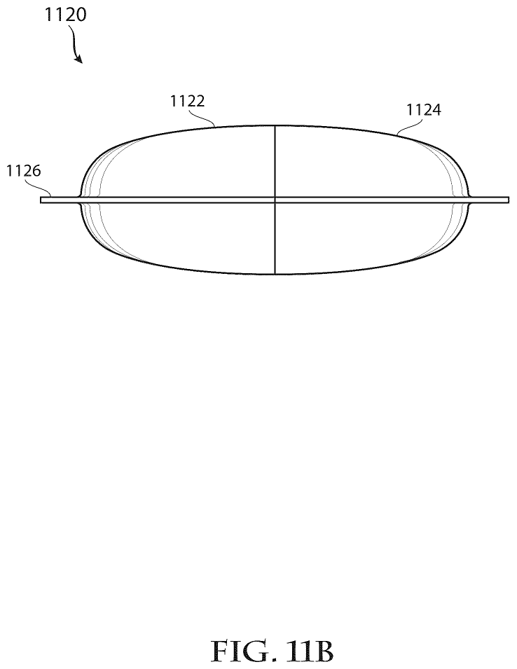

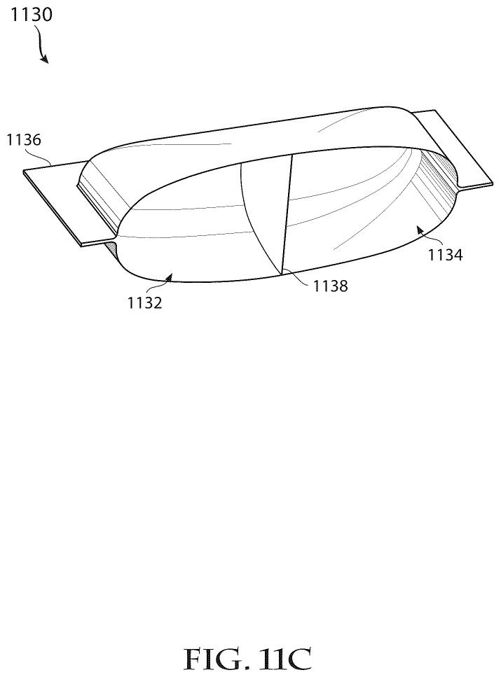

In one example, the heat that is used in the waste recycler process can cause the enzymes to be released in a certain way or at a certain time. For example, the waste recycler 100 of FIG. 1 may have a process in which it first heats the waste for 20 minutes before grinding the waste. The enzyme 102 can be configured in a pouch (such as hydrolytic pouch 1100 in FIG. 11A) with a cover or pouch container 1106 that maintains the integrity of the pouch for 10 minutes of heating before the exterior material breaks down and releases the enzymes. The hydrolytic pouch 1100 may have a different release time for the buffer storage side relative to the enzyme storage side. The release timing may be related to when the grinding or stirring portion of the recycling process occurs. In other words, different hydrolytic pouches 1100 may be developed for different algorithms of different recyclers which can simply match or complement or be operative with their existing food recycling process.

In other cases, the user interface 126 may simply be a button and a user may indicate that they are adding an enzyme 102 to the bucket 110 or vessel as part of the process. A control system 120 may control a temperature control element 128 that can increase heat or decrease the heat of the waste 104 in the bucket 110 depending on whether a portion of a waste processing cycle is to enable the enzyme to work or is to denature the enzyme 102 at the end of a waste processing cycle, for example.

The waste recycler 100 can be defined as simply including an enzyme 102. A user may take the enzyme 102 (which can be configured in a hydrolytic pouch 1100 or directed added to waste 104) and place it within a bucket 110 of the waste recycler 100. The bucket 110 also can be represented as any vessel such as a flexible container, a plastic container, or any other container of any shape that can be associated with the waste recycler 100. The figure illustrates the basic operation of using an enzyme 102 in connection with waste 104 placed within the waste recycler 100. The waste 104 may include food waste as well as bioplastics that can be degraded as part of a recycling process implemented via a food recycler or a waste recycler 100. The waste 104 can include plastics such as biodegradable plastics, compostable plastics, petroleum plastics, or any type of plastics. The waste 104 can also include food items which can have components of fats, oils and grease.

The user may have a package of pouches (such as hydrolytic pouches 1100) available that include the enzyme 102 and as they use the waste recycler 100, if an occasion comes where they want to add bioplastics or other plastics or non-food items to the waste 104 placed within the bucket 110, the user can simply add the enzyme 102 to the bucket 110 and initiate the processing algorithm on the waste recycler 100. The user interface 126 can include a display, physical buttons, voice interaction, a touch-sensitive display, a multi-modal interactive interface, or other user interface for providing instructions that the enzyme 102 is included in the bucket 110 and thus to use a different processing cycle or a modified processing cycle. The enzyme 102 can include a buffer solution or an anhydrous material and an enzyme solution.

The waste recycler 100 can receive the enzyme 102 and the waste 104 and the user may provide the input via the user interface 126 indicating that the bucket 110 contains non-food waste and the enzyme 102 and to select a processing algorithm for the waste that enables the enzyme to have sufficient time to break down bioplastics or other materials. In one aspect, a wireless communication component can be included in the control system 120 and enable the user to interact with the waste recycler 100 via an application or website to provide the instruction. The user may be given options to describe in more granular detail how much bioplastic is in the bucket 110 or what type of non-food waste is in the bucket 110. The control system 120 can select from a plurality of different waste processing cycles that are tailored or configured for a certain type of non-food waste and/or certain percentages or amount of non-food waste in the bucket 110 and then can implement the chosen algorithm.

In one example, the chosen algorithm or a modified waste processing algorithm might include delaying the application of a heating phase in the waste recycling process to avoid denaturing the enzyme thus making it inoperative. For example, the enzyme 102 might be able to degrade a large percentage of bioplastic in the bucket 110 in a period of five hours. A normal food processing cycle might implement a heating phase after three hours of initiating the food processing cycle. In the new waste processing cycle, the heating phase may be delayed by two hours to give the enzyme 102 further time to break down the bioplastics. Other aspects of the food recycling process might be adjusted as well such as a type of and/or a timing of a grinding phase, or a dehumidifier phase, or a mixing phase. For example, airflow may be modified to prevent or slow down evaporation of water from the food waste because a certain enzyme needs a water solution to operate. The temperature control element 128 may cause a temperature to go up or down depending on whether the enzyme in a certain phase of the waste recycling process is to be operative or be denatured. A grinding mechanism 130 is shown to represent any kind of grinding operation as controlled by the control system 120.

FIG. 1 further shows the waste recycler 100 with an integrated delivery system 116. The integrated delivery system 116 generally represents different ways of adding the enzyme 102 to the bucket 110 automatically rather than manually. In this regard, the waste recycler 100 can include additional structure that enables the delivery of one or more of a buffer solution and an enzyme solution, an lyophilized enzyme or enzyme 102. For example, the waste recycler 100 can include a waste recycler lid 108 with the integrated delivery system 116 that includes a first component delivery system or a first container 112 that can contain a buffer solution or an anhydrous material. For example, it may contain a sufficient amount of buffer solution to handle twenty waste cycles. The waste recycler lid 108 can include another component of the delivery system or a second container 114 which can include a sufficient amount of enzyme solution, lyophilized enzyme or enzyme 102 for a plurality of waste cycles. The control system 120 can be used to manage the delivery of one or more of the buffer solution or the anhydrous material from the first container 112 and the enzyme 102 from the second container 114. The control system 120 can provide an electric signal to the first container 112 and the second container 114 causing the introduction of the respective solution to the bucket 110.

In one example, one or more of the first container 112 and the second container 114 can be removable cartridges that contain a plurality of hydrolytic pouches such as hydrolytic pouch 1100 that can be delivered one at a time as controlled the control system 120. For example, an opening can be provided in the waste recycler lid 108 that is accessible from the top or bottom surface of the waste recycler lid 108 which enables a user to insert a removable cartridge containing a plurality of hydrolytic pouches with the mechanical structure to cause, as instructed by the control system 120, a hydrolytic pouch 1100 to be delivered to the bucket one or more at a time.

In another aspect, the first container 112 and the second container 114 can each hold buffer solution and an enzyme 102 respectively and the mechanical delivery system can be configured to deliver an appropriate amount of each solution to the bucket 110. Note that the control system 120 can communicate with a sensor 118 that can provide data regarding the items in the bucket 110 which can include food items, an enzyme, a buffer, and/or quantities of any of these items. For example, the sensor 118 may be a camera and provide a visual image to the control system 120 which can include a bioplastics machine learning algorithm which will classify the image from the materials in the bucket 110 as including bioplastics or not and in some cases how much bioplastic is in a batch of waste. The sensor 118 can also be configured to detect fats, oils or grease as well as other types of plastic that can be degraded through the enzyme 102. The output of a machine learning classifier can be one or more of a confirmation that bioplastics or other materials exist, a predicted or estimated amount of the material (i.e., 50% or 20% of the material is bioplastic), and a volume of the material (i.e., a plastic bottle that is not crushed is in the bucket 110 which may generally take up some volume of the material in the bucket 110 but the actual volume of bioplastic is small in that that bottle is filled with air.). Other factors may be classified as well such as a type of material is in the bucket 110 that can be broken down by the enzyme 102.

In one example, the sensor 118 can be an interior facing camera or other sensor deployed in the waste recycler 100 that would for example be positioned in a waste recycler lid 108 or other location associated with the bucket 110. The waste recycler 100 may have image classification machine learning algorithms or other sensors that can determine whether bioplastics, an enzyme 102 or other materials are added to the bucket. The waste 104 may be 100% bioplastics or may be a mixture of food waste and bioplastics or other materials. The sensor 118 may sense whether an enzyme 102 had been added by the user to the bucket 110 as well. If the system determines of confirms that one or more events have occurred (i.e., bioplastics are included in the waste and/or an enzyme pod is added to the bucket), then the system can select the proper waste processing algorithm, adjust an existing waste processing algorithm or just process the waste using a traditional food recycling algorithm.

A plurality of different processing algorithms can be available for selection. For example, the processing algorithms may be tailored for 100% food waste, 50% food waste 50% bioplastics, 100% bioplastics, or any other percentage breakdown of food waste to bioplastics or other degradable materials. Various aspects of the processing algorithm are adjustable based on the ratio of food waste to bioplastics such as stirring times at the beginning of the cycle, wait times or pre-treatment times if at all for enzymes to break down bioplastics, heating times, cooling times, dehumidification processes, airflow processes, and so forth. As noted above, a user interface 126 can be presented to a user which enables them to also select a percentage of the different items in the waste or estimate what those percentages are.

In another example, if the user identifies, via a user interface 126 on the waste recycler 100 or on a mobile device that communicates the data to the waste recycler 100, that bioplastics are included in the waste 104, then the waste recycler 100 may confirm the existence of bioplastic through a sensor 118 to confirm the ratios or perhaps revise the ratio provided by the user. The system may confirm with the user that an enzyme 102 is added to the waste for processing. In one example, a light may be provided as part of the sensor 118 and the user may be able to be presented with an image of the contents of the bucket 110 on a mobile device (not shown) to enable the user to predict or provide input regarding how much plastic is included in the waste 104.

In yet another example, the user may predict or identify how much bioplastic waste is included in the bucket 110 and the system may then instruct the user regarding a size of enzyme 102 or type of enzyme 102 to add to the bucket 110. The enzyme 102 can have a first size that may be used for example for a certain amount or ratio of bioplastics in the waste 104 and a second size of enzyme 102 may be used for a different amount or ratio of bioplastics.

Classification data from images or other data from the sensor 118 can be used to control a first container 112 and a second container 114 regarding how much of one or more of the buffer solution and the enzyme 102 to deploy into the bucket 110 for a processing cycle. If the sensor 118 data indicates that 20% of the waste material is bioplastic, then a relatively small amount of one or more of the buffer solution and the enzyme 102 can be deposited for that cycle. Other changes to the waste processing cycle can be made as well. If the waste material is 80% bioplastics, then a relatively large amount of one or more of the buffer solution and the enzyme 102 can be provided for that cycle.

In another example, the buffer component and enzyme component be configured on a side portion of the waste recycler housing 106. For example, a first component 122 and a second component 124 are shown as being configured in a region adjacent to the bucket 110. Given the desire for volumetric efficiency in how the internal components to the waste recycler 100 are configured, the inclusion of compartments or cavities for the first component 122 and the second component 124 can vary. For example, these cavities can be configured in locations within the waste recycler housing 504 where other components such as filters, motors or fans are not positioned. An exterior door or opening to the waste recycler 100 can be provided to change out a cartridge of buffer solution and enzyme solution/lyophilized enzyme in connection with the first component 122 and the second component 124. In this manner, the restocking of the buffer solution and the enzyme solution/lyophilized enzyme can be easily managed by the user.

In another aspect, based on data received from the sensor 118, the control system 120 may adjust or modify a food recycling algorithm or process. For example, if the amount of bioplastic is 30% of the waste product in the bucket 110, the control system 120 may determine an amount of buffer solution and/or an amount of enzyme solution/lyophilized enzyme or enzyme 102 to add to the bucket for processing. The adjustment or the algorithm might include a timing component as well such as inserting the buffer solution and/or the enzyme 102 at the time or at different times. The timing might relate to characteristics of the waste material and the steps that occur in the waste recycling process. For example, if the food waste is soup and contains a large amount of water, then dropping the enzyme 102 into the waste might be expected to cause an enzyme container to start to dissolve immediately and thus initiate the degrading process of the enzyme 102. If the food waste is bone and/or bread where there is not a level of liquid in the bucket 110, then the control system 120 may cause the addition of the buffer solution and the enzyme 102 to be right before a grinding step in the waste recycling process which will break open the hydrolytic pouch 1100 to initiate the breakdown of the bioplastics. Thus, the amount of water content in the batch of waste may drive or cause the recycling process to be adjusted.

These modifications or decision points may also vary based on the kind of enzyme delivery system that is provided. Thus, if the delivery system delivers a hydrolytic pouch 1100, then one set of decisions are implemented. If the delivery system delivers the buffer solution and the enzyme 102 directly without the use of pouches, then a different series of steps might be implemented with different timings.

The amount of each of these solutions might differ too depending on the type of waste. In one example, the enzyme 102 may be configured to not only break down bioplastics but certain types of food waste as well, such as fats, oils and grease. If the type of food waste that can be broken down with an enzyme 102 is within the bucket 110 as determined via use of the sensor 118 or via user input via a user interface 126, then the control system 120 may cause an increase in the amount of enzyme 102 added to that batch because the enzyme 102 may also break down the food waste in addition to the bioplastic.

In some aspects, the control system 120 can be connected to a temperature control element 128. The temperature control element can be configured to heat or cool the waste 104 and enzyme 102 in the bucket 110. In some cases, the control system 120 includes one or more enzyme-mediated waste processing cycles or algorithms and can also include food processing algorithms that can be modified to take into account the use of enzymes when processing the waste 104 in the bucket 110 or vessel. Note that there are temperature and timing aspects to how long and under what conditions an enzyme may be operative to biodegrade for example a certain plastic, fat, oil or grease within the waste 104 and thus, the waste recycler 100 can modify a waste processing algorithm or choose an enzyme-mediated waste processing algorithm to enable plastics to be biodegrade while also processing food waste according to a food waste processing cycle. Various stages of a waste processing cycle can be used for pre-treatment of the waste 104 for example for a period of time to break down plastics in the bucket 110 to a sufficient or acceptable amount.

In some aspects, an enzyme-mediated waste processing cycle may include cooling the waste 104, via the temperature control element 128, in the bucket 110 because the natural processing of the food waste might have a temperature which is high enough to reduce the effectiveness of the enzyme 102. Further, the temperature control element 128 can be used near an end of a cycle to either heat the waste or allow heat from the waste to rise to 50° C. or above to denature the enzyme so that it is no longer active when processed waste is placed in a garden or generally removed from the waste recycler 100 after the cycle is complete. The temperature and time required can depend on the enzyme used. In some cases, controlling the temperature to be above 80° C. or 90° C. for a period of time at the end of the waste processing cycle is sufficient to denature the enzyme. Similarly, controlling the temperature to be low enough during a pre-treatment phase might include cooling down the waste 104 to be below 40° C. or 50° C.

As noted above, a user interface 126 can be provided as part of the waste recycler 100. The user interface 126 can provide a mechanism to receiver user input regarding the processing of one or more of food waste and/or bioplastics. For example, if the user adds bioplastics to food waste and manually adds a hydrolytic pouch 1100 or directly adds an enzyme 102, the user may be able to indicate that the current batch includes food waste and bioplastics. The user interface 126 may enable the user to estimate the percentage of bioplastics or may provide instructions to add a particular type of hydrolytic pouch 1100 or enzyme 102. For example, the user may have three different types or sizes of hydrolytic pouch 1100 and one the user indicates data regarding the inclusion of bioplastics in the batch, the system may provide instructions via the user interface 126 to use a certain hydrolytic pouch 1100 or certain enzyme 102 with a certain amount. The instructions and user interface may include any one or more of a graphical input, an audible input, video data, a multimedia or multimodal input, and so forth. The user may also have a separate application on a mobile device that communicates with the waste recycler 100 to enable control and interaction with the waste recycler 100. For example, providing the data regarding the existence of bioplastics in the batch of waste and receiving an instruction regarding which size of a pouch to use may occur via an application on the user's mobile device that is linked to the waste recycler 100. The user interface 126 may be configured on the waste recycler housing 106 or might be configured at a different location.

The user interface 126 may be a physical button or a button shown on a touch-sensitive display. For example, the waste recycler 100 may include one button for “food waste only processing” and another button for “bioplastics only” as well as another button for “food waste and bioplastic processing”. Each of these may implement a different processing algorithm from the control system 120.

In one example, a user places in the waste recycler 100 recycler some food waste and some bioplastics. The sensor 118 may determine that bioplastics are included in the bucket 110. The user interface 126 can be modified based on this input to include through an interactable object or via an application that the user can identify an amount or type of bioplastics. In one case, the person may then add or be instructed to add a hydrolytic pouch 1100 to the batch.

If the waste recycler 100 knows that the processing cycle should include processing bioplastics, then the algorithm can be adjusted to account for the bioplastics. For example, rather than just grinding the waste 104, heating and dehumidifying waste food, the processing algorithm may perform a grinding function to break up and distributed the enzyme 102 amongst the materials in the bucket and wait for a period of time for the enzyme 102 to start breaking down the bioplastics. The control system 120 might then implement further grinding and dehumidifying. The processing algorithm could take into account how long it might take to break down the bioplastics to a certain level using the enzyme 102 as part of the processing cycle.

As shown in FIG. 1, the waste recycler 100 can include a storage and delivery component such as the first container 112 and the second container 114. For example, the food recycler food cycler has a waste recycler lid 108 with an integrated delivery system 116 can include one or more of the first container 112 and the second container 114 which store buffer material and enzyme material. A pouch delivery system can be included in which the waste recycler 100 can drop a hydrolytic pouch 1100 into the bucket 110 when bioplastics are sensed via the sensor 118 or when a user indicates that bioplastics or other degradable materials are included via the user interface 126. In one aspect, a larger supply of buffer solution and the enzyme 102 are provided in first container 112 and the second container 114 that can be released into the bucket 110 as part of a recycling process. For example, the buffer solution and the enzyme 102 might be sprayed or injected into the bucket 110 at different times as part of a recycling process. A proper timing of when these components should be added to the bucket 110 may include first heating the waste or batch for ten minutes, then adding a specific amount of buffer solution, and then mixing for two minutes and then dispenses a portion of the enzyme 102 to the mixture to start breaking down the waste what include bioplastics or other materials.

In one aspect as noted above, the waste may also be broken down to some degree using the enzyme 102. Thus, the aspects of the enzymes may be that the enzymes are both configured to break down bioplastics but also be useful or helpful to some degree to break down food waste as well. In this regard, the waste recycler lid 108 with the integrated delivery system 116 may include different types of enzymes as well. Some enzymes might break down both food waste and bioplastics, while other enzymes might be preferable for one type of waste or another. Thus, part of this solution can be to store different types of enzyme 102 and/or associated buffer solutions and enable or program the control system 120 to select which type of buffer/enzyme combination to add to a batch and in what amounts to improve the recycling process.

In one aspect, the food recycling process can include a heating portion and the first container 112 and the second container 114 can be configured to release the buffer solution and the enzyme solution/lyophilized enzyme according to heat applied in the heating portion of the food recycling process.

In another aspect, the food recycling process can include a grinding portion and the first container 112 and the second container 114 can release the buffer solution and the enzyme solution or the lyophilized enzyme according to when the grinding portion of the food recycling process begins.

The use of the enzyme 102 to degrade bioplastics or other materials has been studied by the inventors of the concepts disclosed herein. The following is a discussion of various enzymes and a study of a spectrophotometric-based assay to quantity relative enzyme-mediated degradation of bioplastics. Any enzyme 102 discussed herein can be used in connection with waste 104 to improve the efficiency of processing the waste as part of the waste recycler 100.

Biodegradable bioplastics have begun to be introduced into a variety of industries worldwide to replace petroleum-based plastics (PBPs). Bioplastics are generally aliphatic polyesters that do not persist in environments to the same extent as PBPs, due to the presence of hydrolysis-susceptible ester-bonds. Unfortunately, many of these bioplastics, including commercially available biodegradable bioplastics, persist in environments including seawater and waste centers. Different sub-classes of hydrolytic and proteolytic enzymes have shown promise in degrading bioplastics in vitro and offer hope to reduce accumulation of bioplastics as they replace PBPs. To aid in the discovery of hydrolytic and proteolytic enzymes that can degrade commercial bioplastics, a spectrophotometric-based medium-throughput assay was developed to aid in screening enzymes that may degrade bioplastics. The commercially available bioplastic degrading potential of two enzymes that have been shown to degrade pure bioplastics was investigated. Proteinase K and PLA depolymerase were shown through this spectrophotometric-based assay to degrade commercially available bioplastics in both dose- and temporal-based responses. Mass-loss measurements and scanning electron microscopy were used to further validate the bioplastic degradation potential of these enzymes. Overall, the screening capacity of the spectrophotometric-based assay was demonstrated to be an accurate method to identify enzymes that can degrade commercially available bioplastics. Again, any enzyme 102 discussed below can be the enzyme 102 that is provided to the bucket 110 of a waste recycler 100 to yield an enzyme-mediated degradation waste processing cycle.

Due to environmental persistence and carbon emissions associated with petroleum-based single-use plastics, biodegradable bioplastics are being integrated in a variety of sectors and countries. Biodegradable bioplastics are commonly made with plant-based materials that readily decompose much as plant materials are degraded in the natural world. Industries such as medical, agriculture, packaging, manufacturing and waste management have adopted the use of biodegradable bioplastic polymers for more eco-friendly applications compared to their petroleum-based plastic counterparts. Unfortunately, bioplastic polymers/compostable bioplastics materials are not readily composted under normal waste handling systems and are seen as contamination by many composting systems. For example, the common ‘compostable’ plastics made of polylactic acid (PLA) and polyhydroxyalkanoate (PHA) are estimated to require 1-20 or sometimes 100+ years to decompose in open environmental settings.

PLA, PHA and other bioplastics can require specific environmental conditions to optimize environment-mediated degradation. For example, PLA is shown to degrade optimally in moist environments of 50° C. or higher. Although most compost piles reach optimal temperatures in the thermophilic range of 45° C.-65° C., in northern climates such as Canada and northern United States, even established compost piles do not reach the necessary temperatures during Fall, Winter and Spring months. As a result, there is an apparent need to improve either long term or initial degradation of bioplastics to aid in decomposition in a compost or waste environment. Further, given the use of bioplastics in the home or in businesses, and the expanding use of food recyclers, the introduction herein of a waste recycler 100 that can also process or use enzymes to generate an enzyme-mediated degradation of bioplastics or other materials in the waste 104 is desirable.

Generally, most biodegradable bioplastic polymers consist of a variety of aliphatic polyesters wherein ester-bonds are readily hydrolysable leading to long-term degradation. The common biodegradable bioplastic polymers include but are not limited to PLA, PHA, poly-caprolactone (PCL), poly-propylene carbonate (PPC), poly-butylene succinate (PBS) and poly-butylene succinate-co-adipate (PBSA). These are all aliphatic polyesters, but their individual chemical structure and composition, as well as their hydrophobicity can affect degradation processes. Along with chemical properties, physical properties such as crystal structure, melting temperature (Tₘ) and glass transition temperature (T_{g}) can also affect how these bioplastic polymers degrade. Such factors can be taken into account by the control system 120 of a waste recycler 100 such that a waste processing algorithm can consider the impact of temperature on the bioplastic or other materials being processed.

The aliphatic polyester-nature of a majority of biodegradable bioplastic polymers mean they are susceptible to enzymatic hydrolysis. As such, recent research has focused on sub-families of hydrolases and how they can facilitate enzymatic hydrolysis leading to bioplastic degradation. Generally, candidate enzymes have been either isolated from bacteria associated with bioplastics in landfills, or are hydrolases shown to have ‘off-target’ activity towards bioplastics because of chemical structure-based homology with their natural substrates. For example, PLA depolymerase is an enzyme isolated from soil samples in Japan that was shown to degrade bioplastics such as PLA and PBSA. Enzymes shown to have off-target activity towards pure bioplastics include cutinase-like enzymes, Proteinase K, Proteases, Esterases and Lipases. Factors such as temperature, time, pH, co-factors, and agitation may decrease, maintain, or increase the ability of an enzyme to degrade bioplastics. For example, proteinase K has optimal enzymatic activity at 37° C., but can maintain upwards up 80% of activity from 20° C. to 60° C. Moreover, Ca²⁺ concentration has also been shown to effect proteinase K stability and activity. Examples such as these demonstrate the need to investigate whether specific reaction conditions could facilitate an enzyme's overall ability to target bioplastics in an in vitro setting.

The factors described above can cause a waste processing cycle in the waste recycler 100 to be modified to take into account, for example, temperature and additives such as Ca²⁺ to improve the efficiency of the enzyme-mediated degradation process. For example, if the enzyme 102 is proteinase K, then the waste processing algorithm might hold the temperature at 37° C. for a period of time so that the impact of the enzyme 102 can be maximized before increasing the temperature during a phase of the waste processing cycle. The use of an additive such as Ca²⁺ might cause, for example, the enzyme 102 to have increased thermal stability such that it continues to degrade bioplastics optimally or at an acceptable rate (say 70% or above, for example) even in higher temperatures than 37° C.

There currently exists a handful of different methods to assess enzymatic-plastic degradation. One common employed method is through mass loss measurements. Simply, one can measure the mass of starting bioplastic material against the remaining mass after enzyme incubation. A dose-responsive relationship is further indication of enzyme activity. Spectrophotometric-based assays have been developed but only with aromatic ring-containing plastics. For example, it has been shown that enzyme-mediated degradation of polyethylene terephthalate (PET) can be quantified via bulk A260 readings, as absorbance measurements of 260 nm light have been used for detection of PET by-products TPA (terephthalic acid), MHET (mono-(2-hydroxyethyl) terephthalate) and BHET (bis(2-hydroxyethyl) terephthalate). Other methods such as bioplastic-agar emulsification have been developed to screen bacteria for their bioplastic degrading capabilities. Although this method is ideal for screening bacteria, once a candidate enzyme is discovered, other techniques need to be implemented to analyze enzymatic degradation of bioplastics. These techniques such as scanning electron microscopy (SEM), mass spectrometry analysis and nuclear magnetic resonance (NMR) spectroscopy have been used to validate an enzyme's ability to degrade pure bioplastic species. These analytical techniques require specialized equipment and therefore are not ideal for routine enzyme screening purposes. Other indirect methods to evaluate enzymatic degradation of bioplastics include gel permeation chromatography analysis, differential scanning calorimetry, and the measure of CO₂ production as it is a by-product of common bioplastic degradation processes. These indirect methods can be labor and materials intensive, require specialized equipment and may be cost-prohibitive and therefore are not ideal for screening for enzymes that degrade bioplastics.

Discovery of enzymes that target bioplastics in an in vitro setting are critical in helping to identify other potential ways to aid in the degradation of bioplastics, either in a pre-landfill or landfill settings. However, the majority of the studies have been done on pure species of bioplastics, and the common commercially available biodegradable bioplastics used in everyday household and industrial settings are more often mixtures of various species of plastics. As such, investigations into candidate enzymes that degrade commercially available biodegradable bioplastic mixtures are helpful, in the same or similar sense that they have been demonstrated to target and degrade pure bioplastic samples in vitro. Moreover, as traditional methods of evaluating enzyme-mediated degradation of bioplastics are labor and materials intensive, require specialized equipment and/or are cost-prohibitive, they are not suitable for rapid screening of candidate or engineered enzymes. As such, a medium-to-high throughput method for screening enzyme's capability to degrade mixtures of bioplastics is also helpful.

A semi-quantitative spectrophotometric approach is disclosed to screen enzymes in a 96-well plate format that is applicable to real-world, complex bioplastic mixtures. For this the inventors have adopted standard methods, using emulsifying solutions and surfactants within a low volume format that can be semi-automated. As long as the target bioplastic mixture can be dissolved in an organic solvent, one can use this assay to optimize enzyme and substrate concentrations and other reaction parameters. To demonstrate, the inventors utilized proteinase K enzyme and PLA depolymerase enzyme in the experiments as positive controls due to their reported activity towards pure bioplastics such as PLA. The inventors were able to demonstrate that proteinase K and PLA depolymerase can both degrade commercially sourced bioplastic mixture in comparison to no enzyme controls as well as negative control cell wall lysing enzyme mixture. The inventors validated our spectrophotometric assay results with mass loss measurements and analytical techniques based on SEM and NMR. The spectrophotometric-based assay can be applied to accurately screen and characterize enzymatic degradation of complex bioplastics.

Materials and methods and discussed next with respect to the preparation of biodegradable plastic. Proteinase K and PLA depolymerase were previously shown to degrade pure polylactic acid (PLA). The inventors developed an assay to test the efficacy of these enzymes to degrade the bioplastic within a commercially available certified compostable bag. For standard sample preparation, a single-hole-punch device was used to obtain 6 mm diameter discs. Generally, 1 disc was equal to 0.55 mg and 2 discs (1.1 mg) were used per tube in spectrophotometric-based assays. It should be noted that areas of bag with printing was avoided.

Next is discussed the purification of PLA depolymerase. A pET25b(+) plasmid containing a PLA depolymerase was transformed in Escherichia coli strain BL21 (DE3)C+ for protein expression and grown in 400 mL LB medium. Cultures for protein expression were inoculated with 0.5-1% starter culture and grown with shaking (200 RPM) at 37° C. to an A600 of 0.5-0.6 whereupon the temperature was decreased to 16° C. and expression was induced with addition of 0.1 mM isopropyl ß-D-1-thiogalacttopyranoside (IPTG). Following IPTG induction, cultures were incubated for five hours at 16° C. and then cells were pelleted by centrifugation (5000×g for 15 min at 4° C.) and medium was decanted. Cell pellets were washed once with ice-cold 1×PBS and pelleted as above by centrifugation. PBS was decanted and pellets were snap frozen in liquid nitrogen and then stored at −80° C.

For protein purification, pellets were resuspended in 20 mM NaHPO4, 10% glycerol, 150 mM NaCl, 0.5 mM DTT and supplemented with protease and phosphatase inhibitors (1 mM PMSF, 0.5 μM Aprotinin, 10 μM E-64, 1 μM Pepstatin). Cells were lysed via sonication 5×30 sec on/off at 70% amplitude intensity on ice for a total for 45 min. The cell lysate was cleared via centrifugation (18000×g for 45 min at 4° C.) and the soluble lysate was loaded onto a 600 tL Ni-NTA agarose resin (Qiagen, Cat #30210) affinity column. The affinity column was washed and eluted with an imidazole gradient (40-250 mM imidazole in 20 mM NaHPO4) and protein fractions were collected. Protein fractions were dialyzed for 3 hours in a protein storage buffer (20 mM NaHPO₄, 10% glycerol, 150 mM NaCl, 0.5 mM DTT) using 6-8 kDa molecular weight cut-off dialysis tubing (FisherScientific, Cat #08-670A). Protein purity was assessed through 12% SDS-PAGE followed by staining with Coomassie Brilliant Blue G-250 stain. Protein concentration was quantified through a standard Bradford assay. Proteins were snap-frozen in liquid nitrogen and stored at −80° C. for later use.

Next is discussed the spectrophotometric-based screening assay. All proteinase K (ThermoFisher, Cat #25530031) reactions took place in Tris-based buffer (50 mM Tris (pH 8.0), 0.1% Triton X-100). All PLA depolymerase reactions took place in protein storage buffer plus Triton X-100 (20 mM NaHPO₄, 10% glycerol, 150 mM NaCl, 0.5 mM DTT, 0.1% Triton X-100). A mixture of lysing enzymes from Trichoderma harzianum (including β-glucanase, cellulase, protease, and chitinases) (Sigma-Aldrich, Cat #L1412) served as a negative control for these experiments and reactions took place in the same Tris-based buffer as proteinase K. To begin, 1.1 mg of bioplastic (2 discs) was added to 1.5 mL Eppendorf tubes with each respective reaction buffer and enzyme. No-enzyme controls were also set up for each enzyme-specific buffer. Reactions proceeded for 24 hours at 37° C. in a tube revolver rotator (ThermoFisher, Cat #88881001). After overnight incubation the supernatant from each reaction was transferred to a new 1.5 mL tube. 1 mL of Tris-based buffer was added to the residual plastic from each reaction. The separate tubes containing residual plastic and decanted supernatant each had 100 μL of CHCl₃ added, followed by vortexing until each solution turned from transparent to turbid. Once turbid, all samples were sonicated using a VCX-130 ultrasonic processor (Sonics & Materials INC, Newtown, CT) for 1 min at 65% amplitude until organic and aqueous phases were emulsified. Once emulsified, 200 μL from each reaction tube was added to a 96-well clear microplate (Corning, Cat #353072) in n=4 replicates. Turbidity of the solution was measured at an absorbance at 610 nm and was read immediately using a Cytation 5 plate reader (Bio-Tek, Winooski, VT).

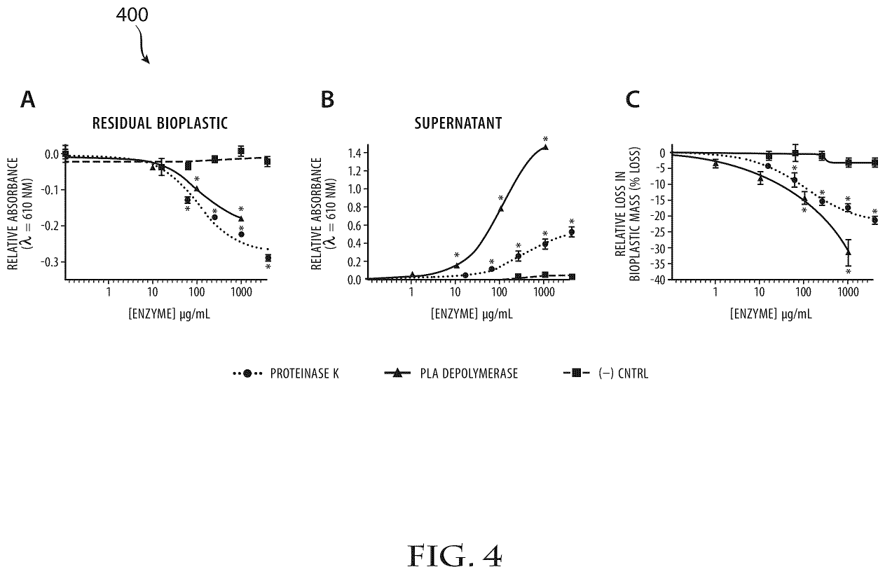

For proteinase K, a 4× dilution curve (See the graphs A and B of the set of graphs 400 of FIG. 4) from 4000-0 μg/mL was used to determine a dose-response regression and an optimal concentration for subsequent experiments. Two biological replicates each with four technical replicates were used. For PLA depolymerase, a 10× dilution curve (See the graphs A and B of the set of graphs 400 of FIG. 4) from 1000-0 μg/mL was used to determine a dose-response regression and an optimal concentration moving forward. Two biological replicates each with four technical replicates were used. With the lysing enzyme mixture from T. harzianum, a 4× dilution curve (See the graphs A and B of the set of graphs 400 of FIG. 4) from 4000-0 μg/mL was used to validate the efficacy of both assays as a negative control. Two biological replicates each with four technical replicates were used.

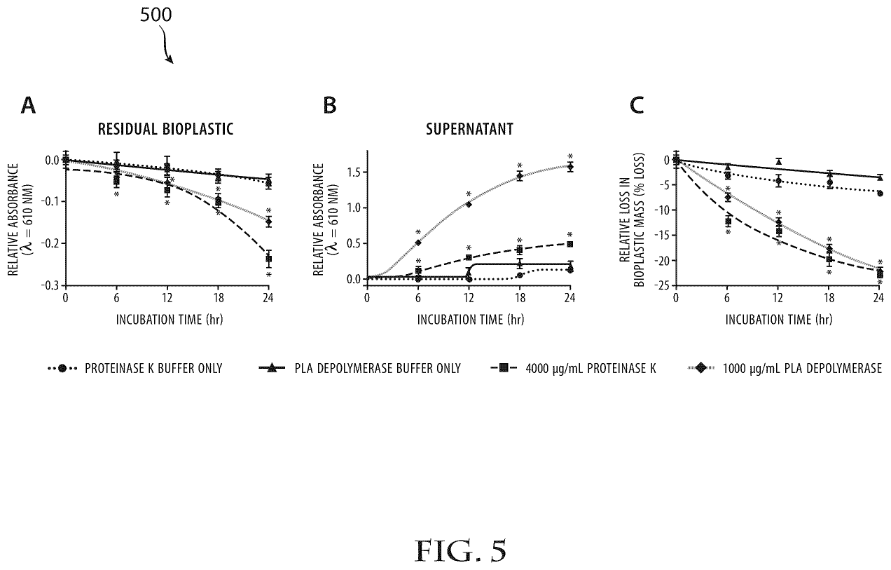

For temporal studies assessing proteinase K and PLA depolymerase activity towards bioplastic substrates, the assays were set up as described (See the graphs A and B of the set of graphs 500 of FIG. 5). Briefly, reactions were initiated at 6-hour intervals. Proteinase K positive control samples were at a concentration of 4000 μg/mL in the Tris-based buffer (50 mM Tris (pH 8.0), 0.1% Triton X-100). The no-enzyme control (0 μg/mL proteinase K) samples were incubated in only Tris-based buffer. For each condition, two biological replicates each with four technical replicates were used. PLA depolymerase positive control samples were at a concentration of 1000 μg/mL in protein storage buffer plus Triton X-100 (20 mM NaHPO4, 10% glycerol, 150 mM NaCl, 0.5 mM DTT, 0.1% Triton X-100). The no-enzyme control (0 μg/mL PLA depolymerase) samples were incubated in only protein storage buffer. After each incubation time, the rest of the assay was completed as described above. For each condition, two biological replicates each with four technical replicates were used.

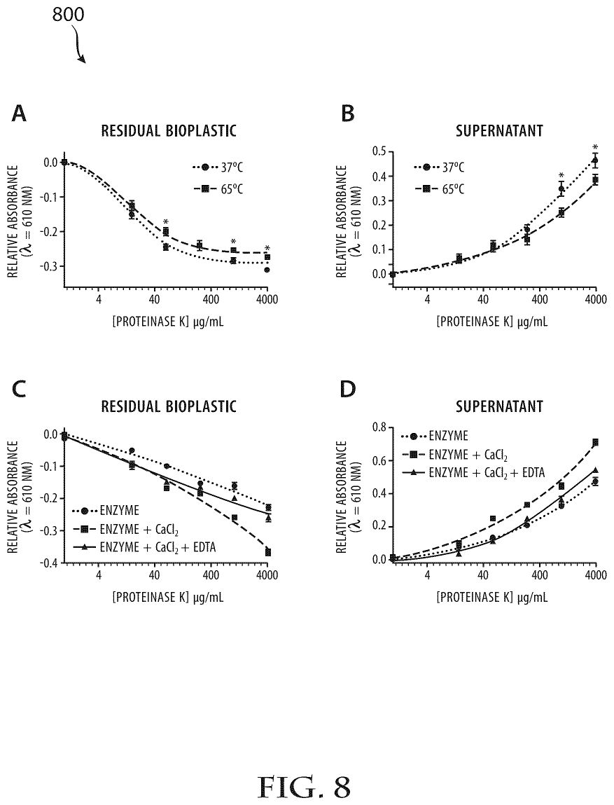

For assessing proteinase K activity at different temperatures (See the graphs A and B of the set of graphs 800 of FIG. 8), the assay was set up the same as described above, except tubes were in incubators set at 37° C. and 65° C. for 24 hours. For assessing Ca²⁺ effects on proteinase K activity (See the graphs C and D of the set of graphs 800 of FIG. 8), reactions were set up as described above for the enzyme-only control and the other two reactions were supplemented with 1 mM CaCl₂ or 1 mM CaCl₂+2 mM EDTA from 1M stock solutions, still totaling to 1 mL total volume.

Enzyme-mediated mass loss and its effectiveness are important features to understand when using an enzyme 102 in a waste recycler 100. Mass loss measurements with commercially available biodegradable plastic was evaluated by incubating enzymes with the bioplastic for 24 hours. To begin, approximately 5 mg of bioplastic (9 discs) was added to a 1.5 mL Eppendorf tube and initially dried overnight at ˜50° C. After overnight drying, initial starting mass of tubes containing bioplastic was weighed using an analytical balance (Sartorius Canada Inc, Oakville, ON). Proteinase K, PLA depolymerase or lysing enzymes from T. harzianum (including β-glucanase, cellulase, protease, and chitinases as a negative control) were separately added to tubes containing weighed bioplastic discs. The same associated buffers used in the spectrophotometric screening assays were used in mass loss assessments to maintain reaction consistency. No-enzyme controls were also set up using each enzyme-respective buffer. Reactions were incubated for 24 hours on a tube revolver rotator at 37° C. After overnight incubations, the supernatants were removed from the tubes and remaining plastic was gently washed 3× with 1 mL of deionized water. After the last wash, remaining bioplastic was dried overnight at ˜50° C. and the final remaining mass of tubes containing bioplastic were weighed using the analytical balance. The difference was calculated between starting and final mass of tubes and plastic and presented.

For proteinase K, a 4× dilution curve (See the graph C of the set of graphs 400 of FIG. 4), from 4000-0 μg/mL was used to determine a dose-responsive regression and an optimal concentration moving forward with other experiments. For PLA depolymerase, a 10× dilution curve (See the graph C of the set of graphs 400 of FIG. 4), from 1000-0 μg/mL was used to determine a dose-responsive regression and an optimal concentration moving forward. For the lysing enzyme mixture from T. harzianum, a 4× dilution curve (See the graph C of the set of graphs 400 of FIG. 4), from 4000-0 μg/mL was used as a negative control. Three technical replicates were used for all enzymes.

For temporal bioplastic mass loss studies, proteinase K and PLA depolymerase assays were set up as described (See the graph C of the set of graphs 500 of FIG. 5). Briefly, reactions were initiated at 6-hour intervals. Proteinase K positive control samples were at a concentration of 4000 μg/mL in the Tris-based buffer (50 mM Tris (pH 8.0), 0.1% Triton X-100). The proteinase K no-enzyme control (0 μg/mL) samples were incubated in only Tris-based buffer. PLA depolymerase positive control samples were at a concentration of 1000 μg/mL in protein storage buffer plus Triton X-100 (20 mM NaHPO₄, 10% glycerol, 150 mM NaCl, 0.5 mM DTT, 0.1% Triton X-100). The PLA depolymerase no-enzyme control (0 μg/mL) samples were incubated in only protein storage buffer. After overnight incubation, the supernatants were removed from the tubes and mass loss was determined as described above. Three technical replicates were used for all enzymes.

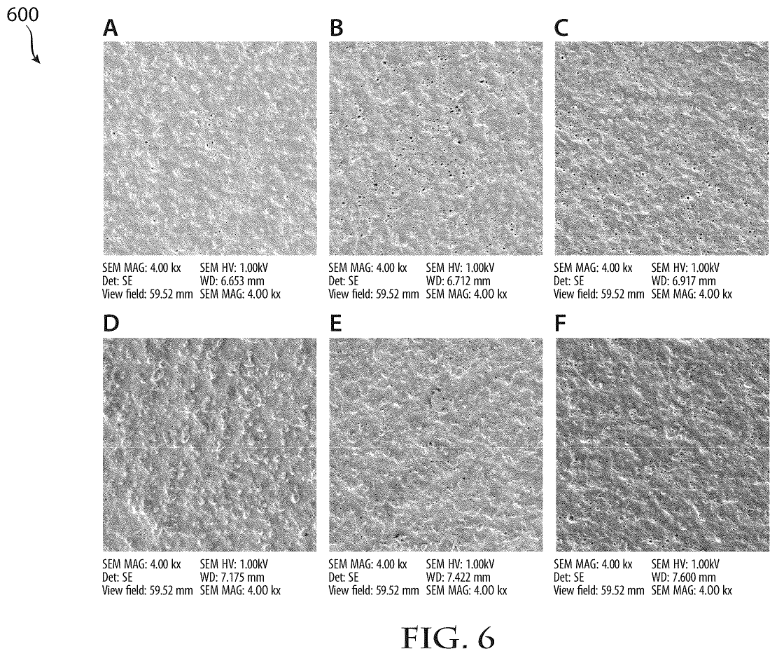

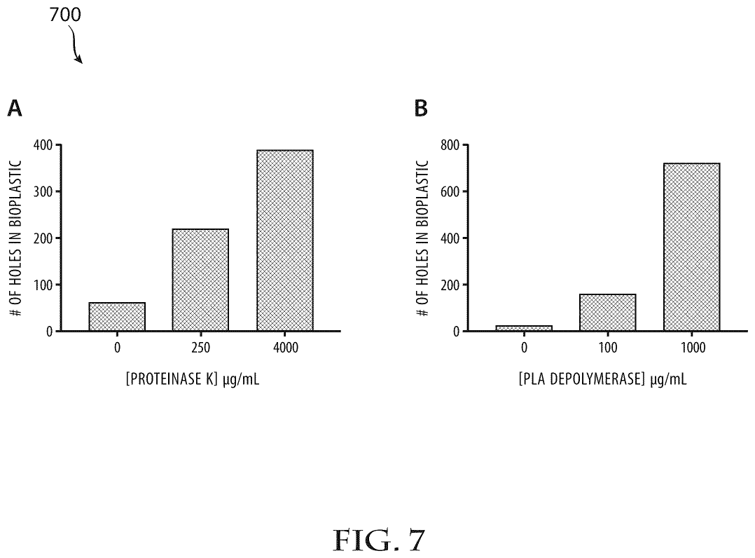

The inventors studied enzymes in some cases using a scanning electron microscopy (SEM). All in vitro enzymatic assays to detect bioplastic degradation via SEM were performed as described in FIG. 6. All proteinase K reactions took place in Tris-based buffer (50 mM Tris (pH 8.0), 0.1% Triton X-100). All PLA depolymerase reactions took place in protein storage buffer plus Triton X-100 (20 mM NaHPO₄, 10% glycerol, 150 mM NaCl, 0.5 mM DTT, 0.1% Triton X-100). As done for the spectrophotometric-based assay, all SEM-based experiments were performed with 1.1 mg of bioplastic (2 discs). To begin, 1.1 mg of bioplastic (2 discs) was added to 1.5 mL Eppendorf tubes with each respective reaction buffer and enzyme. Reactions proceeded for 24 hours at 37° C. After overnight 257 incubation the supernatants were removed from the tubes and remaining plastic was gently washed 3× with 1 mL of deionized water. After the last wash, remaining bioplastic was dried overnight at ˜50° C. and prepared for SEM in an imaging facility. Briefly, dried samples were coated with a gold layer (˜10 nm) for conductive purpose using a Quorum Q150T ES sputter, and then imaged using Scanning Electron Microscope (TESCAN VegaII XMU) at 1 kV acceleration voltage in high vacuum mode. ImageJ “Analysis of particles” feature was used to quantify holes in bioplastic indicative of enzyme degradation (See FIG. 7).

Study was also performed using a nuclear magnetic resonance (NMR). All in vitro enzymatic assays to detect bioplastic degradation via NMR were performed as described. All proteinase K reactions took place in Tris-based buffer (50 mM Tris (pH 8.0)). All PLA depolymerase reactions took place in protein storage buffer (20 mM NaHPO₄, 10% glycerol, 150 mM NaCl, 0.5 mM DTT). So as not to interfere with NMR, Triton-X100 was omitted from the reaction buffers. Similar to the spectrophotometric-based assays, all NMR-based experiments were performed with 1.1 mg of bioplastic (2 discs). To begin, 1.1 mg of bioplastic (2 discs) was added to 1.5 mL Eppendorf tubes with each respective reaction buffer and enzyme. Reactions proceeded for 24 hours at 37° C. After overnight incubation the supernatant from each reaction was removed using glass pipettes and put into a new 1.5 mL tube. The supernatant was passed through a 10 kDa spin column (MilliporeSigma, Cat #UFC801008) as recommended by manufacturer to remove enzymes that may interfere with NMR signals. Samples were roto-evaporated for 2 hours to remove remaining aqueous solution and processed in the Carleton University NMR Facility. Briefly, all NMR spectra were obtained at 7.05 T (v0=300.15 MHz) on a Bruker Avance 300 spectrometer. 1H NMR spectra were obtained in CDCl3 using a zg30 pulse sequence with a relaxation delay of at least Is and an acquisition time of 3.5 s. 64-256 transients were collected. 1H NMR spectra were internally referenced to TMS.

Paired two-tailed T-test were used to examine statistical significance of bioplastic degradation between enzyme and no-enzyme treatments in spectrophotometric-based assays and mass loss measurements. For analysis of proteinase K activity in various reaction conditions with/without the presence of CaCl₂)/EDTA, a 2-way ANOVA with concentration and absorbance held as integers and reaction condition (presence/absence of CaCl₂) and EDTA) held as a factor was used to determine statistical significance between reaction conditions. Quantification of “holes” in bioplastic via enzymatic-mediated degradation was derived from ImageJ “Analysis of particles” feature. ImageJ allows a user-defined threshold that can be set relative to the pixels attributed with a positive control, in this case a “hole” produced via enzyme-mediated degradation. The picture was set to 8-bit and the threshold was set >99.3% of total signal on the side of dark signal. The size was set from 0.0002-2.00 inch² and circularity was set from 0.1-1.00 to minimize false positives.

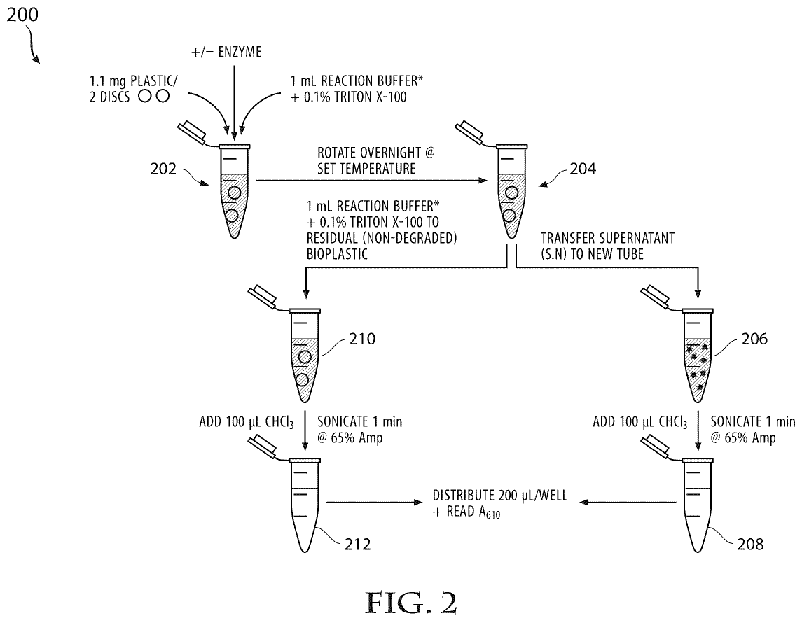

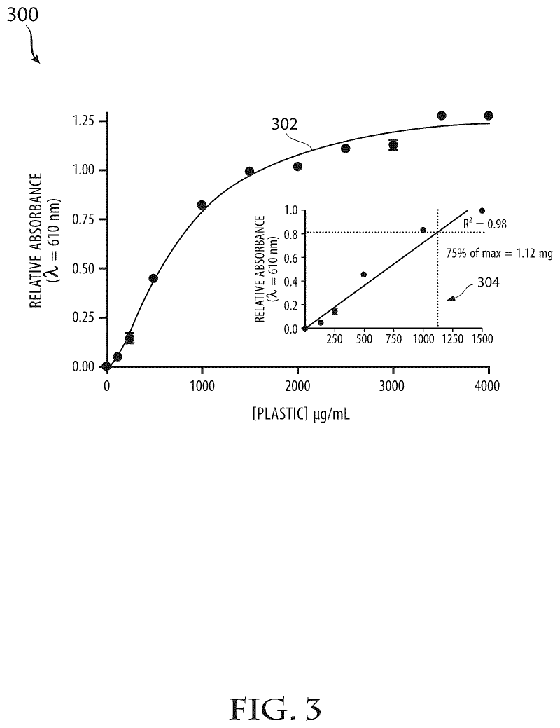

The inventors determined results from the study. To design an in vitro assay to screen the enzymatic-mediated degradation potential of bioplastics, the inventors combined methods in which plastic was emulsified in a solid medium with growth nutrients and agar. Briefly, by applying CHCl₃ to a buffered solution containing a small amount of bioplastic and a small percent of a detergent, emulsification of the solution can be achieved through sonication. The result of the sonication turns a transparent solution containing an organic layer (bioplastic in CHCl₃) and an aqueous layer (buffer in water) into a turbid emulsified solution (See FIG. 2). As the amount of bio-plastic in the emulsified solution increases, the turbidity of the solution also increases. By pipetting 200 μL aliquots into wells of a clear 96-well plate and reading an absorbance wavelength of 610 nm, one can observe a dose-responsive relationship as the mass of bioplastic increases in this 1.1 mL volume (See FIG. 3). A wavelength of 610 nm was chosen to ensure no saturation of signal occurred. Note that the wavelength of 610 nm or in some cases 510 nm were used in many of the studies reported in this disclosure. Note that 510 nm was chosen for the FOG assay that was developed by the inventors. Other values can be used and are used herein. Ultimately, by comparing to a proper control/blank, this spectrophotometric-based assay can become a relative-quantifiable assay by reading the A₆₁₀ of a solution containing an amount of plastic in the linear portion of the curve in FIG. 3. As a result, for all spectrophotometric-based assays used for screening enzymes, the inventors progressed with using 1.1 mg of plastic (2 discs) as this represents approximately 75% of the maximum weight for the linear portion of the curve.

The assay is convenient for medium-throughput enzyme screening as CHCl₃ is denser than water, it naturally settles at the bottom of an Eppendorf tube where remaining bioplastic also settles. This is advantageous as CHCl₃ can be added after incubation of enzyme/no-enzyme treatments with bioplastics as a “detection reagent”. It can be useful to add CHCl₃ after enzyme incubation as CHCl₃ may otherwise contribute to protein precipitation which could result in inactive enzyme. Moreover, upon successful enzyme-mediated degradation of bioplastics, the supernatant of the initial enzymatic reaction contains by-products of bioplastic degradation. As such, CHCl₃ can be added to the supernatant. The result is an emulsified solution that has increased turbidity from by-products of bioplastic produced as a result of degradation. Note that instructions for users regarding the addition of a material such as CHCl₃ can be provided as part of a waste processing cycle.

FIG. 2 illustrates a spectrophotometric-based assay 200 to quantify relative bioplastic degradation. Reaction setup and product detection for candidate bioplastic degrading enzymes. A plastic, enzyme and reaction buffer can be combined 202 and rotated overnight at a set temperature to generate a plastic/buffer combination 204. Bioplastic degradation can be monitored by both reduction of residual plastic and increase in degradation products in supernatant by reading absorbance at 610 nm. A first reaction solution 206 relates to a transfer of a supernatant to a new tube. A first result 208 can be obtained by 100 μL CHCL₃ and sonicating 1 minute. A second reaction solution 210 is obtained by resuspending the residual plastic in 1 mL of reaction buffer with 0.1% Triton X-100 in the absence or presence of enzyme of interest. 10% v/v of CHCl₃ is added as detection reagent. The solution is sonicated until uniformly emulsified. A second result 212 is obtained by adding 100 μL CHCL₃ and sonicating 1 minute.

FIG. 3 illustrates a graph 300 of a standard curve 302 for quantification of commercially available bioplastic. A610-based detection of different masses of plastic in 1 mL Tris-based buffer (50 mM Tris (pH 8.0)+0.1% Triton X-100). CHCl₃ (100 μL) was added as a detection reagent before emulsification via sonication of solution. Absorbance averages were normalized background signal. Results are mean±std. error (n=4). A second graph 304 in FIG. 3 shows the value of 75% of maximum absorbance at 1.12 mg of plastic.

Once the inventors determined the optimal amount of bioplastic to assay enzymes (See FIG. 3), the inventors then assessed the validity of two enzymes that have been reported to degrade pure biopolymers, such as PLA. The enzymes tested were proteinase K and PLA depolymerase. The inventors also implemented a mixture of lysing enzymes from T. harzianum including-glucanase, cellulase, and chitinases to be our negative control. To validate the absorbance-based assay and to ensure that one was observing true degradation, the inventors also assessed the bioplastic-degrading activity of these enzymes via mass-loss measurements. The mass before and after incubation of the enzyme was recorded and total mass loss was calculated based on changing enzyme concentrations. It should be noted that all values in FIG. 4 are shown as relative changes in either A610 values or in bioplastic mass since the inventors observed a small amount of change in A₆₁₀ or mass loss in bioplastic in our no enzyme controls throughout this study. Given most bioplastic species can degrade naturally in aqueous environments due to hydrolysis of ester bonds, the small decreases observed is likely due to basal levels of bioplastic degradation through the in-solution reactions.

To maximize insights from our spectrophotometric-based assay the inventors looked to detect plastic degradation by both a reduction of residual plastic and an increase in degradation products in supernatant, compared to the no enzyme controls (See FIG. 4). Using the spec-trophotometric-based assay, the inventors observed a reduction in the residual (non-degraded) bio-plastic after 24-hour incubation that correlated to increasing enzyme concentration with both proteinase K and PLA depolymerase (See graph A of set of graphs 400 of FIG. 4). When compared to the respective controls, there were statistically significant decreases in A₆₁₀ from proteinase K in concentrations >62.5 μg/mL and PLA depolymerase concentrations >100 μg/mL (p<0.05). Collectively the data indicates treatments with these enzymes can significantly degrade commercial bioplastic within 24 hours. In contrast, no significant reduction in residual bio-plastic was observed in our negative control containing a mixture of lysing enzymes from T. harzianum.

In analyzing the decanted supernatant upon reaction completion, the inventors observed an increase in relative A₆₁₀ absorbance that correlated with proteinase K and PLA depolymerase concentrations (See graph B of set of graphs 400 of FIG. 4). When compared to the respective no-enzyme controls, there were statistically significant increases in A₆₁₀ from proteinase K in concentrations >62.5 μg/mL and PLA depolymerase concentrations >10 μg/mL (p<0.05). This data suggests that as the concentration of proteinase K and PLA depolymerase increased, there 379 was increasing bioplastic degradation leading to increasing amounts of by-products of degradation released into solution. A slight positive trend was also observed in our negative control containing the lysing enzymes from T. harzianum but was not significant compared to the no-enzyme control (p>0.05). Ultimately, both sets of data from residual bioplastic (See graph A of set of graphs 400 of FIG. 4) and degradation products in the supernatant (See graph B of set of graphs 400 of FIG. 4) indicate that proteinase K and PLA depolymerase are able to degrade our commercially available biodegradable plastic bags in solution.

In order to further validate the ability for proteinase K and PLA depolymerase to target bioplastics for degradation in-solution, as well as the efficacy of the spectrophotometric-based assay, the inventors analyzed the change in mass of bioplastics before and after incubation with these enzymes in comparison to the no enzyme controls (See graph C of set of graphs 400 of FIG. 4). A similar trend was observed to that in FIG. 3A, such that as concentrations of proteinase K and PLA depolymerase increase, the inventors observe a greater loss in mass of bioplastic (See graph C of set of graphs 400 of FIG. 4). When compared to their respective controls, there were statistically significant decreases in percent mass loss from proteinase K in concentrations >62.5 μg/mL and PLA depolymerase concentrations >100 μg/mL (p<0.05). Specifically, using a concentration of 4000 μg/mL of proteinase K the inventors observed an average of ˜21% (±1%) mass loss of starting bio-plastic material (p<0.05). Using PLA depolymerase the inventors observed an average of ˜32% (±3%) mass loss of starting bioplastic material using 1000 μg/mL of PLA depolymerase (p<0.05). A slight negative trend was also observed in our negative control containing lysing enzymes from T. harzianum but was not significant compared to the no-enzyme control (p>0.05). Some background degradation was expected since many bioplastic species are reported to degrade naturally in aqueous environments. Overall, the mass loss data confirms that the spectrophotometric-based assay is a quantitative assay that can be used to screen for enzymes with bioplastic degradation capabilities in a multi-well, medium-throughput format. Going forward, concentrations of 4000 μg/mL of proteinase K and 1000 μg/mL of PLA depolymerase were deemed optimal for future experiments.

FIG. 4 illustrates a set of graphs 400 showing proteinase K and PLA depolymerase activity towards commercially available bioplastic. Graph A shows a A₆₁₀-based detection of residual commercially available bioplastic upon proteinase K, PLA depolymerase and negative control (lysing enzymes from T. harzianum) incubation with bioplastic. Absorbance averages were normalized by no-enzyme control signal. Results are mean±std. error (n=8). Graph B shoes A₆₁₀-based detection of bioplastic by-product containing supernatant upon proteinase K, PLA depolymerase and negative control (lysing enzymes from T. harzianum) incubation with bioplastic. Absorbance averages were normalized by no-enzyme control signal. Results are mean±std. error (n=8). Graph C shows Mass-loss of commercially available bioplastic upon proteinase K, PLA depolymerase and negative control (lysing enzymes from T. harzianum) incubation at 37° C. and 24 h. Mass-loss averages were normalized by no enzyme control signal. Results are mean±std. error (n=3). The reference to “*” indicates significant difference from no-enzyme control (p<0.05).

To further assess how incubation time affects relative activity of proteinase K and PLA depolymerase towards commercially available bioplastic, the inventors assessed both enzyme end-point activities over 6-hour intervals (FIG. 5). Specifically, the inventors assessed relative bioplastic degradation at 0-, 6-, 12-, 18- and 24-hours with concentrations of 4000 μg/mL proteinase K and 1000 μg/mL PLA depolymerase. The inventors also included no enzyme controls to determine what effects each of the respective buffers had on the spectrophotometric-based assay and whether these results were represented in the mass loss assessments and consistent between all assays.

The spectrophotometric-based assay demonstrated an increase in degradation of commercially available bioplastics as incubation time increased with both proteinase K and PLA depolymerase enzymes. Generally, the inventors observed that as incubation time increased in 6-hour intervals there was an associated decrease in A₆₁₀ values from the residual bioplastic (See graph A of FIG. 5). Specifically for proteinase K compared to the control (0-hour reaction with 4000 μg/mL proteinase K), the inventors begin to observe a significant decrease (p<0.05) in relative A₆₁₀ values from as early as an initial 6-hour incubation. PLA depolymerase when compared to its control (0-hour reaction with 1000 μg/mL PLA depolymerase) demonstrated a significant decrease (p<0.05) in relative A₆₁₀ values from the residual bioplastic as early as 12-hours. There were also observed decreases in relative A₆₁₀ values in the no-enzyme controls as incubation time increased. Both sets of no-enzyme control data showed significant decrease (p<0.05) in relative A₆₁₀ values from the remaining residual bioplastic from the 18- and 24-hour when compared to the no-enzyme control 0-hour reaction (FIG. 4A). This was expected and is consistent with our previous observations of some loss in mass in our no-enzyme controls (See graph C of FIG. 4).

In analyzing the decanted supernatant at each time interval, the inventors observed an increase in relative A₆₁₀ values as incubation times increased with proteinase K and PLA depolymerase enzymes indicative of release of degradation products into solution (See graph B of FIG. 5). Specifically, relative A₆₁₀ values significantly increase (p<0.05) for both proteinase K and PLA depolymerase when the reaction time exceeded 6 hours, in comparison to the respective controls (0-hour reaction with enzyme present). Similar to the residual bioplastic analysis (See graph A of FIG. 5), both sets of no-enzyme control data showed significant increase (p<0.05) in relative A₆₁₀ values from the supernatant from the 18- and 24-hour reaction when compared to the no-enzyme control 0-hour reaction (See graph B of FIG. 5). This further supports that these bioplastics when in an aqueous environment can display some basal levels of degradation most likely attributed to hydrolysis of ester bonds.

Similar to what was done for our initial dilution curves (See graph C of FIG. 4), the inventors replicated our temporal experiments above using the mass-loss assessment (See graph C of FIG. 5). For both proteinase K and PLA depolymerase when compared to their respective controls (0-hour reaction with enzyme present), the inventors begin to observe a significant decrease (p<0.05) in relative percent mass from the 6-hour incubation period to the complete 24-hour reaction. Generally, the inventors observed an approximately 4-5% decrease in mass of bioplastic per 6-hour incubation period from the 6-hour to 24-hour incubation period. Here the inventors observe that over the initial 24-hour incubation period, there is a temporal-based factor in enzyme-mediated bioplastic degradation which increases from 0 to 24 hours of allocated reaction time. Consistent with other data in this study, the inventors observed a <6.5% decrease in mass loss in the no enzyme control samples after 24 hours. In both proteinase K and PLA depolymerase no-enzyme controls, only the 24-hour incubation time displayed significant loss (p<0.05) in remaining mass of bioplastic compared to the no enzyme 0-hour incubation control. Again, this further indicates basal levels of bioplastic degradation observed in our samples. Overall, the inventors have demonstrated the utility of our spectrophotometric-based assay to temporally screen enzyme degradation processes.

FIG. 5 illustrates a set of graphs 500 showing a temporal analysis of proteinase K and PLA depolymerase activity towards commercially available bioplastic. Graph A illustrates A₆₁₀-based detection of residual commercially available bioplastic upon reactions with proteinase K, PLA depolymerase and respective buffer only controls over 0-, 6-, 12-, 18- and 24-hour incubation periods. Enzyme-present absorbance averages were normalized by respective 0-hour incubation control. Buffer-only absorbance averages were normalized by respective 0-hour incubation control. Results are mean±std. error (n=8). Graph B illustrates A₆₁₀-based detection of bioplastic by-product containing supernatant upon reactions with proteinase K, PLA depolymerase and respective buffer only controls over 0-, 6-, 12-, 18- and 24-hour incubation periods. Enzyme-present absorbance averages were normalized by respective 0-hour incubation control. Buffer-only absorbance averages were normalized by respective 0-hour incubation control. Results are mean±std. error (n=8).

Graph C illustrates mass-loss-based detection of residual commercially available bioplastic upon reactions with proteinase K, PLA depolymerase and buffer only controls over 0-, 6-, 12-, 18- and 24-hour incubation periods. Enzyme-present mass-loss averages were normalized by respective 0-hour incubation control. Buffer-only absorbance averages were normalized by respective 0-hour incubation control. Results are mean±std. error (n=3). The “*” indicates significant difference from no-enzyme controls (p<0.05).

To further validate the efficacy of our A₆₁₀-based enzyme screening assay for enzyme-mediated bioplastic degradation, the inventors sought to demonstrate through other analytical methods that the inventors were in fact observing plastic degradation via proteinase K and PLA depolymerase. To help confirm enzyme-mediated plastic degradation, scanning electron microscopy was used to directly observe signs of bioplastic degradation. A high and medium enzyme concentration along the dilution curves used in both the spectrophotometric-based assay and the mass loss assessments (See FIG. 4) were chosen, along with a no-enzyme control. The inventors observed a dose-responsive relationship between increasing enzyme concentration and numbers of “holes” in the bioplastic as a result of enzymatic-mediated degradation (See images A-F of FIG. 6). A non-enzyme/buffer treated control of bioplastic was imaged as a ‘non-treated’ reference. ImageJ was used to quantify the number of holes produced between enzyme and no-enzyme treatments. As observed in images A-C in FIG. 6 increasing concentration of proteinase K resulted in an increase in the number of the holes in the bioplastic. Specifically, in 3489 μm² of bioplastic surface the inventors observed the following: 47 holes with the no-enzyme control, 218 holes with 250 μg of proteinase K, and 388 holes with 4000 μg of proteinase K (See image A, FIG. 6). A similar trend was observed when bioplastic was incubated with PLA depolymerase (See images D-F of FIG. 6): 22 holes were quantified in the no-enzyme control, 158 holes with 100 μg of PLA depolymerase, and 718 holes with 1000 μg of PLA depolymerase (See graph B of FIG. 7). The visual observation of the “holes” created in the no enzyme controls of this experiment provides further evidence of basal levels of bioplastic degradation during experiments in this study. Although the entire 3489 μm² of bioplastic was examined, there does appear to be local regions of high and low degradation.

FIG. 6 illustrates the scanning electron microscopy (S.E.M.) images of degraded commercially available bioplastic. Image A illustrates a bioplastic after 24-hour incubation with Tris-based buffer. Image B illustrates a bioplastic after 24-hour incubation with 250 μg/mL proteinase K in Tris-based buffer. Image C illustrates a bioplastic after 24-hour incubation with 4000 μg/mL proteinase K in Tris-based buffer. Image D illustrates a bioplastic after 24-hour incubation with protein storage buffer plus Triton X-100. Image E illustrates a bioplastic after 24-hour incubation with 100 μg/mL PLA depolymerase in protein storage buffer plus Triton X-100. Image F illustrates a bioplastic after 24-hour incubation with 1000 μg/mL PLA depolymerase in protein storage buffer plus Triton X-100.

FIG. 7 illustrates a set of graphs 700 related to a quantification of number of “holes” detected by scanning electron microscopy (S.E.M.) per 3489 μm² of commercially available bioplastic upon enzyme-treatments. Graph A illustrates a quantification of “holes” in bioplastic after 24-hour incubation with and without proteinase K. Graph B illustrates a quantification of “holes” in bioplastic after 24-hour incubation with and without PLA depolymerase. Quantification analysis were done with S.E.M. images using Image J's “Analysis of particles” feature.

Nuclear magnetic resonance (NMR) spectroscopy of the supernatants of in vitro reactions was used to observe bioplastic by-products produced through Proteinase K- and PLA depolymerase-mediated degradation. Specifically, the inventors sought to determine if there was an increase in bioplastic by-products as a result of degradation, as well as identify the by-products. As PLA depolymerase acts as a hydrolase and sequentially hydrolyzes ester bonds down ester-containing bioplastic polymers, and a proteinase K intrinsic mechanism of protein degradation is via Ser/Thr targeted degradation, the inventors hypothesized that the inventors would observe different end products through incubation with each respective enzyme. As the authors were not aware of what the initial material of the commercially available bioplastic were, the inventors were unable to identify the species of bioplastic by-products produced via enzymatic-mediated degradation. As for bioplastics incubated with PLA depolymerase, the inventors observed an increase in three signals, which likely originate from degradation products. The inventors were not able to observe similar by-products from bioplastic incubated with proteinase K. These results compliment that of graph B of FIG. 4 where the inventors saw a large increase in the A₆₁₀ values in samples with a high concentration of PLA depolymerase. Although these results alone are not indicative of any signs of degradation, the authors feel the NMR results of the PLA depolymerase incubation in conjunction with the spectrophotometric-based assay, mass loss measurements and SEM data all show evidence that these enzymes degrade commercially available bioplastics.

It is well known that both temperature and co-factors such as Ca²⁺ can influence proteinase K activity. In light of this, the inventors sought to determine whether they could quantify proteinase K relative activity towards commercially available bioplastic using a spectrophotometric-based assay at different temperatures, as well as in the presence of 1 mM CaCl₂) and 1 mM CaCl₂) with 2 mM EDTA as a Ca²⁺ chelating agent. Using the spectrophotometric-based assay, the inventors observed how incubating proteinase K with commercially available bioplastic at temperatures of 37° C. and 65° C. effected degradation of the bioplastics. Upon analyzing the residual bioplastic after incubation of bioplastic at varying proteinase K concentrations, there was an observed decrease in relative A₆₁₀ as proteinase K concentrations increased compared to the no enzyme controls (See graph A of FIG. 8). There were statistically significant differences in 37° C. vs 65° C. temperatures in samples containing 62.5 μg/mL, 1000 μg/mL, and 4000 μg/mL proteinase K but none at the other concentrations (p<0.05). In analyzing the decanted supernatant upon reaction completion, the inventors observed an increase in relative A₆₁₀ as proteinase K concentrations increased compared to the no-enzyme controls (See graph B of FIG. 8).

Consistent with the previous residual bioplastic analysis the inventors observed statistically significant differences in proteinase K activity between relative A₆₁₀ as a result of the difference in 37° C. vs 65° C. incubation temperatures at higher concentrations of 1000 μg/mL and 4000 μg/mL proteinase K (p<0.05). Although at both 37° C. and 65° C. the end-point activity curves followed the same trend of increased proteinase K activity as concentration increased, there were statistically significant differences in relative A₆₁₀ values observed between many of the proteinase K concentrations data observed in both the residual bioplastic and supernatant sample. As such, the incubation temperature of 37° C. appears to be superior for proteinase K-mediated degradation of commercially available bioplastic relative to 50° C. or 60° C. This is significant as it demonstrates that the spectrophotometric-based assay can be used to optimize bioplastic degradation over various temperatures.

Similar to above, the spectrophotometric-based assay was used to observe effects of incubating proteinase K with commercially available bioplastic on its own (enzyme only), in the presence of 1 mM CaCl₂) (enzyme+CaCl₂)) and in the presence of 1 mM CaCl₂) and 2 mM EDTA (enzyme+CaCl₂+EDTA) (See graphs C-D of FIG. 8). A two-way ANOVA was performed to compare the effect of how the three different reaction conditions alter proteinase K activity towards the bioplastic. For the residual bioplastic samples, generally as Ca²⁺ concentration increased, there was a decrease in absorbance between our different enzyme reactions (See graph C of FIG. 8). It appears that there was an interaction between the two independent variables between concentration and enzyme reaction condition, however, this was not 593 statistically significant (F(2,66)=[3.12], p=0.051). The addition of CaCl₂) did significantly alter absorbance compared to the enzyme only control (TukeyHSD, p=0.002). The addition of CaCl₂) and EDTA had no significant effect compared to the reactions just with CaCl₂) (TukeyHSD, p=0.126) nor compared to the enzyme only control (TukeyHSD, p=0.234). In analyzing the decanted supernatant upon reaction completion in comparison to the no-enzyme controls, the inventors observed across all reaction conditions there was an increase in relative A₆₁₀ as proteinase K concentrations increased (See graph D of FIG. 8). Similar to above, a two-way ANOVA was performed to compare results between reaction conditions and there was not a significant interaction between our reaction conditions and increasing values of absorbance (F(2,66)=[2.47], p=0.092). The addition of CaCl₂) did significantly alter absorbance compared to the enzyme only control (TukeyHSD, p=0.002) and the CaCl₂) and EDTA (TukeyHSD, p=0.009). The addition of CaCl₂) and EDTA had no significant effect compared to the enzyme only control (TukeyHSD, p=0.844). Overall, it appears that the addition of CaCl₂) to the reactions did improve the activity of proteinase K towards the commercially available bioplastic in comparison to the enzyme-only control. This is significant as it demonstrates that the spectrophotometric-based assay can be used to evaluate how cofactors influence enzyme-mediated degradation of bioplastics.

FIG. 8 illustrates effects of temperature and CaCl₂) of proteinase K activity towards commercially available bioplastic. Graph A illustrates A₆₁₀-based detection of remaining commercially available bio-plastic upon proteinase K incubation with bioplastic at 37° C. and 65° C. Absorbance averages were normalized by no-enzyme control signal. Results are mean±std. error (n=4). Graph B illustrates A₆₁₀-based detection of bioplastic by-product containing supernatant upon proteinase K incubation with bioplastic at 37° C. and 65° C. Absorbance averages were normalized by no-enzyme control signal. Results are mean±std. error (n=4). Graph C illustrates A₆₁₀-based detection of remaining commercially available bioplastic upon proteinase K incubation with no co-factors, 1 mM CaCl₂) and 1 mM CaCl₂+2 mM EDTA added. Absorbance averages were normalized by no-enzyme control signal. Results are mean±std. error (n=4). Graph D illustrates A₆₁₀-based detection of bioplastic by-product containing supernatant upon proteinase K incubation with no co-factors, 1 mM CaCl₂) and 1 mM CaCl₂+2 mM EDTA added. Absorbance averages were normalized by no-enzyme control signal. Results are mean±std. error (n=4). The “*” indicates significant differences at specified time points (p<0.05).

While there have been advancements in identifying enzymes that can degrade petroleum-based plastics and biodegradable plastics, limitations surrounding a medium-/high-throughput assay that can be used to screen candidate enzymes persist. Mass-loss measurements are commonly used but these assays represent relatively low throughput processes, require long assay times and relatively large reagent quantities, and require further assays or analytical methods to confirm the mass-loss data. Other analytical approaches such as NMR, SEM, gel permeation chromatography and plate emulsification assays have assisted in finding candidate enzymes but may be cost-prohibitive and/or require long incubation/sample analysis time and specialized equipment. Here, the inventors demonstrate a novel, medium-throughput screening method that combines low volume and low sample requirements. The method has the advantage of assaying both residual remaining bioplastic and bioplastic by-products in order to screen candidate enzymes for bioplastic degradation. Using this method, the inventors demonstrate the ability for candidate enzymes to degrade commercially available biodegradable plastic/bioplastics.

To date, a majority of research into plastic/bioplastic degrading enzymes has been performed on pure plastic/bioplastic species. However, commercially available compostable bioplastics that are comprised of several plastic species are common pollutants in environments. Here, the inventors show that bioplastic-degrading enzymes proteinase K and PLA de-polymerase degrade commercially available bioplastic after overnight incubation, the inventors demonstrate statistically significant bioplastic degradation based on both reduction in residual bioplastic and release of bioplastic degradation by-products into the supernatant in reactions with proteinase K concentrations >250 μg/mL (See graphs A-B of FIG. 4). Similarly, PLA depolymerase treatments resulted in reduction of residual plastic and release of degradation by-products at concentrations >100 μg/mL (See graphs A-B of FIG. 4). Degradation of commercial bioplastics by both enzymes was further confirmed by mass-loss and SEM assessment.

It should be noted that for proteinase K samples there is a smaller increase in the relative A₆₁₀-values for supernatant samples for both proteinase K concentration (Sec graph B of FIG. 4) and reaction time (See graph B of FIG. 5) experiments in comparison to the PLA depolymerase samples. This is most likely due to moieties in the commercial proteinase K enzyme preparation that lower overall turbidity of the solutions upon emulsification, such as salts. When both the 4000 μg/mL and 0 μg/mL proteinase K incubation time points are subtracted to the 0 μg/mL 0-hour proteinase K reaction, the inventors observe that the 4000 μg/mL proteinase K sample had a significantly lower raw A₆₁₀ value compared to its no-enzyme control counterpart. This observation suggests that when any proteinase K is added to a solution that is emulsified with the emulsifying agents (CHCl₃ and Triton X-100) used in this study, the solution becomes less turbid. As a result, this likely explains why the A₆₁₀-based supernatant analysis yields less difference between high and lower/no enzyme concentrations for proteinase K that it does for PLA depolymerase and why those same effects aren't observe in the residual bioplastic samples. This is significant as enzyme additives, whether commercial or added in-house, must be considered when applying this enzyme for screening purposes to ensure collection of accurate data.

Supporting the literature suggesting the hydrolysis-susceptible nature of a variety of bioplastic species as a result of their ester-bond linkages, the inventors did observe low levels of the commercially available bioplastic degradation in all of the no enzyme-controlled experiments, hence the need to report all assay data in relative amounts. Direct observation of background levels of bioplastic degradation can be made in both graph A of FIG. 6 for proteinase K and graph D of FIG. 6 for PLA depolymerase no enzyme controls. It appears the added components (10% glycerol, 150 mM NaCl, 0.5 mM DTT) in the protein storage buffer in the PLA depolymerase no-enzyme control resulted in reduced basal levels of degradation compared to the 50 mM Tris-base buffer that was present in the proteinase K control. This could be attributed to the presence of NaCl in the protein storage buffer as it has been reported that some bioplastic species such as PLA do not degrade naturally in seawater. Specially, the presence of salts in the seawater affects the diffusion of water into various biopolymers resulting in less natural hydrolysis and slower degradation.

The inventors observed increases in PLA-depolymerase degradation by-products through the NMR analysis but not with proteinase K. A possible explanation is that proteinase K bioplastic degradation products may be much larger than those of PLA depolymerase. This may indicate that proteinase K cuts the bioplastic polymers internally rather than processively from ends. In this case, proteinase K by-products may be retained in the spin-column used to remove remaining proteinase K from the supernatant upon completion of the overnight incubation. The combination of our spectrophotometric-based assay and NMR may, therefore, may provide interesting insights into enzymatic degradation mechanisms of commercial bioplastics, although more research still needs to be done to confirm this theory.

Almost all studies to date have focused on the ability of enzymes to degrade pure bioplastic or petroleum-based single-use plastics. Although this is critical information as it provides substrate targeting information on which enzymes and families of enzymes can target bioplastics, the practical application of these enzymes for commonly used bioplastics in society has not yet been fully investigated. Given the persistent problem of plastic pollution in a variety of waste systems, ecosystems and landscapes, it is critical to investigate enzymes that can degrade common commercially available bioplastics in a facile manner with minimal additives. Moreover, it is critical to identify which enzymes can produce significant degradation in a short time frame (<24-48 hours). Indeed, it is difficult to decipher what constitutes significant enzyme-mediated bioplastic degradation. As the initial findings demonstrate, a 20%-30% mass reduction after overnight incubation of proteinase K and PLA depolymerase could result in a large reduction of bioplastics in local waste systems and environments. Although bioplastics account for only 1% of the global 370 million tons of total world plastic generated, this number is expected to grow upwards of 30% in 2023, to an estimated one-hundred and ten million tons of global bioplastics. Assuming one-hundred million tons of bioplastic were accessible to be degraded via enzymes at rates our initial findings suggest, that could accumulate to 20-30 million tons of bioplastic removed before it even ends up in waste systems and environments. However, this is a gross over-simplification for the changes in household and waste management industries that would be required to impose such a large reduction in bioplastic degradation. The inventors do recognize the major hurtle for such a goal is to produce large enough quantities of these candidate bioplastic degrading enzymes. Bioplastic degrading enzymes could also aid in turning plastic waste into by-products of value. Thermal pyrolysis can be used to integrate thermostable enzymatic bioplastic degrading enzymes such as proteinase K for the conversion of PLA-PET into fuel oil.

### Enzyme Discussion

The disclosed approach is to cover various ways of introducing enzymes into a bucket 110 or batch that includes waste 104 and that can also include food (which can have fats, oils or grease) and/or biodegradable plastics. In general, the enzymes that are contemplated as being added to the batch of waste fall under the class of hydrolase, although other classes are contemplated as well. The enzymes or enzyme sub-classes include at least one or more of: (1) Lipases, (2) Proteases, (3) Proteinase K, (4) PLA depolymerase, (5) Esterase and (6) Cutinase. Other enzyme can be included as well such as cellulases, amylases, lignases, proteinases, glucosidases, xylanases, peptidases, Phospholipases, and chitinases. For biodegradable plastic degradation, the inventors have conducted experiments as discussed herein with enzyme families (1)-(4).

In some cases, enzymes can be engineered to provide improved efficiency in the context of being included in the waste recycler 100 for enzyme-mediated degradation of bioplastics, other plastics, fats, oils and grease as well as waste food. Enzymes can be engineered in for regular plastic plus biodegradable plastic degradation with enzyme families (5)-(6) above. The inventors have demonstrated the ability to apply Lipases (family (1) above) to the waste recycler 100 to mitigate degradation of fats, oils and grease when processing waste that includes these materials.

Multiple hydrolase enzymes can degrade biodegradable plastic in vitro. Specifically, Lipases can degrade biodegradable plastic in the waste recycler 100. Lipases can be or can ben engineered to be thermally stable, making it more effective to degrade biodegradable plastic in the waste recycler 100. In some cases, a certain type and amount of buffer, the presence of co-factors, and incubation time can all be optimized to allow for optimal enzyme-mediated degradation of biodegradable plastic.

In some cases, a mass reduction of 30% in bioplastic bags after enzyme treatment in vitro has been established. This can include an enzyme-mediated degradation while running a waste recycler 100 process or algorithm. In other cases, the inventors have shown a reduction upwards of 80% in observable remnants of a bioplastic bag after a pre-treatment period of time or separate process is used as part of the waste recycler 100 process to enable the enzyme to degrade the bioplastic.

Engineered enzymes to degrade biodegradable plastic, and/or regular plastic have been and can be further developed to improve the efficiency of this process.

With respect to fats, oils and grease (FOGs), lipases can degrade FOGs in vitro and data has shown that lipases can degrade FOGs in the waste recycler 100. For example, the inventors have generated a reduction of <˜50% of oil and other FOGs in the waste recycler 100. Lipase reaction can be optimized for improved FOG degradation and waste processing algorithms can further be adjusted to improve or further optimize FOG degradation during a waste processing cycle.

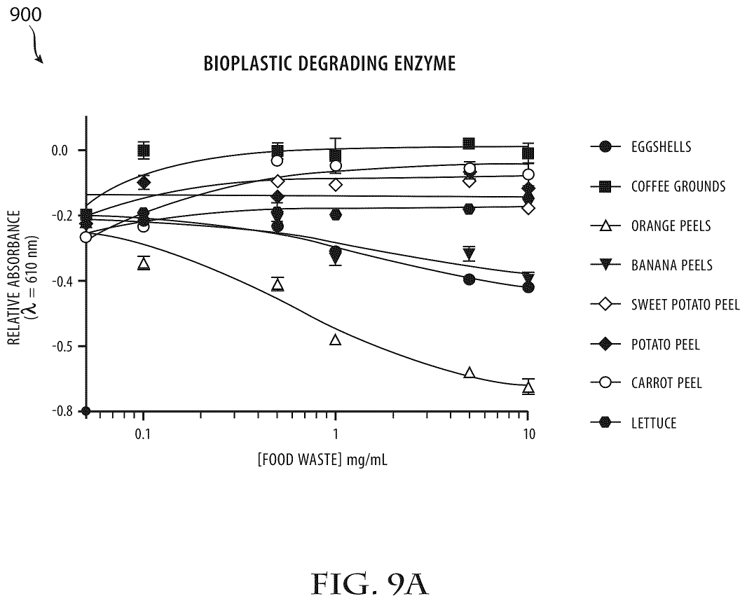

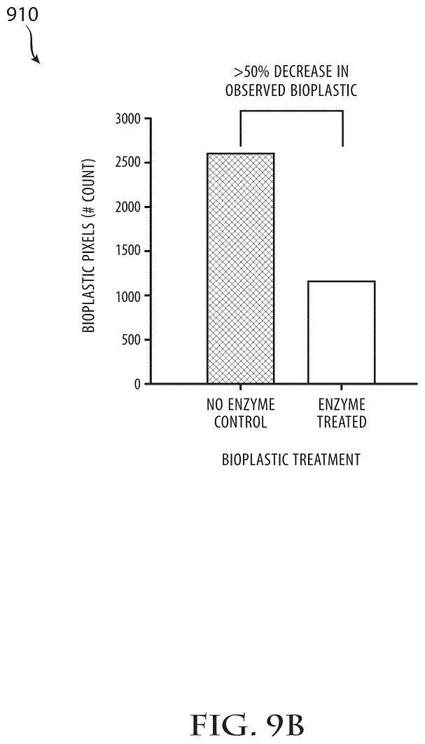

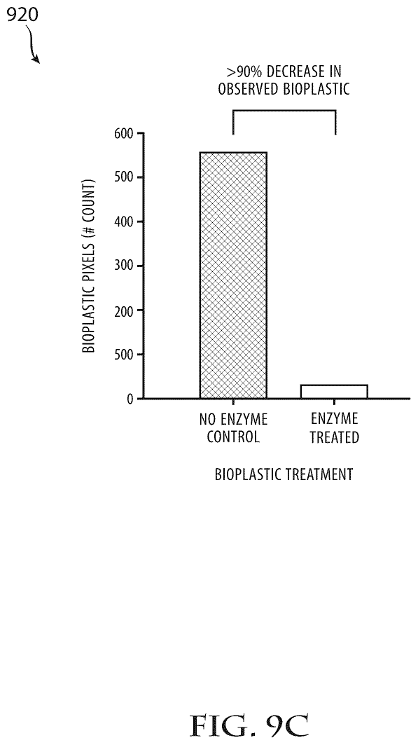

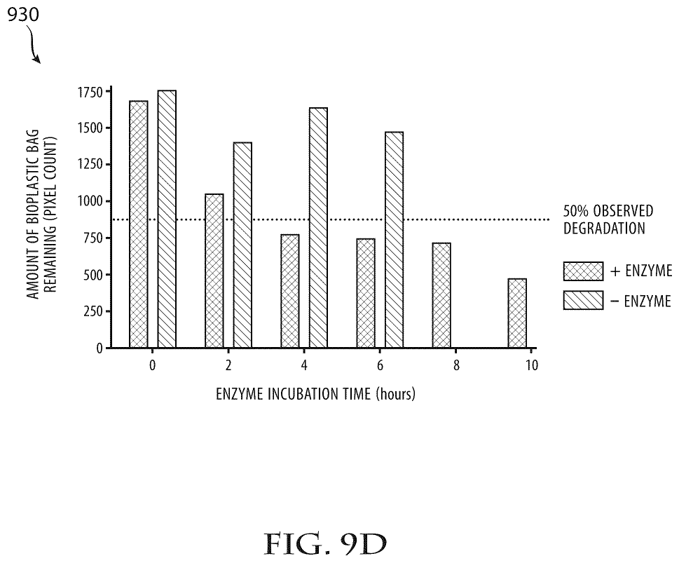

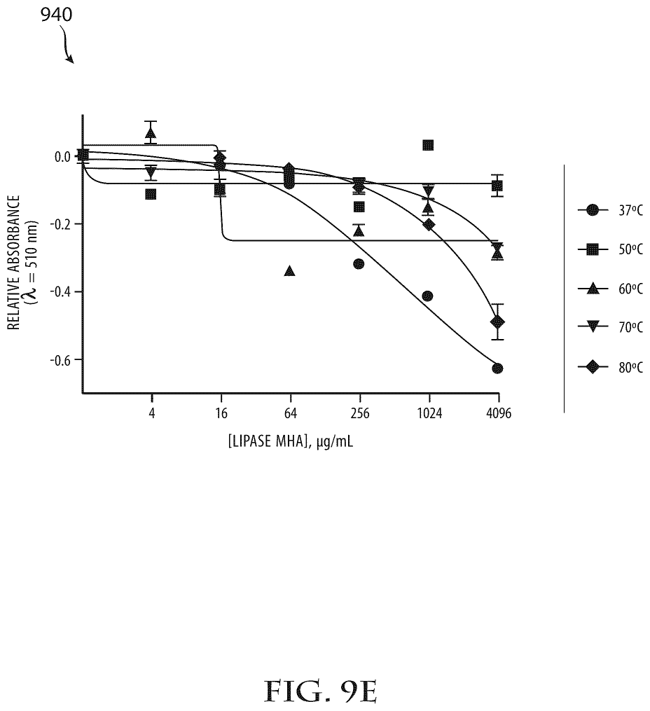

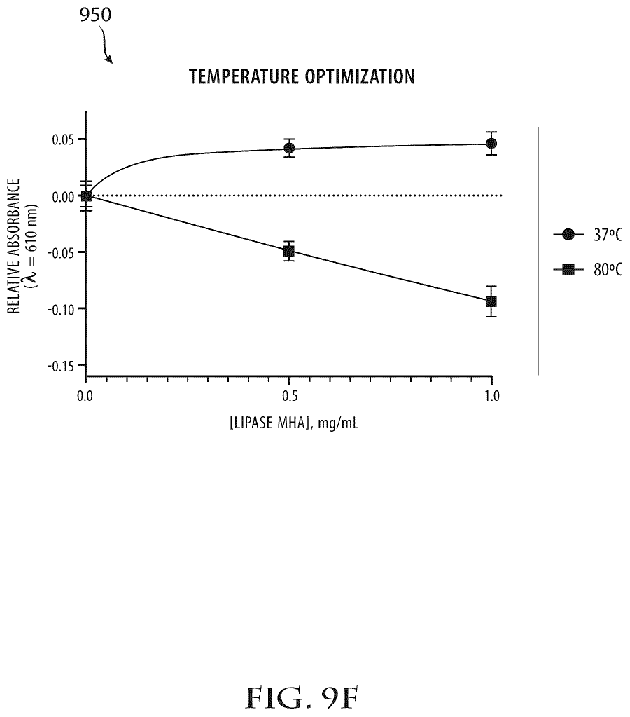

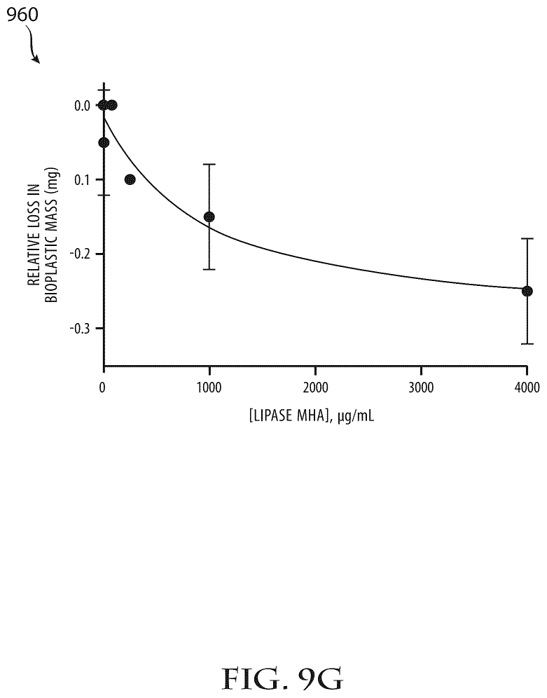

FIG. 9A illustrates a graph 900 that shows enzyme-mediated bioplastic degradation for various foods, in accordance with some aspects of this disclosure. The inventors assessed the activity of candidate enzymes in presence of food waste rich in nutrients/biomolecules. Some food waste (orange peels, eggshells) increase activity of the enzyme with respect to the effectiveness of the enzyme to degrade bioplastics. Some food waste (coffee grounds) had no effect on enzyme activity. Lipases were focused on more as an effective enzyme based on these studies. Note that based on these results, the waste recycler 100 can adjust its processing algorithm when certain food waste is available or in a batch of waste. For example, a sensor 118 can be used to determine whether orange peels or eggshells are in the batch of waste and how much is present. Because the inclusion of these food items increases enzyme activity, the waste processing algorithm can be adjusted to perhaps reduce a pre-treatment time and/or change a temperature setting to complete the cycle more quickly. In other cases, some food items won't impact the enzyme activity and other foods may reduce the enzyme activity. In general, the waste recycler 100 can detect what food items are in a batch of waste and determine the impact of enzyme activity on bioplastics, plastics and/or FOGs due to the food items and determine whether or not to adjust a waste processing algorithm for a processing cycle. If the determination is yes to adjust the waste processing algorithm, the waste recycler 100 can either adjust an algorithm or select from a plurality of waste processing algorism and begin the cycle.

FIG. 9B illustrates degradation of food waste and a bioplastic for a period of time where enzyme degradation is used following a standard waste processing cycle, in accordance with some aspects of this disclosure. A graph 910 illustrates how there is a greater than 50% decrease in observed bioplastic when there is enzyme treatment applied. In one example, the inventors studied a 10 hour enzyme degradation in a waste recycler 100 followed by a standard cycle for 600 grams of food waste, 250 mL water (no enzyme control) of buffer (enzyme treated) and one large bioplastic bag which provided about 49 grams of bioplastic and 5 grams of lipase enzyme or a commercially available lipase enzyme.

FIG. 9C illustrates a period of time used for enzyme-mediated degradation followed by a standard waste processing cycle, in accordance with some aspects of this disclosure. A graph 920 shows a greater than 90% decrease in observed bioplastic for a ten-hour enzyme degradation period followed by a standard food processing cycle. As with FIG. 9B, the inventors studied in this case a 10 hour enzyme degradation period of time in a waste recycler 100 followed by a standard cycle for 600 grams of food waste, 250 mL water of buffer and one large bioplastic bag which provided about 49 grams of bioplastic and 5 grams of lipase enzyme such as a commercially available lipase enzyme. In this case, the additional decrease can be due to an adjustment or modification of the waste recycling algorithm to increase the grinding that is performed. There may be various grinding mechanisms that can be used when running a standard waste processing cycle. In other words, different grinding structures, or turning or rotation of the waste could be used as part of the processing cycle.

FIG. 9D illustrates use of a lipase MHA in the presence of food waste in a time graph 930, in accordance with some aspects of this disclosure. Lipase MHA was studied in a waste recycler 100 with bioplastic plus food waste. The inventors assessed activity of Lipase MHA in the presence of food waste and after a desired enzyme incubation period of time, the inventors ran food waste/bioplastic samples through standard food processing cycle. In one example, the inventors used 1 kg homogenized food waste input and included an enzyme incubation period of time held at 37° C. for each allocated pre-treatment period. The inventors used 250 mL 50 mM Tris-base buffer pH 8.0 and incubated with and without the enzyme. The inventors have shown that decrease in bioplastic is not necessarily the result of increased initial grinding, although part of this disclosure does include altering the grinding aspect of the waste processing algorithm. The lipase MHA appears to influence bioplastic biodegradation as shown in the time graph 930 which covers the amount of bioplastic bag remaining relative to enzyme incubation time in hours. The result is that the new process achieved over ˜50% reduction in 4-6 hour pre-treatment time. The study helps guide the inventors in the determination of how to adjust the waste processing cycle to provide an enzyme incubation time period (or other changes to the cycle) prior to resuming waste processing as would occur if just food waste was included in the bucket. Changes also can be made to other parts of the waste processing cycle as are disclosed herein, such as providing a high temperature at the end of the cycle to denature the enzyme or to cool the temperature in the bucket 110 to prevent hot food waste from reducing the effectiveness of the enzyme 102.

Different amounts of degradation of bioplastics occur at different amounts of enzyme incubation time. Thus, in some aspects, the waste processing algorithms may be set, predetermined, adjusted based on sensed data, or chosen manually by a user to balance an amount of degradation desired given how much time is available. For example, a user may not have much time before they desire the end product of the waste recycling process and thus choose a shorter enzyme incubation time (such as four hours instead of ten hours) to obtain some biodegradation of bioplastics, or other materials, but not perhaps the full amount possible which would be available for a longer enzyme incubation time.

FIG. 9E illustrates the application of lipase for temperature optimization, in accordance with some aspects of this disclosure. An absorbance graph 940 is shown which compares an amount of lipase MHA to a relative absorbance for different temperatures. In one aspect, the inventors used lipase MHA as the enzyme and used an eco-products bag as a substrate. The inventors studied the stable temperature range of lipase MHA. In association with an overnight reaction, the inventors examined at what highest temperature was stability+activity of enzyme observed. The results were that the enzyme was stable up to +80° C. and maintained 50-80% of activity over the range of 37-80° C. after 24 hrs.

FIG. 9F illustrates the use of lipase MHA and bioplastics for temperature optimization, in accordance with some aspects of this disclosure. A relative absorbance graph 950 shows an amount of lipase MHA relative to absorbance for two different temperatures. The inventors assessed lipase MHA activity in a four-hour incubation time which is one example pre-treatment time for a waste recycler 100. Two different studies were held, one at 37° C. and one at 80° C., each for four hours. The results of the study showed that lipase MHA functions well at 80° C. and performs better at 80° C. then at 37° C. in a shorter reaction incubation period. Reaction included the use of the enzyme, a bioplastic, and a buffer.

FIG. 9G illustrates the use of a lipase MHA with aircarbon to evaluate loss in bioplastic mass, in accordance with some aspects of this disclosure. A relative loss graph 960 is shown to illustrate or evaluate the loss in bioplastic mass. Lipase MHA with an aircarbon was assessed for the activity of lipase MHA towards plastic cutlery in vitro. The substrate used was PHB (Polyhydroxybutyrate) rather than PLA as in bioplastic bags. The reaction time of the lipase MHA for 24 hours at 37° C. is shown.

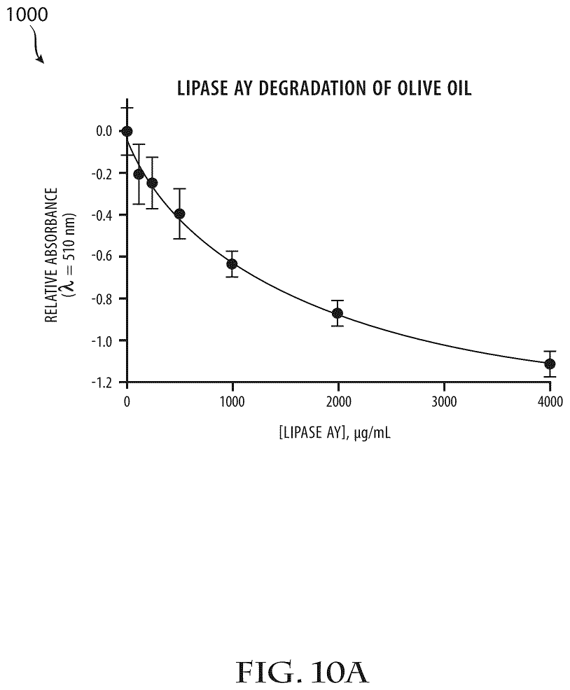

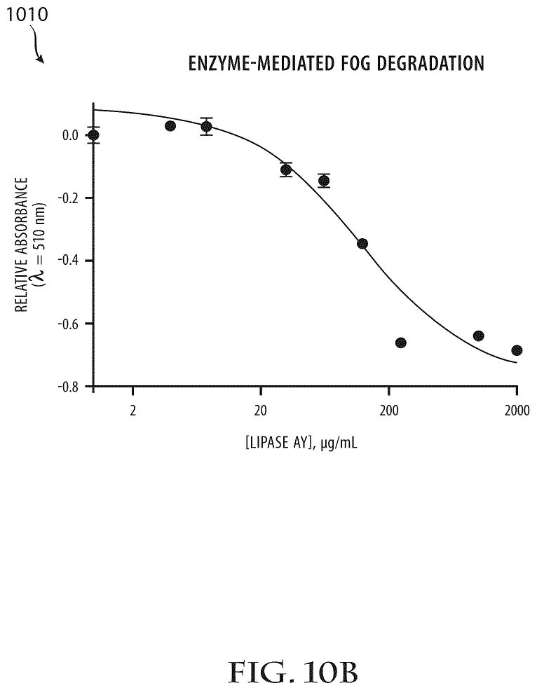

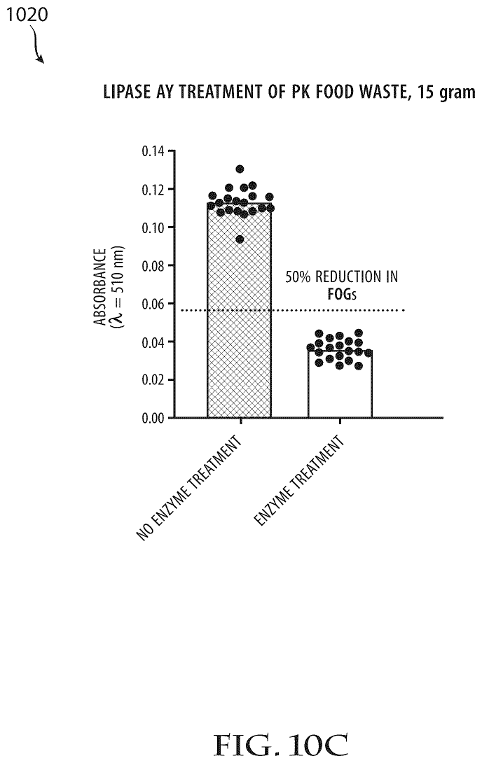

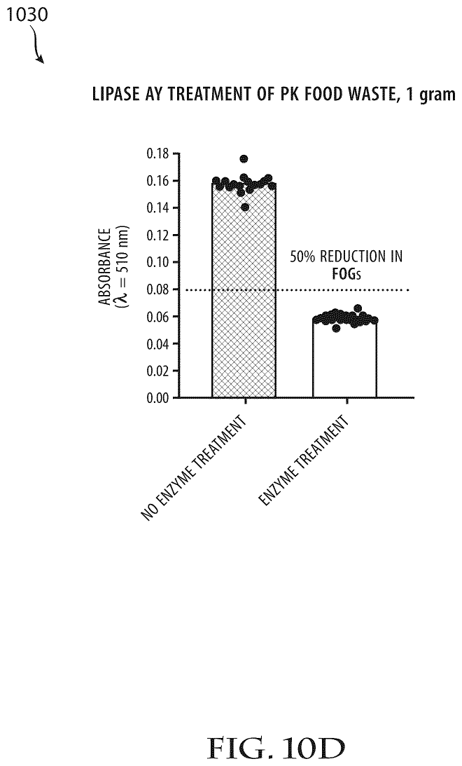

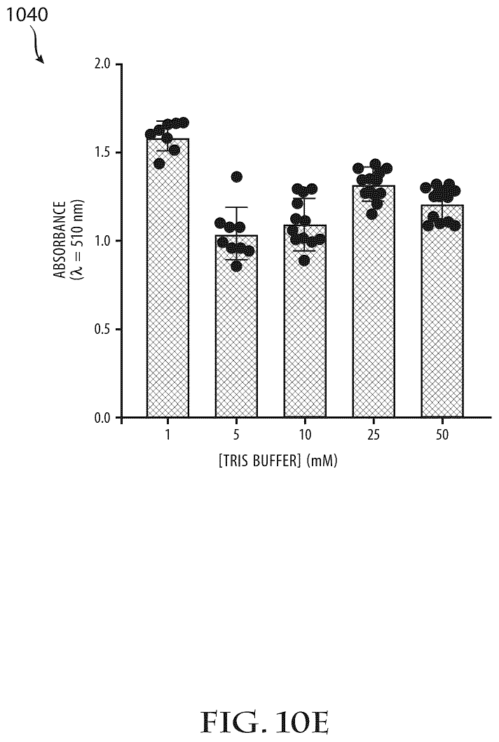

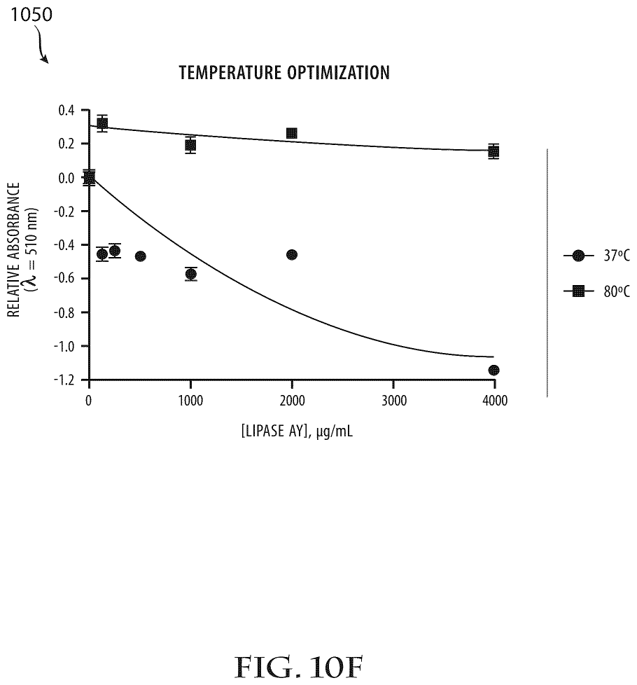

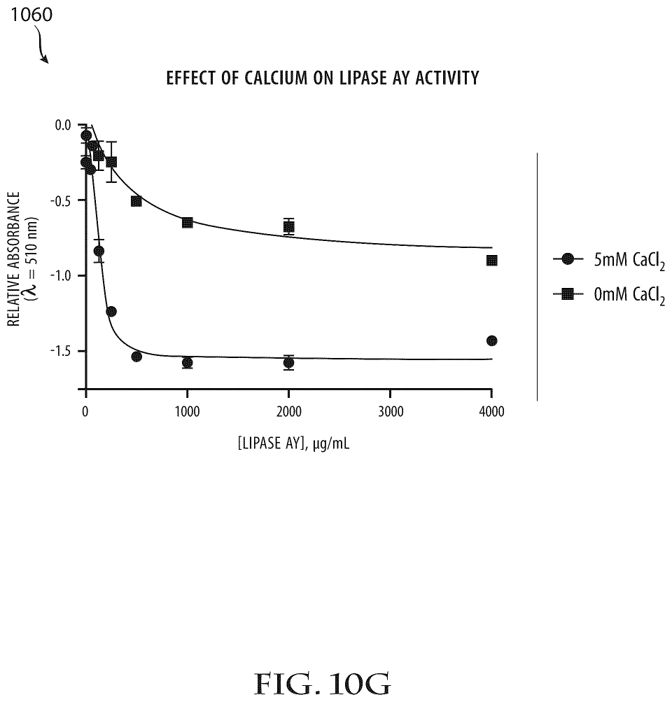

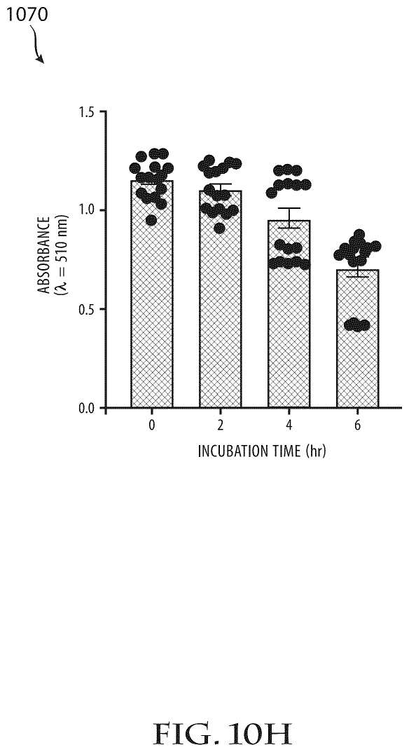

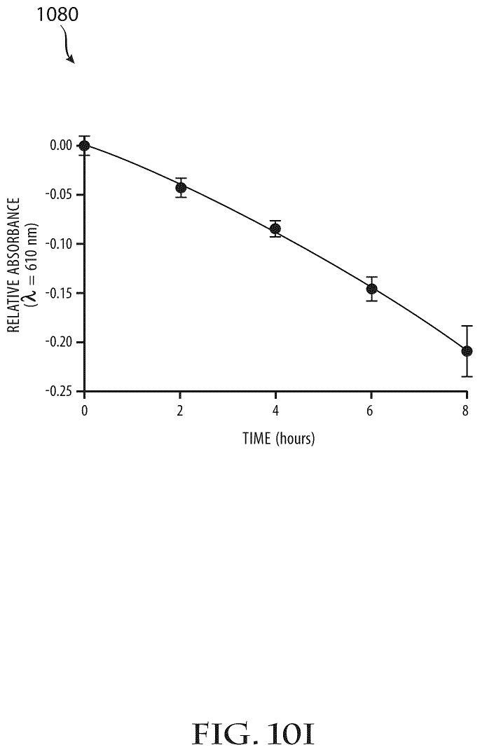

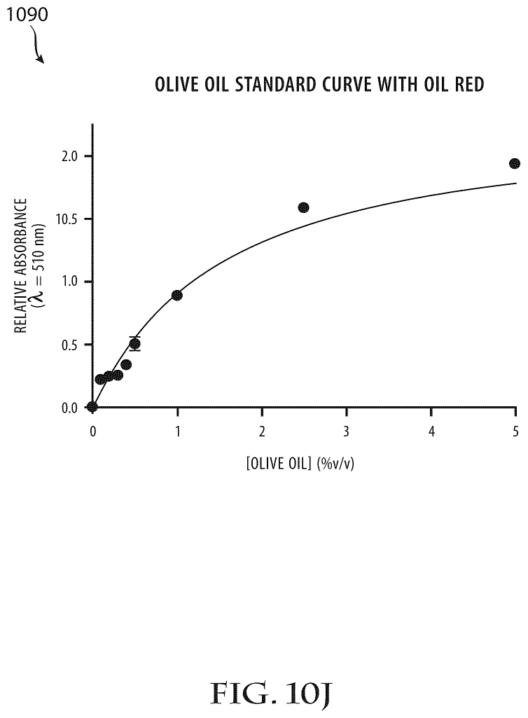

The inventors have also studied enzyme-mediated degradation of fats, oils and grease (FOG) in a waste recycler 100. FIG. 10A illustrates data in a graph 1000 for lipase AY degradation of olive oil. The inventors applied commercially available enzymes that naturally target fats and oils and lipase AY were reacted overnight at 37° C. with 2.5% (v/v) olive oil. The inventors observed a dose-responsive relationship as lipase concentration increased. A decrease in absorbance (y-axis)=less remaining oil compared to no enzyme control. Preliminary results indicate commercially available lipases can break down common cooking oils.

FIG. 10B illustrates a fats, oils and grease assay in an enzyme-mediated FOG degradation graph 1010. The inventors applied commercially available enzymes that naturally target fats and oils to restaurant waste or food waste with fat, oil and/or grease content. The lipase AY were reacted 10 hours at 37° C. with 22.5 mg of restaurant waste (microscale). The study shows that one can apply commercially available enzymes to breakdown food waste saturated with cooking oils. The inventors observed a dose-responsive relationship as lipase concentration increased. A decrease in absorbance (y-axis)=less remaining oil compared to no enzyme control. Note that the information about what enzymes can be used to also break down food waste can impact how the waste recycler 100 can adjust or be instructed to choose or adjust a waste processing algorithm in which enzymes are included in the bucket or vessel.

FIG. 10C illustrates a lipase AY treatment of restaurant food waste graph 1020 for 15 grams of food with a comparison of no enzyme treatment and enzyme treatment and the reduction in FOGs. The inventors applied commercially available enzymes that naturally target fats and oils to restaurant food waste (e.g., French fries) in a waste recycler 100. In some cases, 5.5 g of lipase AY was reacted for 10 hours at 37° C. with 1 kg of restaurant food waste. After the 10 hours, the food waste was placed into the waste recycler 100 for a regular cycle. The inventors also showed that one can degrade FOGs within the waste recycler 100, and that the by-product looked less greasy. In one test, there were two sample sizes, 15 g (5%) and 1 g (0.3%) of final mass to make sure there isn't a localization of oils.

FIG. 10D illustrates a one gram graph 1030 that compares lipase AY treatment of restaurant food waste with a comparison of no enzyme treatment and enzyme treatment which results in a 50% reduction as shown in the figure.

FIG. 10E illustrates a FOG enzyme optimization graph 1040, according to some aspects of this disclosure. Using lipase AY as have observed the most activity of the enzyme towards different FOGs in the proof-of-concept experiments. The inventors wanted to determine minimal amount of buffer required to observe maximal lipase AY activity towards FOGs. The sole purpose of a buffer is to accommodate any changes that occur to a mixtures of different pH levels. Initially, the inventors used 50 mM Tris buffer. Lipase AY was incubated at 1 mg/mL with 2.5% olive oil for 24 hours at 37° C. in buffering conditions. The results are shown with a 5-10× reduction in initial buffer can be applied to maintain lipase AY activity in vitro. The inventors were able to observe that at concentrations as low as 5-10 mM Tris buffer, activity was maintained in terms of how much absorption occurred.

FIG. 10F illustrates a FOG enzyme optimization related to temperature graph 1050. The inventors used lipase AY as the enzyme of interest during optimizations. The inventors wanted to determine the effects varying temperatures have on lipase AY activity in regard to FOG degradation. A study was done with lipase AY was run for 24 hours with 2.5% olive oil at 37° C. and 80° C. The inventors observed that at temperatures of 80° C., enzyme appeared to be inactive. At high temperatures, the result is often a relaxed enzyme tertiary structure, resulting in a loosened active and/or binding site.

FIG. 10G illustrates an effect of calcium on lipase AY activity graph 1060. FOG Enzyme optimization in this case included co-factors. The inventors applied amano enzymes that naturally target fats and oils. The introduction of co-factors allows for enzymes to function better. For example, lipase AY were reacted overnight at 37° C. with 2.5% (v/v) olive oil and the inventors observed a dose-responsive relationship as lipase concentration increased. The results show that the addition of CaCL₂ improves lipase activity. The data obtained from this study can be used to create an enzyme solution with a co-factor added and the knowledge of the characteristics of the enzyme solution might cause or require a change in a waste recycling algorithm to make adjustments for optimal degradation of plastics of FOGs.

FIG. 10H illustrates an incubation time graph 1070 that relates to FOG enzyme optimization. The inventors used lipase AY as the enzyme of interest during optimizations. The inventors wanted to determine the effects different incubation times have on quantifiable decrease in olive oil as a response to enzyme incubation. The studies applied no more then 6-hours tests. Based on these results, reactions with lipase AY at 1 mg/mL were run at 0, 2, 4, and 6 hours with 2.5% olive oil at 37° C., the inventors observed large decreases after 4-6 hours of lipase AY incubation, before this time incubation there is no notable differences. Again, these time frames are used when considering how to create various waste recycling algorithms or relate to how to adjust an existing algorithm to provide a pre-treatment time frame for enzyme-mediated degradation prior to running a waste processing cycle.

FIG. 10I illustrates a graph of relative absorption over time 1080 for lipase MHA at 80° C., according to some aspects of this disclosure. The graph of relative absorption over time 1080 shows steady absorption over two hour periods. The data obtained from the study related to FIG. 10I can guide the choice of waste processing cycle or algorithm when lipase MHA is used as the enzyme. For example, a 4 or 6 hour pre-treatment time might be chosen for the enzyme to degrade waste material prior to running a standard waste processing cycle in the waste recycler 100.

FIG. 10J illustrates a graph of a standard cure to detect olive oil with oil red 1090, in accordance with some aspects of this disclosure. The x-axis is the relative absorbance and the x axis is amount of olive oil.

### Enzyme Pods and Strips

In one example, the algorithm on the recycler may not need to be adjusted but the innovation may just be to receive bioplastics in a food recycler and receiving an enzyme pod or pouch as well and running the normal food recycling process via the food recycler. In this case, as the grinding tool begins to process the waste, the enzyme pouch will be broken open and the enzymes will begin to break down the bioplastics as part of the normal food recycling process. In this regard, the process can include receiving bioplastics in a bucket of a food recycler, receiving an enzyme pouch in the bucket of the food recycler, and running a food recycling processing via the food recycler that causes the pod to break open and the enzymes to start breaking down the bioplastics and then breaking down the bioplastics in the bucket through the food recycling process.

The food recycler can be composting device as well and can be a countertop device or a larger commercial device. Other composting devices can be used as well. Thus, the food recycler described herein and all the components can apply to a composting device or other device that may not be designed specifically for food recycling.

FIG. 11A illustrates an example hydrolytic pouch 1100 that includes a first portion or cavity having a buffer solution 1102 and a second portion or cavity having an enzyme solution 1104. The buffer solution can be used to prevent a sever pH-change and therefore a possible denaturation of the enzyme. The buffer solution can maintain the concentration of hydrogen ions in the solution. The chemical component of the buffer can play a role in the enzymatic reaction. Changing the buffer system is therefore useful to increase and control product formation. Since enzymes are sensitive to pH changes, an enzyme operating in a buffer solution can be helpful to keep the pH constant.

The housing or pouch container 1106 can be made from a material that can dissolve in a water solution which will then release the buffer solution 1102 and the enzyme solution 1104. Different size hydrolytic pouches 1100 can be used for different sized projects. For example, as an example, a 2-3 cm² pouch may be used for 1-2 L bucket volumes in which the bucket represents a size of bucket that will receive one or more of food waste and bioplastics for processing. An example size for a larger pouch could be 3-6 cm² for 3-9 L bucket volumes. Another example might be a 7-10 cm² pouch for 10-30 L bucket volumes. Different ranges can be considered as well.

The hydrolytic pouch 1100 can be similar in concept to a Tide® pod in which cloths are washed with a Tide® pod that helps to clean the cloths during a cycle. Here, bioplastic degrading enzymes can be prepared in the hydrolytic pouch 1 100 that can be added to a bucket that includes food waste and bioplastics.

FIG. 11B illustrates a side view of a hydrolytic pouch 1120 that shows an example of the structure that can include the pouch container 1126 having the buffer solution 1122 and the enzyme solution 1124. The pouch container 1126 as noted above can be made from a material that dissolves in water or is easily broken up via the grinding of the waste material in a bucket of a food recycler. In this manner, the buffer solution 1122 and the enzyme solution 1124 can be released generally at the same time.

FIG. 11C illustrates the pouch container cross section 1130 of the hydrolytic pouch 1100 that shows a buffer solution cavity 1132 and an enzyme solution cavity 1134 that is separated by a cavity divider 1138. The buffer solution cavity 1132 can be defined by a first material and containing the buffer solution and the enzyme solution cavity 1134 can be defined by a second material and contain the enzyme solution that breaks down bioplastics. The first material and the second material can be the same material and have the same characteristics so that they are configured to release the buffer solution 1102 and the enzyme solution 1104 simultaneously.

In another aspect, the buffer solution cavity 1132 and the enzyme solution cavity 1134 may be constructed with the pouch container 1136 having different characteristics whether they are of a different material or a different thickness or composition. In this regard, the hydrolytic pouch 1100 can be configured to release the buffer solution 1102 or the enzyme solution 1104 first or at a first time followed by the release of the other of the buffer solution 1102 or the enzyme solution 1104. This releasing mechanism can be useful if the desired effect is to introduce the buffer solution 1102 first into the bucket followed by the enzyme solution 1104.

An enzyme strip may also be used. Such a strip may be packaged and used in a similar way to earth-friendly eco-strips used for laundry. For example, a strip of material can be configured or provided with immobilized enzymes. The strip might dissolve in water. The strip can come packaged in a stack of strips or as a roll such as roll of toilet paper or a roll of tape. The user can select a strip or break off an enzyme strip and add it to a vessel or a bucket for waste processing as described herein. The strip may completely dissolve as part of the waste processing cycle.

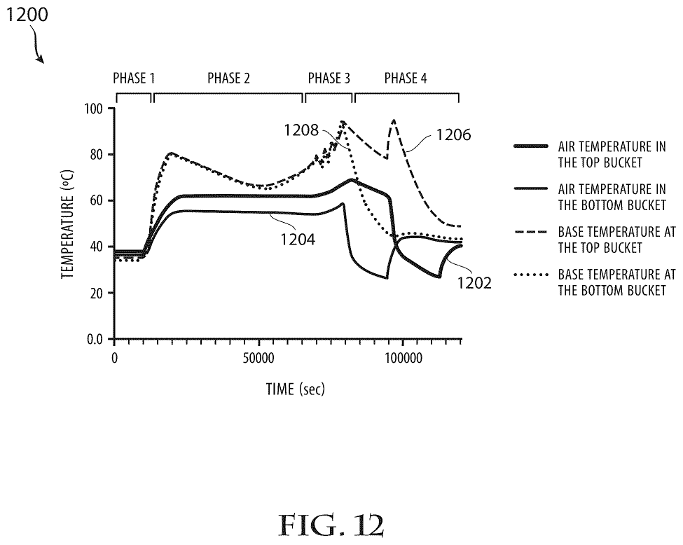

FIG. 12 illustrates a graph of different phases of a waste processing cycle 1200. The x-axis shows time and the y-axis shows temperature variations over time for different specific locations within a bucket of a waste recycler 100. For example, a first temperature line 1202 reports the air temperature at a top portion of the bucket 110. During phase 1 of the waste recycler process, the air temperature at the top portion of the bucket 110 is below 40° C. During phase 2, the air temperature at the top portion of the bucket 110 rises to over 60° C. During phase 3, the air temperature at the top portion of the bucket 110 rises several degrees relative to phase 2. In phase 4, the air temperature at the top portion of the bucket 110 drops to about 30° C. and then rises to about 40° C.

A second temperature line 1204 reports the air temperature at a bottom portion of the bucket 110. During phase 1 of the waste recycler process, the air temperature at the bottom portion of the bucket 110 is below 40° C. During phase 2, the air temperature at the bottom portion of the bucket 110 rises to around 55° C. During phase 3, the air temperature at the bottom portion of the bucket 110 rises several degrees relative to phase 2 and then starts to drop. In phase 4, the air temperature at the bottom portion of the bucket 110 drops to about 30° C. and then rises to over 40° C.

A third temperature line 1206 reports a base temperature at a top portion of the bucket 110. During phase 1 of the waste recycler process, the base temperature at the top portion of the bucket 110 is below 40° C. During phase 2, the base temperature at the top portion of the bucket 110 rises to around 80° C., dips and returns to about 75° C. During phase 3, the base temperature at the top portion of the bucket 110 rises to about 90° C. In phase 4, the base temperature at the top portion of the bucket 110 rises back to about 90° C. and then drops to about 50° C.

A fourth temperature line 1208 reports a base temperature at a bottom portion of the bucket 110. During phase 1 of the waste recycler process, the base temperature at the bottom portion of the bucket 110 is below 40° C. During phase 2, the base temperature at the bottom portion of the bucket 110 rises to around 80° C., dips and returns to about 75° C. During phase 3, the base temperature at the bottom portion of the bucket 110 rises to about 90° C. and then starts to drop. In phase 4, the base temperature at the bottom portion of the bucket 110 continues to drop to about 50° C.

The inventors studied the different phases of the waste recycling process in order to determine, based on the characteristics of any enzyme added to the bucket 110, what changes might need to be made on several fronts. For example, a temperature controlling mechanism might be used to cool down or heat up the air or base temperature of the bucket 1 10 in order to either enable the enzyme 102 to maintain is function of degrading one or more of plastics, fats, oils and/or grease or perhaps may need to be denatured before the end of the cycle so that the enzyme is no longer active when it is placed in a garden or other location. Thus, the knowledge of various temperatures throughout the waste processing cycle can be used to adjust the waste processing cycle when enzymes are present are generate an enzyme-mediated waste processing cycle that makes adjustments with respect to one or more of a time associated with a phase, the introduction of a new phase such as a pre-treatment phase, and/or temperature adjustment up or down as part of a phase of the waste processing cycle.

Other aspects of a waste processing cycle can be modified as well such as airflow speed, amount and timing to control or maintain water content in food waste which may be needed or desirable to enable the enzyme 102 to continue to be effective. The control system 120 may also control the temperature control element 128 to cool down the waste 104 for various reasons at certain times to maintain the effectiveness of the enzyme 102.

### Example Methods

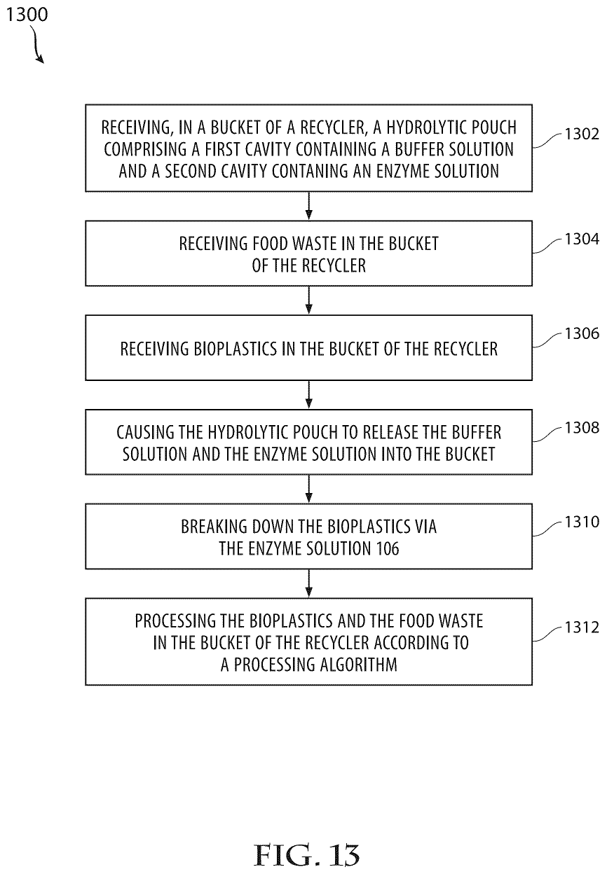

FIG. 13 illustrates a method associated with processing food waste and bioplastics in a waste recycler 100. The recycler may be a waste recycler 100 or may be a recycler in general. The method can include one or more of receiving, in a bucket of a recycler, a hydrolytic pouch comprising a first cavity containing a buffer solution and a second cavity containing an enzyme solution (1302), receiving food waste in the bucket of the recycler (1304), receiving bioplastics in the bucket of the recycler (1306), causing the hydrolytic pouch to release the buffer solution and the enzyme solution into the bucket (1308), breaking down the bioplastics via the enzyme solution (1310) and processing the bioplastics and the food waste in the bucket of the recycler according to a processing algorithm (1312). The user may provide some input through a user interface 126 as part of the process as well where the system may receive input from the user regarding one or more of how to process the bioplastics, how to adjust a processing algorithm to take into account the inclusion of bioplastics in a batch of waste, and so forth. The processing algorithm can be stored in the control system 120 and can include such processes as a heating process, a cooling process, a dehumidifying process, a grinding process, a fanning process, and so forth.

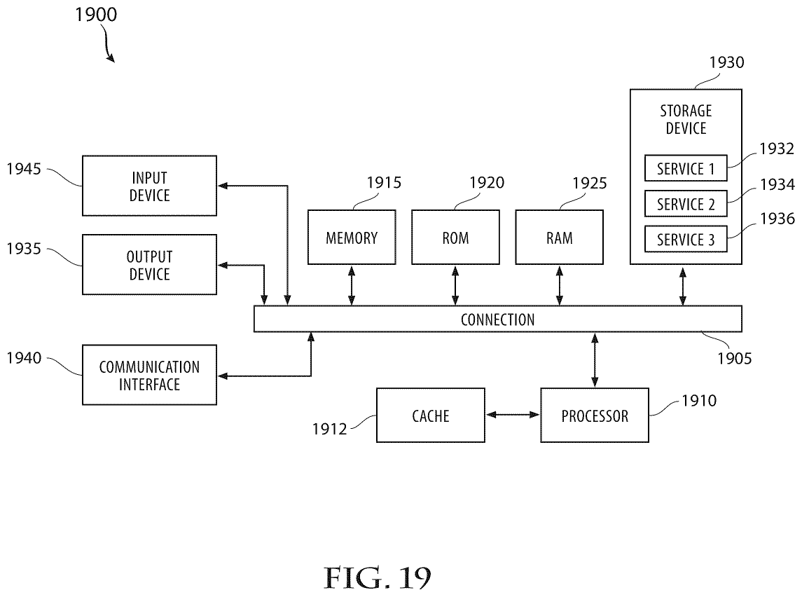

An example system or recycler can include a processer such as a computer processor, a computer-readable storage device, a bucket 110, a grinding mechanism 130 configured within the bucket 110 as is shown in the applications incorporated herein by reference, a heating element as is shown in the applications incorporated herein by reference or a temperature control element 128 and a storage container containing an enzyme solution. The system can include a sensor 118 connected to the processor as shown in FIG. 1 and FIG. 19. The instructions can cause the system or waste recycler 100 to perform operations include receiving, in the bucket of the recycler, a hydrolytic pouch including a first cavity containing a buffer solution and a second cavity containing an enzyme solution; receiving food waste in the bucket of the recycler; receiving bioplastics in the bucket of the recycler; causing the hydrolytic pouch to release the buffer solution and the enzyme solution into the bucket; breaking down the bioplastics via the enzyme solution and processing the bioplastics and the food waste in the bucket of the recycler according to a processing algorithm.

Other additives could also be put in the first cavity such as the co-factors (e.g. calcium chloride) in with the buffer in the first cavity.

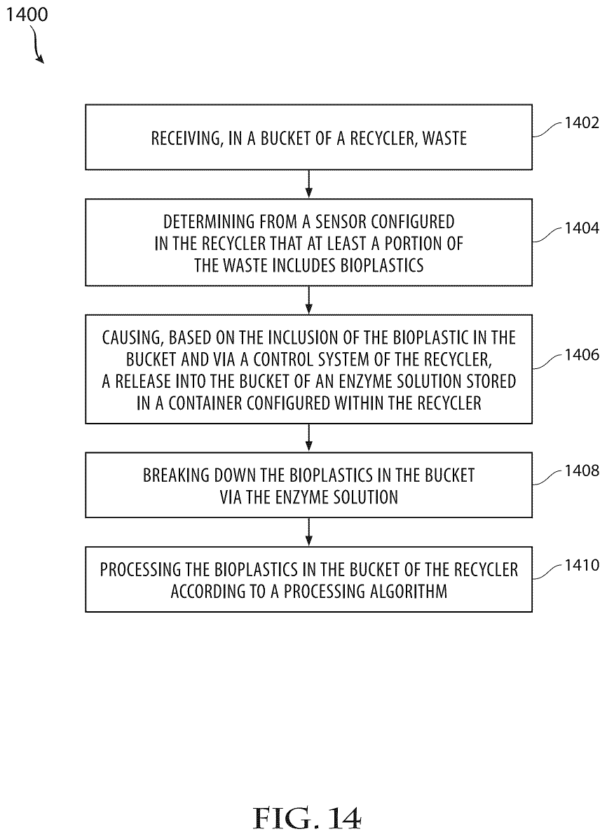

FIG. 14 illustrates another method 1400 related to sensing for bioplastics and then processing the batch of waste. The method 1400 can be performed by a waste recycler 100 and/or any of its subcomponents and can include receiving, in a bucket of a recycler, waste (1402), determining from a sensor configured in the recycler that at least a portion of the waste includes bioplastics (1404), causing, based on the inclusion of the bioplastic in the bucket and via a control system of the recycler, a release into the bucket of an enzyme solution stored in a container configured within the recycler (1406), breaking down the bioplastics in the bucket via the enzyme solution (1408) and processing the bioplastics in the bucket of the recycler according to a processing algorithm (1410).

An example system or recycler can include a computing system 1900, processer 1910 such as a computer processor, a computer-readable storage device, a bucket 110, a grinding mechanism 130 configured within the bucket as is shown in the applications incorporated herein by reference, a heating element or temperature control element 128 as is shown in the applications incorporated herein by reference and a storage container or vessel containing an enzyme solution or the enzyme 102. The system can include a sensor 118 connected to the processor as shown in FIG. 1. The computer-readable storage device stores instructions for controlling the processor to perform operations including determining from the sensor 118 configured in the waste recycler 100 that at least a portion of a waste 104 deposited in the bucket 110 includes bioplastics; causing, based on the inclusion of the bioplastic in the bucket, a release into the bucket of an enzyme solution stored in the storage container such that the bioplastics in the bucket are broken down by the enzyme solution; and processing, via the grinding mechanism and the heating element, the bioplastics in the bucket of the recycler according to a processing algorithm.

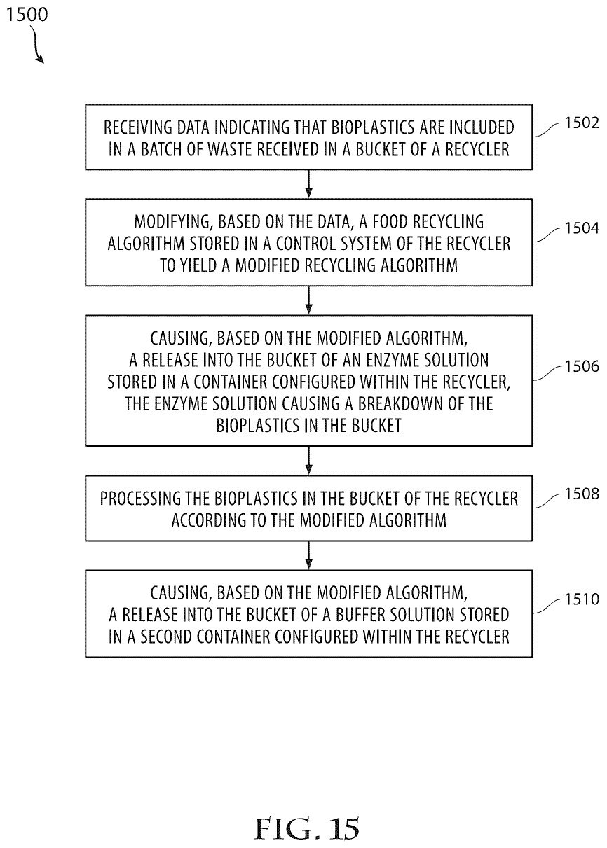

FIG. 15 illustrates another method 1500 related to an enzyme release and delivery system. There can be different examples of how the release and delivery system can work. FIG. 1 shows various locations at which storage component can be positioned within a waste recycler 100. The control system 120 can manage the process. In one aspect, the user may provide user input to the user interface 126 indicating that the batch has bioplastics and/or an enzyme 102 added by the user to the waste 104. In another aspect, the waste cycler 100 with an integrated delivery system 116 will sense through the sensor 118 that bioplastics are in the batch. In either case, there is “data” provided to the control system 120 indicating the presence of bioplastics and/or the enzyme 102. The method 1500 can therefore be performed by one or more components of a waste recycler 100 including one or more components from a computing system 1900 shown in FIG. 19, the control system 120, the user interface 126, and/or the temperature control element 128.

The method of FIG. 15 can include receiving data indicating that bioplastics are included in a batch of waste received in a bucket of a recycler (1502), modifying, based on the data, a food recycling algorithm stored in a control system of the recycler to yield a modified recycling algorithm (1504), causing, based on the modified algorithm, a release into the bucket of an enzyme solution stored in a container configured within the recycler, the enzyme solution causing a breakdown of the bioplastics in the bucket (1506) and processing the bioplastics in the bucket of the recycler according to the modified algorithm (1508).

The data can be received from a user via a user interface or sensed via a sensor 118 configured in the waste recycler 100. The method can further include causing, based on the modified algorithm, a release into the bucket of a buffer solution stored in a second container configured within the recycler (1510). The container can be configured in one of a lid of the recycler and a housing of the recycler. A control system 120 can be configured in the recycler that causes an enzyme delivery system to release the enzyme solution.

An example system or waste recycler 100 can include a processer 1910 such as a computer processor, a computer-readable storage device, a bucket 110, a grinding mechanism configured within the bucket as is shown in the applications incorporated herein by reference, a heating element as is shown in the applications incorporated herein by reference and a storage container containing an enzyme solution. The computer-readable storage device stores instructions for controlling the processor to perform operations including receiving data indicating that bioplastics are included in a batch of waste received in a bucket of a recycler, modifying, based on the data, a food recycling algorithm stored in a control system of the recycler to yield a modified recycling algorithm, causing, based on the modified algorithm, a release into the bucket of one or more of a buffer solution and an enzyme solution stored in a container configured within the recycler, the enzyme solution causing a breakdown of the bioplastics in the bucket and processing the bioplastics in the bucket of the recycler according to the modified algorithm.

In one example, the enzyme 102 contemplated herein can be used to convert waste to fuel oil. Some devices or systems for performing this process might include a large vat that can contain bioplastics or the device may be a bioreactor vat. These enzymes can be added to a certain concentration. This approach can be applied also to other industries where larger entities might be processing bioplastics at a larger way. The buffer/enzyme delivery systems described below are therefore also applicable to any system such as a large-scale bioplastics processing system, in contrast to a consumer counter-top food recycler.

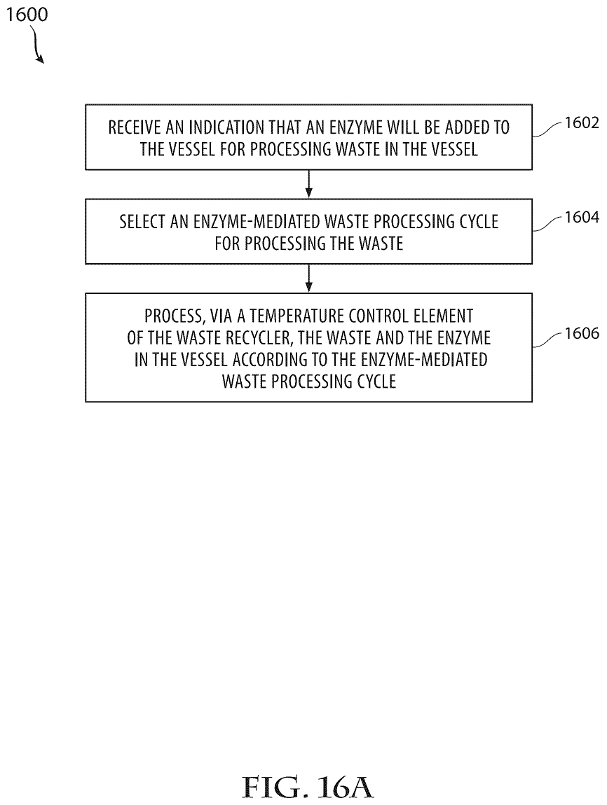

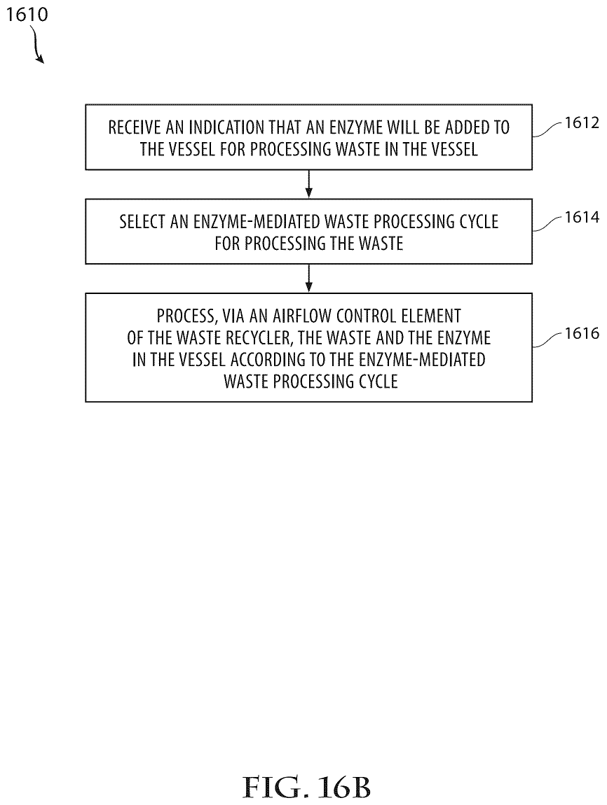

FIG. 16A illustrates a method 1600 of operating a waste recycler 100. The method 1600 can be performed by one or more components of a waste recycler 100 including one or more components from a computing system 1900 shown in FIG. 19, the control system 120, the sensor 118, the user interface 126, and/or the temperature control element 128.

At block 1602, the waste recycler 100, or any component thereof, can and is configured to receive an indication that an enzyme will be added to the vessel for processing waste in the vessel.

At block 1604, the waste recycler 100, or any component thereof, can and is configured to select an enzyme-mediated waste processing cycle for processing the waste.

At block 1606, the waste recycler 100, or any component thereof, can and is configured to process, via a temperature control element of the waste recycler, the waste and the enzyme in the vessel according to the enzyme-mediated waste processing cycle.

In some aspects, the waste recycler, according to the enzyme-mediated waste processing cycle for processing the waste, holds a temperature via the temperature control element for a pretreatment period of time for the enzyme to start decomposing the waste.

In some aspects, the waste recycler, according to the enzyme-mediated waste processing cycle for processing the waste, delays an application of heating via the temperature control element as part of the enzyme-mediated waste processing cycle relative to a standard waste processing cycle. The standard waste processing cycle for example may be configured to process waste food only without the inclusion of enzymes in the vessel.

In some aspects, the waste recycler, according to the enzyme-mediated waste processing cycle for processing the waste, adds via the temperature control element a high heat for a period of time at an end of the enzyme-mediated waste processing cycle to denature the enzyme. The high heat comprises a temperature at or above 50° C. and in some cases is expected to be 80° C. or above. The value of the temperature may be chosen or determined based on characteristics of the particular enzyme added to the vessel and based on data disclosed herein.

In some aspects, the waste recycler, according to the enzyme-mediated waste processing cycle for processing the waste, cools, via the temperature control element, the waste during at least a portion of the enzyme-mediated waste processing cycle. For example, waste recycler can cool the waste to reduce water evaporation during the enzyme-mediated waste processing cycle. The enzyme may need water or a water solution to become active to degrade plastics.

The vessel can include one or more of a pouch, a container that may be rigid or flexible, a plastic vessel, a vessel or a bucket.

The method 1600 may further include grinding the waste via a grinding mechanism configured within the bucket or vessel. The waste recycler 100 may also spin the waste, or turn the waste or perform some other processing operation besides using a grinding tool within the vessel or bucket.

In some aspects, the temperature control element can include one or more of a heating element and a cooling element. In some aspects, the enzyme is part of a hydrolase enzyme class.

In some aspects, the method 1600 may further include modifying an existing waste processing cycle to generate the enzyme-mediated waste processing cycle or select the enzyme-mediated waste processing cycle from a plurality of waste processing cycles.

In some aspects, the enzyme is operable to biodegrade at least one of a biodegradable plastic, a compostable plastic, a petroleum plastic, fat, oil and grease.

The enzyme can be in some cases operable to biodegrade food waste with fat content. In some aspects, the enzyme can include one or more of a lipases, proteases, proteinase K, PLA (Polylactic acid) depolymerase, esterase, cutinase, cellulases, amylases, lignases, proteinases, glucosidases, xylanases, peptidases, Phospholipases, chitinases, PLA, PHB (Poly(3-hydroxybutyrate)), PHA (Polyhydroxyalkanoate), PBS (Polybutylene succinate), PBSA (2-phenylbenzimidazole-5-sulfonic acid), and PBAT (polybutylene adipate terephthalate) depolymerase.

In some aspects, the waste recycler, according to the enzyme-mediated waste processing cycle for processing the waste, applies an air circulation characteristic. Changing the air circulation aspect of a waste processing cycle can enable or maintain the natural moisture in the food part of the waste to enable the enzyme to continue to operate to biodegrade materials in the waste. The air circulation characteristic, for example, can reduce air flow relative to a food-based processing cycle to maintain moisture in the waste for the enzyme to go into a solution and be operable to biodegrade materials in the waste.

The method may further include selecting the enzyme-mediated waste processing cycle for processing the waste from a group of processing cycles comprising a first enzyme-mediated waste processing cycle for processing the waste when the waste includes biodegradable plastics or compostable plastics and a second enzyme-mediated waste processing cycle for processing the waste when the waste includes one of fat, oil and grease.

In some aspects, the plastics of the first enzyme-mediated waste processing cycle for processing the waste further comprises biodegradable plastic or compostable plastic and wherein the group of processing cycles further can include a third enzyme-mediated waste processing cycle for processing the waste when the waste includes non-biodegradable plastics.

In some aspects, the group of processing cycles further can include a third enzyme-mediated waste processing cycle for processing the waste when the waste includes a combination of two or more of waste food, biodegradable plastics, non-biodegradable plastics, fat, oil and grease.

The method may further include receiving the indication that the enzyme will be added to the vessel for processing waste in the vessel based on data from a sensor that senses plastics, fat, oil or grease in the waste. In some aspects, the method may include receiving user input, via a button, touch-sensitive screen, speech input, motion input, remote input, or multimodal input, providing the indication that the enzyme will be added to the vessel.

In some aspects, a waste recycler 100 can include at least one processer; a vessel; a temperature control element; and a computer-readable storage medium storing instructions which, when executed by the at least one processor, cause the at least one processor to be configured to: receive an indication that an enzyme will be added to the vessel for processing waste in the vessel; select an enzyme-mediated waste processing cycle for processing the waste; and process, via the temperature control element, the waste and the enzyme in the vessel according to the enzyme-mediated waste processing cycle.

In some aspects, a waste recycler 100 can include one or more of: means for receiving an indication that an enzyme will be added to the vessel for processing waste in the vessel; means for selecting an enzyme-mediated waste processing cycle for processing the waste; and means for processing, via the temperature control element, the waste and the enzyme in the vessel according to the enzyme-mediated waste processing cycle.

In some aspects, a computer-readable storage medium stores instructions which, when executed by at least one processor, cause the at least one processor to be configured to: receive an indication that an enzyme will be added to the vessel for processing waste in the vessel; select an enzyme-mediated waste processing cycle for processing the waste; and process, via the temperature control element, the waste and the enzyme in the vessel according to the enzyme-mediated waste processing cycle.

In some aspects, a waste recycler 100 can include at least one processer; a vessel; a temperature control element; and a computer-readable storage medium storing instructions which, when executed by the at least one processor, cause the at least one processor to be configured to: determine, based on an indication, an enzyme-mediated waste processing cycle for processing a waste in the vessel, the vessel containing an enzyme of a hydrolase enzyme class; and process, via the temperature control element, the waste and the enzyme in the vessel according to the enzyme-mediated waste processing cycle.

The enzyme 102 can be modified to have thermostable properties to remain stable at higher temperatures such as above 50° C. or 60° C. The enzyme 102 can be chosen to act on bioplastics, compostable plastics, petroleum-based plastics, single-use plastics, fats, oils and grease. The enzyme 102 can include one or more of a lipases, a proteases, a proteinase K, a PLA (Polylactic acid) depolymerase, esterase, cutinase, cellulases, amylases, lignases, proteinases, glucosidases, xylanases, peptidases, Phospholipases, chitinases, PLA, PHB (Poly(3-hydroxybutyrate)), PHA (Polyhydroxyalkanoate), PBS (Polybutylene succinate), PBSA (2-phenylbenzimidazole-5-sulfonic acid), and PBAT (polybutylene adipate terephthalate) depolymerase.

FIG. 16B illustrates an example method 1610 relative to airflow control, in accordance with some aspects of this disclosure. The method 1600 can be performed by one or more components of a waste recycler 100 including one or more components from a computing system 1900 shown in FIG. 19, the control system 120, the sensor 118, the user interface 126, and/or the temperature control element 128.

At block 1612, the waste recycler 100, or any component thereof, can and is configured to receive an indication that an enzyme will be added to the vessel for processing waste in the vessel.

At block 1614, the waste recycler 100, or any component thereof, can and is configured to select an enzyme-mediated waste processing cycle for processing the waste.

At block 1616, the waste recycler 100, or any component thereof, can and is configured to process, via an airflow control element of the waste recycler, the waste and the enzyme in the vessel according to the enzyme-mediated waste processing cycle. In this regard, the airflow control element can be a part of the control system 120 that can control a fan, heating component, cooling component or any other component that relates to airflow and can change the standard airflow in terms of airflow amount or volume, velocity, direction, rotational characteristics, and so forth in order to accommodate or increase the viability and use for the enzyme in the vessel for that waste processing cycle.

In some aspects, a waste recycler 100 can include at least one processer; a vessel; an airflow control element; and a computer-readable storage medium storing instructions which, when executed by the at least one processor, cause the at least one processor to be configured to: receive an indication that an enzyme will be added to the vessel for processing waste in the vessel; select an enzyme-mediated waste processing cycle for processing the waste; and process, via the airflow control element, the waste and the enzyme in the vessel according to the enzyme-mediated waste processing cycle.

In some aspects, a waste recycler 100 can include one or more of: means for receiving an indication that an enzyme will be added to the vessel for processing waste in the vessel; means for selecting an enzyme-mediated waste processing cycle for processing the waste; and means for processing, via an airflow control element, the waste and the enzyme in the vessel according to the enzyme-mediated waste processing cycle.

In some aspects, a computer-readable storage medium stores instructions which, when executed by at least one processor, cause the at least one processor to be configured to: receive an indication that an enzyme will be added to the vessel for processing waste in the vessel; select an enzyme-mediated waste processing cycle for processing the waste; and process, via an airflow control element, the waste and the enzyme in the vessel according to the enzyme-mediated waste processing cycle.

In some aspects, a waste recycler 100 can include at least one processer; a vessel; an airflow control element; and a computer-readable storage medium storing instructions which, when executed by the at least one processor, cause the at least one processor to be configured to: determine, based on an indication, an enzyme-mediated waste processing cycle for processing a waste in the vessel, the vessel containing an enzyme of a hydrolase enzyme class; and process, via the airflow control element, the waste and the enzyme in the vessel according to the enzyme-mediated waste processing cycle.

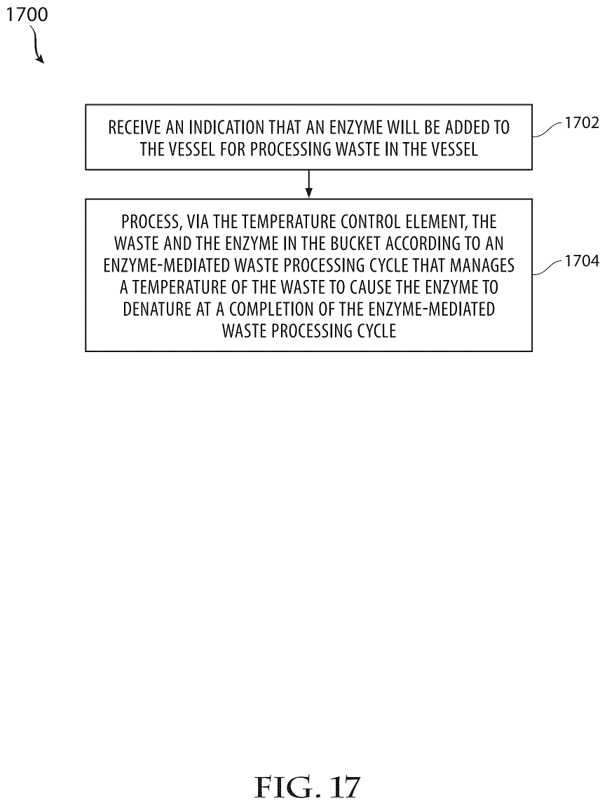

FIG. 17 illustrates a method 1700 of operating a waste recycler 100. The method 1700 can be performed by one or more components of a waste recycler 100 including one or more components from a computing system 1900 shown in FIG. 19, the control system 120, the sensor 118, the user interface 126, and/or the temperature control element 128.

At block 1702, the waste recycler 100, or any component thereof, can and is configured to receive an indication that an enzyme will be added to the vessel for processing waste in the vessel.

At block 1704, the waste recycler 100, or any component thereof, can and is configured to process, via the temperature control element, the waste and the enzyme in the bucket according to an enzyme-mediated waste processing cycle that manages a temperature of the waste to cause the enzyme to denature at a completion of the enzyme-mediated waste processing cycle.

The temperature comprises at least 50° C. The temperature of the waste 104 can be managed to be at an elevated value for a period of time according to a characteristic of the enzyme 102. In some cases, the temperature control element 128 either heats up the waste 104 to cause the enzyme 102 to denature or allows natural heat from food waste in the waste 104 to rise in temperature to denature the enzyme 102 as part of the enzyme-mediated waste processing cycle.

A waste recycler 100 can include at least one processer; a vessel; a temperature control element; and a computer-readable storage medium storing instructions which, when executed by the at least one processor, cause the at least one processor to be configured to: receive an indication that an enzyme will be added to the vessel for processing waste in the vessel; and process, via the temperature control element, the waste and the enzyme in the vessel according to an enzyme-mediated waste processing cycle that manages a temperature of the waste to cause the enzyme to denature at a completion of the enzyme-mediated waste processing cycle.

In some aspects, a waste recycler 100 can include at least one processer; a vessel; a hydrolase enzyme; and a computer-readable storage medium storing instructions which, when executed by the at least one processor, cause the at least one processor to be configured to: process waste in the vessel according to a waste processing cycle, wherein the waste comprises the hydrolase enzyme. The waste recycler 100 can further include a chemical additive, wherein the hydrolase enzyme including the chemical additive is configured to degrade food waste plus one or more of a biodegradable plastic, and non-biodegradable plastic, fats, oils and grease.

The chemical additive an include one or more of calcium chloride, magnesium, iron, cobalt, potassium, zinc, and manganese. The chemical additive can further include cations or anions as water soluble ions.

In some cases, the hydrolase enzyme can include one or more of a lipases, a proteases, a proteinase K, a PLA (Polylactic acid) depolymerase, esterase, cutinase, cellulases, amylases, lignases, proteinases, glucosidases, xylanases, peptidases, Phospholipases, chitinases, PLA, PHB (Poly(3-hydroxybutyrate)), PHA (Polyhydroxyalkanoate), PBS (Polybutylene succinate), PBSA (2-phenylbenzimidazole-5-sulfonic acid), and PBAT (polybutylene adipate terephthalate) depolymerase.

In other cases, the hydrolase enzyme is configured in an enzyme solution including a chemical additive and is configured to degrade food waste and one or more of biodegradable plastic, compostable plastic, petroleum plastic, fats, oils and grease. The hydrolase enzyme an include a pH/acidic/alkaline stable enzyme that is configured to degrade food waste having a non-neutral pH level. The hydrolase enzyme can be configured such that an amount of buffer, a presence of a co-factor and an incubation time optimize enzyme-mediated degradation of plastics being processed by the waste recycler.

The computer-readable storage medium of the waste recycler 100 can store instructions which, when executed by the at least one processor, cause the at least one processor to be configured to: receive an indication that the hydrolase enzyme is in the waste; and select the waste processing cycle to process the waste with the hydrolase enzyme.

The waste recycler 100 can further include a temperature control element 128. The waste recycler 100, according to the waste processing cycle for processing the waste, can hold a temperature via the temperature control element 128 for a pretreatment period of time for the hydrolase enzyme to start decomposing the waste.

The waste recycler 100 can also include a temperature control element 128 in which the waste recycler, according to the waste processing cycle for processing the waste, delays an application of heating via the temperature control element 128 as part of the waste processing cycle relative to a standard waste processing cycle.

A temperature control element 128 can also, according to the waste processing cycle for processing the waste, add a high heat (i.e., above 50° C., above 60° C. or 80° C.-100° C.) for a period of time at an end of the waste processing cycle to denature the hydrolase enzyme.

The waste recycler 100, according to the waste processing cycle for processing the waste, can be configured to cool, via the temperature control element 128, the waste 104 during at least a portion of the waste processing cycle. The waste recycler 100 can cool the waste 104 to reduce water evaporation during the waste processing cycle. The waste recycler 100, according to the waste processing cycle for processing the waste 104, can also apply an air circulation characteristic. The air circulation characteristic can reduce air flow relative to a food-based processing cycle to maintain moisture in the waste for the hydrolase enzyme to go into a solution and be operable to biodegrade materials in the waste.

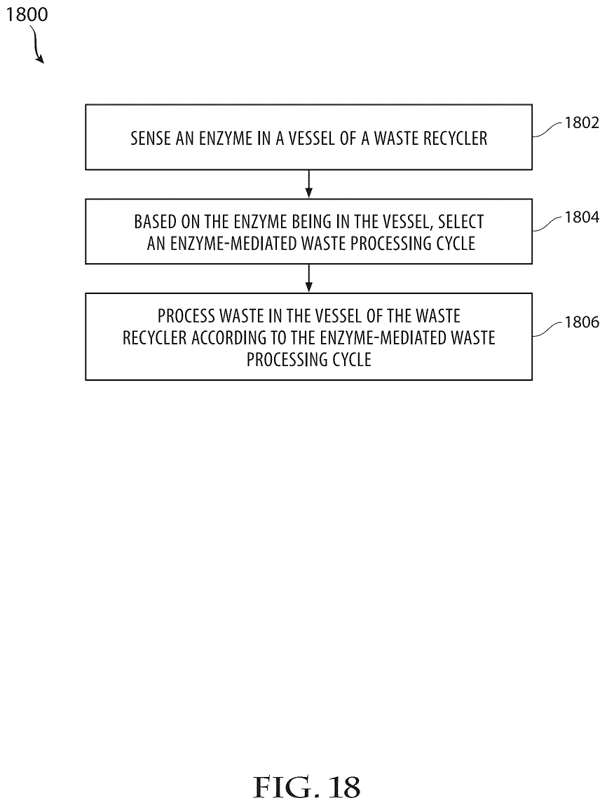

FIG. 18 illustrates a method 1800 of operating a waste recycler 100. The method 1800 can be performed by one or more components of a waste recycler 100 including one or more components from a computing system 1900 shown in FIG. 19, the control system 120, the sensor 118, the user interface 126, and/or the temperature control element 128.

At block 1802, the waste recycler 100, or any component thereof, can and is configured to sense an enzyme in a vessel of a waste recycler.

At block 1804, the waste recycler 100, or any component thereof, can and is configured to, based on the enzyme being in the vessel, select an enzyme-mediated waste processing cycle.

At block 1806, the waste recycler 100, or any component thereof, can and is configured to process waste in the vessel of the waste recycler according to the enzyme-mediated waste processing cycle.

Computer systems can be included within the scope of this disclosure. Such devices include processors, memory, software modules that are stored in the non-transitory memory, a bus, input and output components, displays, and so forth. This disclosure includes concepts such as a touch-sensitive display or the use of an application on a mobile device that can be used to control a recycler and provide instructions as well as receive input. A back-end network-based server may be used to communicate data via the Internet or other network with a recycler. In some embodiments, the computer-readable storage devices, mediums, and/or memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can include, for example, instructions and data that cause or otherwise configure a general purpose computer, special purpose computer, or special purpose processing device to perform a certain function or group of functions. Portions of computer resources used can be accessible over a network. The computer executable instructions may be, for example, binaries, intermediate format instructions such as assembly language, firmware, or source code. Examples of computer-readable media that may be used to store instructions, information used, and/or information created during methods according to described examples include magnetic or optical disks, flash memory, USB devices provided with non-volatile memory, networked storage devices, and so on.

Devices implementing methods according to these disclosures can include hardware, firmware and/or software, and can take any of a variety of form factors. Typical examples of such form factors include laptops, smart phones, small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims. Moreover, claim language reciting “at least one of” a set indicates that one member of the set or multiple members of the set satisfy the claim.

It should be understood that features or configurations herein with reference to one embodiment or example can be implemented in, or combined with, other embodiments or examples herein. That is, terms such as “embodiment”, “variation”, “aspect”, “example”, “configuration”, “implementation”, “case”, and any other terms which may connote an embodiment, as used herein to describe specific features or configurations, are not intended to limit any of the associated features or configurations to a specific or separate embodiment or embodiments, and should not be interpreted to suggest that such features or configurations cannot be combined with features or configurations described with reference to other embodiments, variations, aspects, examples, configurations, implementations, cases, and so forth. In other words, features described herein with reference to a specific example (e.g., embodiment, variation, aspect, configuration, implementation, case, etc.) can be combined with features described with reference to another example. Precisely, one of ordinary skill in the art will readily recognize that the various embodiments or examples described herein, and their associated features, can be combined with each other.

A phrase such as an “aspect” does not imply that such aspect is essential to the subject technology or that such aspect applies to all configurations of the subject technology. A disclosure relating to an aspect may apply to all configurations, or one or more configurations. A phrase such as an aspect may refer to one or more aspects and vice versa. A phrase such as a “configuration” does not imply that such configuration is essential to the subject technology or that such configuration applies to all configurations of the subject technology. A disclosure relating to a configuration may apply to all configurations, or one or more configurations. A phrase such as a configuration may refer to one or more configurations and vice versa. The word “exemplary” is used herein to mean “serving as an example or illustration.” Any aspect or design described herein as “exemplary” is not necessarily to be construed as preferred or advantageous over other aspects or designs.

FIG. 19 is a diagram illustrating an example of a system for implementing certain aspects of the present disclosure. In particular, FIG. 19 illustrates an example of computing system 1900, which can be for example any computing device making up a computing system, a camera system, or any component thereof in which the components of the system are in communication with each other using connection 1905. Connection 1905 can be a physical connection using a bus, or a direct connection into processor 1912, such as in a chipset architecture. Connection 1905 can also be a virtual connection, networked connection, or logical connection.

In some examples, computing system 1900 is a distributed system in which the functions described in this disclosure can be distributed within a datacenter, multiple data centers, a peer network, etc. In some examples, one or more of the described system components represents many such components each performing some or all of the function for which the component is described. In some examples, the components can be physical or virtual devices.

Example system 1900 includes at least one processing unit (CPU or processor) 1910 and connection 1905 that couples various system components including system memory 1915, such as read-only memory (ROM) 1920 and random access memory (RAM) 1925 to processor 1912. Computing system 1900 can include a cache 1911 of high-speed memory connected directly with, in close proximity to, or integrated as part of processor 1912.

Processor 1912 can include any general purpose processor and a hardware service or software service, such as services 1932, 1934, and 1936 stored in storage device 1930, configured to control processor 1912 as well as a special-purpose processor where software instructions are incorporated into the actual processor design. Processor 1912 may essentially be a completely self-contained computing system, containing multiple cores or processors, a bus, memory controller, cache, etc. A multi-core processor may be symmetric or asymmetric.

To enable user interaction, computing system 1900 includes an input device 1945, which can represent any number of input mechanisms, such as a microphone for speech, a touch-sensitive screen for gesture or graphical input, keyboard, mouse, motion input, speech, etc. Computing system 1900 can also include output device 1935, which can be one or more of a number of output mechanisms. In some instances, multimodal systems can enable a user to provide multiple types of input/output to communicate with computing system 1900. Computing system 1900 can include communications interface 1940, which can generally govern and manage the user input and system output.

The communication interface may perform or facilitate receipt and/or transmission wired or wireless communications using wired and/or wireless transceivers, including those making use of an audio jack/plug, a microphone jack/plug, a universal serial bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a radio-frequency identification (RFID) wireless signal transfer, near-field communications (NFC) wireless signal transfer, dedicated short range communication (DSRC) wireless signal transfer, 1202.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof.

The communications interface 1940 may also include one or more Global Navigation Satellite System (GNSS) receivers or transceivers that are used to determine a location of the computing system 1900 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 1930 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (L1/L2/L3/L4/L5/L #), resistive random-access memory (RRAM/ReRAM), phase change memory (PCM), spin transfer torque RAM (STT-RAM), another memory chip or cartridge, and/or a combination thereof.

The storage device 1930 can include software services, servers, services, etc., that when the code that defines such software is executed by the processor 1912, it causes the system to perform a function. In some examples, a hardware service that performs a particular function can include the software component stored in a computer-readable medium in connection with the necessary hardware components, such as processor 1912, connection 1905, output device 1935, etc., to carry out the function. The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

In some aspects the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per sc.

Specific details are provided in the description above to provide a thorough understanding of the aspects and examples provided herein. However, it will be understood by one of ordinary skill in the art that the aspects may be practiced without these specific details. For clarity of explanation, in some instances the present technology may be presented as including individual functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code. Examples of computer-readable media that may be used to store instructions, information used, and/or information created during methods according to described examples include magnetic or optical disks, flash memory, USB devices provided with non-volatile memory, networked storage devices, and so on.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific aspects thereof, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

The present disclosure incorporates by reference the paper included as Appendix A.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

The various illustrative logical blocks, modules, circuits, and algorithm steps described in connection with the examples disclosed herein may be implemented as electronic hardware, computer software, firmware, or combinations thereof. To clearly illustrate the interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, then the techniques may be realized at least in part by a computer-readable data storage medium comprising program code including instructions that, when executed, performs one or more of the methods, algorithms, and/or operations described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

The following are clauses associated with this disclosure.

### Waste Recycler and Enzyme Clauses

Clause 1. A waste recycler comprising: at least one processer; a vessel; a temperature control element; and a computer-readable storage medium storing instructions which, when executed by the at least one processor, cause the at least one processor to be configured to: receive an indication that an enzyme will be added to the vessel for processing waste in the vessel; select an enzyme-mediated waste processing cycle for processing the waste; and process, via the temperature control element, the waste and the enzyme in the vessel according to the enzyme-mediated waste processing cycle.
Clause 2. The waste recycler of clause 1, wherein the vessel comprises a bucket.
Clause 3. The waste recycler of clause 2 or of any previous clause, further comprising: a grinding mechanism configured within the bucket.
Clause 4. The waste recycler of clause 1 or of any previous clause, wherein the temperature control element comprises one or more of a heating element and a cooling element.
Clause 5. The waste recycler of clause 1 or of any previous clause, wherein the enzyme is part of a hydrolase enzyme class.
Clause 6. The waste recycler of clause 1 or of any previous clause, wherein the computer-readable storage medium stores instructions which, when executed by the at least one processor, cause the at least one processor to be configured to: modify an existing waste processing cycle to generate the enzyme-mediated waste processing cycle or select the enzyme-mediated waste processing cycle from a plurality of waste processing cycles.
Clause 7. The waste recycler of clause 1 or of any previous clause, wherein the enzyme is operable to biodegrade at least one of a biodegradable plastic, a compostable plastic, a petroleum-based plastic, fat, oil and grease.
Clause 8. The waste recycler of clause 1 or of any previous clause, wherein the enzyme is operable to biodegrade food waste with fat content.
Clause 9. The waste recycler of clause 1 or of any previous clause, wherein the enzyme comprises one or more of a lipases, proteases, proteinase K, PLA (Polylactic acid) depolymerase, esterase, cutinase, cellulases, amylases, lignases, proteinases, glucosidases, xylanases, peptidases, Phospholipases, chitinases, PLA, PHB (Poly(3-hydroxybutyrate)), PHA (Polyhydroxyalkanoate), PBS (Polybutylene succinate), PBSA (2-phenylbenzimidazole-5-sulfonic acid), and PBAT (polybutylene adipate terephthalate) depolymerase.
Clause 10. The waste recycler of clause 1 or of any previous clause, wherein the waste recycler, according to the enzyme-mediated waste processing cycle for processing the waste, holds a temperature via the temperature control element for a pretreatment period of time for the enzyme to start decomposing the waste.
Clause 11. The waste recycler of clause 1 or of any previous clause, wherein the waste recycler, according to the enzyme-mediated waste processing cycle for processing the waste, delays an application of heating via the temperature control element as part of the enzyme-mediated waste processing cycle relative to a standard waste processing cycle.
Clause 12. The waste recycler of clause 1 or of any previous clause, wherein the waste recycler, according to the enzyme-mediated waste processing cycle for processing the waste, adds via the temperature control element a high heat for a period of time at an end of the enzyme-mediated waste processing cycle to denature the enzyme.
Clause 13. The waste recycler of clause 12 or of any previous clause, wherein the high heat comprises a temperature at or above 50° C.
Clause 14. The waste recycler of clause 1 or of any previous clause, wherein the waste recycler, according to the enzyme-mediated waste processing cycle for processing the waste, cools, via the temperature control element, the waste during at least a portion of the enzyme-mediated waste processing cycle.
Clause 15. The waste recycler of clause 14 or of any previous clause, wherein waste recycler cools the waste to reduce water evaporation during the enzyme-mediated waste processing cycle.
Clause 16. The waste recycler of clause 1 or of any previous clause, wherein the waste recycler, according to the enzyme-mediated waste processing cycle for processing the waste, applies an air circulation characteristic.
Clause 17. The waste recycler of clause 16 or of any previous clause, wherein the air circulation characteristic reduces air flow relative to a food-based processing cycle to maintain moisture in the waste for the enzyme to go into a solution and be operable to biodegrade materials in the waste.
Clause 18. The waste recycler of clause 1 or of any previous clause, wherein the computer-readable storage medium stores instructions which, when executed by the at least one processor, cause the at least one processor to be configured to: select the enzyme-mediated waste processing cycle for processing the waste from a group of processing cycles comprising a first enzyme-mediated waste processing cycle for processing the waste when the waste includes a biodegradable plastic, a compostable plastic, or a petroleum-based plastic, and a second enzyme-mediated waste processing cycle for processing the waste when the waste includes one of fat, oil and grease.
Clause 19. The waste recycler of clause 18 or of any previous clause, wherein the plastics of the first enzyme-mediated waste processing cycle for processing the waste further comprises a biodegradable plastic, a compostable plastic, or a petroleum-based plastic and wherein the group of processing cycles further comprises a third enzyme-mediated waste processing cycle for processing the waste when the waste includes non-biodegradable plastics.
Clause 20. The waste recycler of clause 19 or of any previous clause, wherein the group of processing cycles further comprises a third enzyme-mediated waste processing cycle for processing the waste when the waste includes a combination of two or more of waste food, a biodegradable plastic, a compostable plastic, a petroleum-based plastic, fat, oil and grease.
Clause 21. The waste recycler of clause 1 or of any previous clause, wherein the computer-readable storage medium stores instructions which, when executed by the at least one processor, cause the at least one processor to be configured to: receive the indication that the enzyme will be added to the vessel for processing waste in the vessel based on data from a sensor that senses plastics, fat, oil or grease in the waste.
Clause 22. The waste recycler of clause 1 or of any previous clause, wherein the computer-readable storage medium stores instructions which, when executed by the at least one processor, cause the at least one processor to be configured to: receive user input, via a button, touch-sensitive screen, speech input, motion input, remote input, or multimodal input, providing the indication that the enzyme will be added to the vessel.
Clause 23. A method of operating a waste recycler that receives an enzyme in a vessel containing waste, wherein the enzyme causes a breakdown of at least part of the waste in the vessel, the method comprising: receiving an indication that an enzyme will be added to the vessel for processing waste in the vessel; selecting an enzyme-mediated waste processing cycle for processing the waste; and processing, via a temperature control element of the waste recycler, the waste and the enzyme in the vessel according to the enzyme-mediated waste processing cycle.
Clause 24. The waste recycler of clause 23, wherein the waste recycler, according to the enzyme-mediated waste processing cycle for processing the waste, holds a temperature via the temperature control element for a pretreatment period of time for the enzyme to start decomposing the waste.
Clause 25. The waste recycler of clause 23 or any of clauses 23-24, wherein the waste recycler, according to the enzyme-mediated waste processing cycle for processing the waste, delays an application of heating via the temperature control element as part of the enzyme-mediated waste processing cycle relative to a standard waste processing cycle.
Clause 26. The waste recycler of clause 23 or any of clauses 23-25, wherein the waste recycler, according to the enzyme-mediated waste processing cycle for processing the waste, adds via the temperature control element a high heat for a period of time at an end of the enzyme-mediated waste processing cycle to denature the enzyme.
Clause 27. The waste recycler of clause 26 or any of clauses 23-26, wherein the high heat comprises a temperature at or above 50° C.
Clause 28. The waste recycler of clause 23 or any of clauses 23-27, wherein the waste recycler, according to the enzyme-mediated waste processing cycle for processing the waste, cools, via the temperature control element, the waste during at least a portion of the enzyme-mediated waste processing cycle.
Clause 29. The waste recycler of clause 28 or any of clauses 23-28, wherein waste recycler cools the waste to reduce water evaporation during the enzyme-mediated waste processing cycle.
Clause 30. The method of clause 23 or any of clauses 23-29, wherein the vessel comprises a bucket.
Clause 31. The method of clause 30 or any of clauses 23-30, further comprising: grinding the waste via a grinding mechanism configured within the bucket.
Clause 32. The method of clause 23 or any of clauses 23-31, wherein the temperature control element comprises one or more of a heating element and a cooling element.
Clause 33. The method of clause 23 or any of clauses 23-32, wherein the enzyme is part of a hydrolase enzyme class.
Clause 34. The method of clause 23 or any of clauses 23-33, further comprising: modifying an existing waste processing cycle to generate the enzyme-mediated waste processing cycle or select the enzyme-mediated waste processing cycle from a plurality of waste processing cycles.
Clause 35. The method of clause 23 or any of clauses 23-34, wherein the enzyme is operable to biodegrade at least one of a biodegradable plastic, a compostable plastic, a petroleum plastic, fat, oil and grease.
Clause 36. The method of clause 35 or any of clauses 23-35, wherein the enzyme is operable to biodegrade food waste with fat content.
Clause 37. The method of clause 23 or any of clauses 23-36, wherein the enzyme comprises one or more of a lipases, proteases, proteinase K, PLA (Polylactic acid) depolymerase, esterase, cutinase, cellulases, amylases, lignases, proteinases, glucosidases, xylanases, peptidases, Phospholipases, chitinases, PLA, PHB (Poly(3-hydroxybutyrate)), PHA (Polyhydroxyalkanoate), PBS (Polybutylene succinate), PBSA (2-phenylbenzimidazole-5-sulfonic acid), and PBAT (polybutylene adipate terephthalate) depolymerase.
Clause 38. The method of clause 23 or any of clauses 23-37, wherein the waste recycler, according to the enzyme-mediated waste processing cycle for processing the waste, applies an air circulation characteristic.
Clause 39. The method of clause 38 or any of clauses 23-38, wherein the air circulation characteristic reduces air flow relative to a food-based processing cycle to maintain moisture in the waste for the enzyme to go into a solution and be operable to biodegrade materials in the waste.
Clause 40. The method of clause 23 or any of clauses 23-39, further comprising: selecting the enzyme-mediated waste processing cycle for processing the waste from a group of processing cycles comprising a first enzyme-mediated waste processing cycle for processing the waste when the waste includes plastics and a second enzyme-mediated waste processing cycle for processing the waste when the waste includes one of fat, oil and grease.
Clause 41. The method of clause 40 or any of clauses 23-40, wherein the plastics of the first enzyme-mediated waste processing cycle for processing the waste further comprises biodegradable plastic or compostable plastic and wherein the group of processing cycles further comprises a third enzyme-mediated waste processing cycle for processing the waste when the waste includes non-biodegradable plastics.
Clause 42. The method of clause 41 or any of clauses 23-41, wherein the group of processing cycles further comprises a third enzyme-mediated waste processing cycle for processing the waste when the waste includes a combination of two or more of waste food, biodegradable plastics, non-biodegradable plastics, fat, oil and grease.
Clause 43. The method of clause 23 or any of clauses 23-42, further comprising: receiving the indication that the enzyme will be added to the vessel for processing waste in the vessel based on data from a sensor that senses plastics, fat, oil or grease in the waste.
Clause 44. The method of clause 23 or any of clauses 23-43, further comprising: receiving user input, via a button, touch-sensitive screen, speech input, motion input, remote input, or multimodal input, providing the indication that the enzyme will be added to the vessel.
Clause 45. A waste recycler comprising: at least one processer; a vessel; a temperature control element; and a computer-readable storage medium storing instructions which, when executed by the at least one processor, cause the at least one processor to be configured to: determine, based on an indication, an enzyme-mediated waste processing cycle for processing a waste in the vessel, the vessel containing an enzyme of a hydrolase enzyme class; and process, via the temperature control element, the waste and the enzyme in the vessel according to the enzyme-mediated waste processing cycle.
Clause 46. The waste recycler of clause 45, wherein the enzyme is modified to have thermostable properties to remain stable at higher temperatures.
Clause 47. The waste recycler of clause 45 or any of clauses 45-46, wherein the enzyme is chosen to act on bioplastics, compostable plastics, petroleum-based plastics, single-use plastics, fats, oils and grease.
Clause 48. The waste recycler of clause 45 or any of clauses 45-47, wherein the enzyme comprises one or more of a lipases, a proteases, a proteinase K, a PLA (Polylactic acid) depolymerase, esterase, cutinase, cellulases, amylases, lignases, proteinases, glucosidases, xylanases, peptidases, Phospholipases, chitinases, PLA, PHB (Poly(3-hydroxybutyrate)), PHA (Polyhydroxyalkanoate), PBS (Polybutylene succinate), PBSA (2-phenylbenzimidazole-5-sulfonic acid), and PBAT (polybutylene adipate terephthalate) depolymerase. Enzyme-Based Waste Recycler Claim for Denaturing the Enzyme before the end of the Cycle
Clause 49. A waste recycler comprising: at least one processer; a vessel; a temperature control element; and a computer-readable storage medium storing instructions which, when executed by the at least one processor, cause the at least one processor to be configured to: receive an indication that an enzyme will be added to the vessel for processing waste in the vessel; and process, via the temperature control element, the waste and the enzyme in the vessel according to an enzyme-mediated waste processing cycle that manages a temperature of the waste to cause the enzyme to denature at a completion of the enzyme-mediated waste processing cycle.
Clause 50. The waste recycler of clause 49, wherein the temperature comprises at least 50° C.
Clause 51. The waste recycler of clause 49 or any of clauses 49-50, wherein the temperature of the waste is managed to be at an elevated value for a period of time according to a characteristic of the enzyme.
Clause 52. The waste recycler of clause 49 or any of clauses 49-51, wherein the temperature control element either heats up the waste to cause the enzyme to denature or allows natural heat from food waste in the waste to rise in temperature to denature the enzyme as part of the enzyme-mediated waste processing cycle.
Clause 53. A method of managing a waste recycler having a vessel and a temperature control element, the method comprising: receiving an indication that an enzyme will be added to the vessel for processing waste in the vessel; and processing, via the temperature control element, the waste and the enzyme in the vessel according to an enzyme-mediated waste processing cycle that manages a temperature of the waste to cause the enzyme to denature at a completion of the enzyme-mediated waste processing cycle.
Clause 54. The method of clause 53, wherein the temperature comprises at least 50° C.
Clause 55. The method of clause 53 or any of clauses 53-54, wherein the temperature of the waste is managed to be at an elevated value for a period of time according to a characteristic of the enzyme.
Clause 56. The method of clause 53 or any of clauses 53-55, wherein the temperature control element either heats up the waste to cause the enzyme to denature or allows natural heat from food waste in the waste to rise in temperature to denature the enzyme as part of the enzyme-mediated waste processing cycle.
Clause 57. A waste recycler comprising: at least one processer; a vessel; a hydrolase enzyme; and a computer-readable storage medium storing instructions which, when executed by the at least one processor, cause the at least one processor to be configured to: process waste in the vessel according to a waste processing cycle, wherein the waste comprises the hydrolase enzyme.
Clause 58. The waste recycler of clause 57, further comprising: a chemical additive, wherein the hydrolase enzyme including the chemical additive is configured to degrade food waste plus one or more of a biodegradable plastic, and non-biodegradable plastic, fats, oils and grease.
Clause 59. The waste recycler of clause 58 or any of clauses 57-58, wherein the chemical additive comprises one or more of calcium chloride, magnesium, iron, cobalt, potassium, zinc, and manganese.
Clause 60. The waste recycler of clause 57 or any of clauses 57-59, wherein the chemical additive comprises cations or anions as water soluble ions.
Clause 61. The waste recycler of clause 59 or any of clauses 57-60, wherein the hydrolase enzyme comprises one or more of a lipases, a proteases, a proteinase K, a PLA (Polylactic acid) depolymerase, esterase, cutinase, cellulases, amylases, lignases, proteinases, glucosidases, xylanases, peptidases, Phospholipases, chitinases, PLA, PHB (Poly(3-hydroxybutyrate)), PHA (Polyhydroxyalkanoate), PBS (Polybutylene succinate), PBSA (2-phenylbenzimidazole-5-sulfonic acid), and PBAT (polybutylene adipate terephthalate) depolymerase.
Clause 62. The waste recycler of clause 57 or any of clauses 57-61, wherein the hydrolase enzyme is configured in an enzyme solution including a chemical additive and is configured to degrade food waste and one or more of biodegradable plastic, compostable plastic, petroleum plastic, fats, oils and grease.
Clause 63. The waste recycler of clause 57 or any of clauses 57-62, wherein the hydrolase enzyme comprises a pH/acidic/alkaline stable enzyme that is configured to degrade food waste having a non-neutral pH level.
Clause 64. The waste recycler of clause 57 or any of clauses 57-63, wherein the hydrolase enzyme is configured such that an amount of buffer, a presence of a co-factor and an incubation time optimize enzyme-mediated degradation of plastics being processed by the waste recycler.
Clause 65. The waste recycler of clause 57 or any of clauses 57-64, wherein the computer-readable storage medium stores instructions which, when executed by the at least one processor, cause the at least one processor to be configured to: receive an indication that the hydrolase enzyme is in the waste; and select the waste processing cycle to process the waste with the hydrolase enzyme.
Clause 66. The waste recycler of clause 65 or any of clauses 57-65, further comprising: a temperature control element, wherein the waste recycler, according to the waste processing cycle for processing the waste, holds a temperature via the temperature control element for a pretreatment period of time for the hydrolase enzyme to start decomposing the waste.
Clause 67. The waste recycler of clause 65 or any of clauses 57-66, further comprising: a temperature control element, wherein the waste recycler, according to the waste processing cycle for processing the waste, delays an application of heating via the temperature control element as part of the waste processing cycle relative to a standard waste processing cycle.
Clause 68. The waste recycler of clause 65 or any of clauses 57-67, further comprising: a temperature control element, wherein the waste recycler, according to the waste processing cycle for processing the waste, adds via the temperature control element a high heat for a period of time at an end of the waste processing cycle to denature the hydrolase enzyme.
Clause 69. The waste recycler of clause 68 or any of clauses 57-68, wherein the high heat comprises a temperature at or above 50° C.
Clause 70. The waste recycler of clause 65 or any of clauses 57-69, wherein the waste recycler, according to the waste processing cycle for processing the waste, cools, via a temperature control element, the waste during at least a portion of the waste processing cycle.
Clause 71. The waste recycler of clause 70 or any of clauses 57-70, wherein waste recycler cools the waste to reduce water evaporation during the waste processing cycle.
Clause 72. The waste recycler of clause 65 or any of clauses 57-71, wherein the waste recycler, according to the waste processing cycle for processing the waste, applies an air circulation characteristic.
Clause 73. The waste recycler of clause 72 or any of clauses 57-72, wherein the air circulation characteristic reduces air flow relative to a food-based processing cycle to maintain moisture in the waste for the hydrolase enzyme to go into a solution and be operable to biodegrade materials in the waste.
Clause 74. A method of operating a waste recycler, the method comprising: receiving an indication that an enzyme will be added to a vessel of the waste recycler for processing waste in the vessel; selecting an enzyme-mediated waste processing cycle for processing the waste; and processing, via an airflow control element of the waste recycler, the waste and the enzyme in the vessel according to the enzyme-mediated waste processing cycle.
Clause 75. A waste recycler comprising: at least one processer; a vessel; an airflow control element; and a computer-readable storage medium storing instructions which, when executed by the at least one processor, cause the at least one processor to be configured to: receive an indication that an enzyme will be added to a vessel for processing waste in the vessel; select an enzyme-mediated waste processing cycle for processing the waste; and process, via the airflow control element, the waste and the enzyme in the vessel according to the enzyme-mediated waste processing cycle.
Clause 76: A waste recycler comprising: one or more of: means for receiving an indication that an enzyme will be added to the vessel for processing waste in the vessel; means for selecting an enzyme-mediated waste processing cycle for processing the waste; and means for processing, via an airflow control element, the waste and the enzyme in the vessel according to the enzyme-mediated waste processing cycle.
Clause 77: A computer-readable storage medium stores instructions which, when executed by at least one processor, cause the at least one processor to be configured to: receive an indication that an enzyme will be added to the vessel for processing waste in the vessel; select an enzyme-mediated waste processing cycle for processing the waste; and process, via an airflow control element, the waste and the enzyme in the vessel according to the enzyme-mediated waste processing cycle.
Clause 78: A waste recycler comprising: at least one processer; a vessel; an airflow control element; and a computer-readable storage medium storing instructions which, when executed by the at least one processor, cause the at least one processor to be configured to: determine, based on an indication, an enzyme-mediated waste processing cycle for processing a waste in the vessel, the vessel containing an enzyme of a hydrolase enzyme class; and process, via the airflow control element, the waste and the enzyme in the vessel according to the enzyme-mediated waste processing cycle.

### Enzyme Pod Clauses

Clause 1. A pod comprising: a first cavity defined by a first material and containing a buffer solution or an anhydrous material; and a second cavity defined by a second material and containing an enzyme solution or lyophilized enzyme that breaks down bioplastics, wherein the first material and the second material are configured to release the buffer component and the enzyme component according to a food recycling process implemented in a food recycler.
Clause 2. The pod of clause 1, wherein the food recycling process comprises a heating portion and wherein the first cavity and the second cavity release the buffer solution or the anhydrous material and the enzyme solution or the lyophilized enzyme according to heat applied in the heating portion of the food recycling process.
Clause 3. The pod of clause 1, wherein the food recycling process comprises a grinding portion and wherein the first cavity and the second cavity release the buffer solution or the anhydrous material and the enzyme solution or the lyophilized enzyme according to when the grinding portion of the food recycling process begins.
Clause 4. The pod of clause 1, wherein first materials dissolves to release the buffer solution or the anhydrous material at a different time that the second material dissolves to release the enzyme solution.
Clause 5. The pod of clause 1, wherein the first cavity contains between 1-20 cm² of buffer solution or anhydrous material and the second cavity contains between 1-20 cm² of enzyme solution/lyophilized enzyme or other additives as a co-factor with the buffer.
Clause 6. A method comprising: receiving, in a bucket of a recycler, a hydrolytic pouch comprising a first cavity containing a buffer solution or an anhydrous material and a second cavity containing an enzyme solution; receiving food waste in the bucket of the recycler; receiving bioplastics in the bucket of the recycler; causing the hydrolytic pouch to release the buffer solution or the anhydrous material and the enzyme solution or the lyophilized enzyme into the bucket; breaking down the bioplastics via the enzyme solution; and processing the bioplastics and the food waste in the bucket of the recycler according to a processing algorithm.
Clause 7. The method of clause 6, further comprising receiving user input via a user interface of the recycler and wherein the processing of the bioplastics is performed according to data received from a user via the user interface.
Clause 8. The method of clause 6, wherein the processing algorithm is modified based on the receiving of the bioplastics in the bucket of the recycler.
Clause 9. A method comprising: receiving, in a bucket of a recycler, waste; determining from a sensor configured in the recycler that at least a portion of the waste includes bioplastics; causing, based on the inclusion of the bioplastic in the bucket and via a control system of the recycler, a release into the bucket of an enzyme solution or the lyophilized enzyme stored in a container configured within the recycler; breaking down the bioplastics in the bucket via the enzyme solution; and processing the bioplastics in the bucket of the recycler according to a processing algorithm.
Clause 10. The method of clause 9, further comprising: modifying the processing algorithm based on the determining that the bioplastics are found in the bucket.
Clause 11. The method of clause 9, further comprising: causing, based on the determining that the bioplastics are found in the bucket and via the control system of the recycler, a release into the bucket of a buffer solution or an anhydrous material stored in a buffer container configured within the recycler.
Clause 12. A recycler comprising: a processer; a computer-readable storage device; a bucket; a grinding mechanism configured within the bucket; a heating element; a storage container containing an enzyme solution; and a sensor connected to the processor, wherein the computer-readable storage device stores instructions for controlling the processor to perform operations comprising: determining from the sensor configured in the recycler that at least a portion of a waste deposited in the bucket includes bioplastics to yield a determination; causing, based on determination indicating the bioplastics are in the bucket, a release into the bucket of an enzyme solution or the lyophilized enzyme stored in the storage container such that the bioplastics in the bucket are broken down by the enzyme solution; and processing, via the grinding mechanism and the heating element, the bioplastics in the bucket of the recycler according to a processing algorithm.
Clause 13. A method comprising: receiving data indicating that bioplastics are included in a batch of waste received in a bucket of a recycler; modifying, based on the data, a food recycling algorithm stored in a control system of the recycler to yield a modified recycling algorithm; causing, based on the modified recycling algorithm, a release into the bucket of an enzyme solution or a lyophilized enzyme stored in a container configured within the recycler, the enzyme solution or the lyophilized enzyme causing a breakdown of the bioplastics in the bucket; and processing the bioplastics in the bucket of the recycler according to the modified recycling algorithm.
Clause 14. The method of clause 13, wherein the data is received from a user via a user interface or sensed via a sensor configured in the recycler.
Clause 15. The method of clause 13, further comprising: causing, based on the modified recycling algorithm, a release into the bucket of a buffer solution or an anhydrous material stored in a second container configured within the recycler.
Clause 16. The method of clause 13, wherein the container is configured in one of a lid of the recycler and a housing of the recycler.
Clause 17. The method of clause 13, wherein a control system in the recycler causes an enzyme delivery system to release the enzyme solution.
Clause 18. A system comprising: a processer; a computer-readable storage device; a bucket; a grinding mechanism configured within the bucket; and a storage container containing an enzyme solution, wherein the computer-readable storage device stores instructions for controlling the processor to perform operations comprising: receiving data indicating that bioplastics are included in a batch of waste received in a bucket of a recycler; modifying, based on the data, a food recycling algorithm stored in a control system of the recycler to yield a modified recycling algorithm; causing, based on the modified recycling algorithm, a release into the bucket of one or more of a buffer solution or an anhydrous material and an enzyme solution or a lyophilized enzyme stored in the storage container, the enzyme solution or the lyophilized enzyme causing a breakdown of the bioplastics in the bucket; and processing the bioplastics in the bucket of the recycler according to the modified recycling algorithm.
Clause 19. The system of clause 18, wherein the storage container is configured within one of a lid of the system and a housing of the system.
Clause 20. The system of clause 18, wherein the modified recycling algorithm causes the system to process waste comprising food waste and the bioplastics in the bucket.

We claim:

1. A waste recycler comprising:
at least one processer;
a vessel;
a temperature control element; and
a computer-readable storage medium storing instructions which, when executed by the at least one processor, cause the at least one processor to be configured to:
receive an indication that an enzyme will be added to the vessel for processing waste in the vessel;
select an enzyme-mediated waste processing cycle for processing the waste; and
process, via the temperature control element, the waste and the enzyme in the vessel according to the enzyme-mediated waste processing cycle.

2. The waste recycler of claim 1, wherein the vessel comprises a bucket.

3. The waste recycler of claim 2, further comprising:
a grinding mechanism configured within the bucket.

4. The waste recycler of claim 1, wherein the temperature control element comprises one or more of a heating element and a cooling element.

5. The waste recycler of claim 1, wherein the enzyme is part of a hydrolase enzyme class.

6. The waste recycler of claim 1, wherein the computer-readable storage medium stores instructions which, when executed by the at least one processor, cause the at least one processor to be configured to:
modify an existing waste processing cycle to generate the enzyme-mediated waste processing cycle or select the enzyme-mediated waste processing cycle from a plurality of waste processing cycles.

7. The waste recycler of claim 1, wherein the enzyme is operable to biodegrade at least one of a biodegradable plastic, a compostable plastic, a petroleum-based plastic, fat, oil and grease.

8. The waste recycler of claim 1, wherein the enzyme is operable to biodegrade food waste with fat content.

9. The waste recycler of claim 1, wherein the enzyme comprises one or more of a lipases, proteases, proteinase K, PLA (Polylactic acid) depolymerase, esterase, cutinase, cellulases, amylases, lignases, proteinases, glucosidases, xylanases, peptidases, Phospholipases, chitinases, PLA, PHB (Poly(3-hydroxybutyrate)), PHA (Polyhydroxyalkanoate), PBS (Polybutylene succinate), PBSA (2-phenylbenzimidazole-5-sulfonic acid), and PBAT (polybutylene adipate terephthalate) depolymerase.

10. The waste recycler of claim 1, wherein the waste recycler, according to the enzyme-mediated waste processing cycle for processing the waste, holds a temperature via the temperature control element for a pretreatment period of time for the enzyme to start decomposing the waste.

11. The waste recycler of claim 1, wherein the waste recycler, according to the enzyme-mediated waste processing cycle for processing the waste, delays an application of heating via the temperature control element as part of the enzyme-mediated waste processing cycle relative to a standard waste processing cycle.

12. The waste recycler of claim 1, wherein the waste recycler, according to the enzyme-mediated waste processing cycle for processing the waste, adds via the temperature control element a high heat for a period of time at an end of the enzyme-mediated waste processing cycle to denature the enzyme.

13. The waste recycler of claim 12, wherein the high heat comprises a temperature at or above 50° C.

14. The waste recycler of claim 1, wherein the waste recycler, according to the enzyme-mediated waste processing cycle for processing the waste, cools, via the temperature control element, the waste during at least a portion of the enzyme-mediated waste processing cycle.

15. The waste recycler of claim 14, wherein waste recycler cools the waste to reduce water evaporation during the enzyme-mediated waste processing cycle.

16. The waste recycler of claim 1, wherein the waste recycler, according to the enzyme-mediated waste processing cycle for processing the waste, applies an air circulation characteristic.

17. The waste recycler of claim 16, wherein the air circulation characteristic reduces air flow relative to a food-based processing cycle to maintain moisture in the waste for the enzyme to go into a solution and be operable to biodegrade materials in the waste.

18. The waste recycler of claim 1, wherein the computer-readable storage medium stores instructions which, when executed by the at least one processor, cause the at least one processor to be configured to:
select the enzyme-mediated waste processing cycle for processing the waste from a group of processing cycles comprising a first enzyme-mediated waste processing cycle for processing the waste when the waste includes a biodegradable plastic, a compostable plastic, or a petroleum-based plastic, and a second enzyme-mediated waste processing cycle for processing the waste when the waste includes one of fat, oil and grease.

19. The waste recycler of claim 18, wherein the plastics of the first enzyme-mediated waste processing cycle for processing the waste further comprises a biodegradable plastic, a compostable plastic, or a petroleum-based plastic and wherein the group of processing cycles further comprises a third enzyme-mediated waste processing cycle for processing the waste when the waste includes non-biodegradable plastics.

20. The waste recycler of claim 19, wherein the group of processing cycles further comprises a third enzyme-mediated waste processing cycle for processing the waste when the waste includes a combination of two or more of waste food, a biodegradable plastic, a compostable plastic, a petroleum-based plastic, fat, oil and grease.

21. The waste recycler of claim 1, wherein the computer-readable storage medium stores instructions which, when executed by the at least one processor, cause the at least one processor to be configured to:
receive the indication that the enzyme will be added to the vessel for processing waste in the vessel based on data from a sensor that senses plastics, fat, oil or grease in the waste.

22. The waste recycler of claim 1, wherein the computer-readable storage medium stores instructions which, when executed by the at least one processor, cause the at least one processor to be configured to:
receive user input, via a button, touch-sensitive screen, speech input, motion input, remote input, or multimodal input, providing the indication that the enzyme will be added to the vessel.

23. A method of operating a waste recycler that receives an enzyme in a vessel containing waste, wherein the enzyme causes a breakdown of at least part of the waste in the vessel, the method comprising:
receiving an indication that an enzyme will be added to the vessel for processing waste in the vessel;
selecting an enzyme-mediated waste processing cycle for processing the waste; and
processing, via a temperature control element of the waste recycler, the waste and the enzyme in the vessel according to the enzyme-mediated waste processing cycle.

24. The waste recycler of claim 23, wherein the waste recycler, according to the enzyme-mediated waste processing cycle for processing the waste, holds a temperature via the temperature control element for a pretreatment period of time for the enzyme to start decomposing the waste.

25. The waste recycler of claim 23, wherein the waste recycler, according to the enzyme-mediated waste processing cycle for processing the waste, delays an application of heating via the temperature control element as part of the enzyme-mediated waste processing cycle relative to a standard waste processing cycle.

26. The waste recycler of claim 23, wherein the waste recycler, according to the enzyme-mediated waste processing cycle for processing the waste, adds via the temperature control element a high heat for a period of time at an end of the enzyme-mediated waste processing cycle to denature the enzyme.

27. The waste recycler of claim 26, wherein the high heat comprises a temperature at or above 50° C.

28. The waste recycler of claim 23, wherein the waste recycler, according to the enzyme-mediated waste processing cycle for processing the waste, cools, via the temperature control element, the waste during at least a portion of the enzyme-mediated waste processing cycle.

29. The waste recycler of claim 28, wherein waste recycler cools the waste to reduce water evaporation during the enzyme-mediated waste processing cycle.

30. The method of claim 23, wherein the vessel comprises a bucket.

31. The method of claim 30, further comprising:
grinding the waste via a grinding mechanism configured within the bucket.

32. The method of claim 23, wherein the temperature control element comprises one or more of a heating element and a cooling element.

33. The method of claim 23, wherein the enzyme is part of a hydrolase enzyme class.

34. The method of claim 23, further comprising:
modifying an existing waste processing cycle to generate the enzyme-mediated waste processing cycle or select the enzyme-mediated waste processing cycle from a plurality of waste processing cycles.

35. The method of claim 23, wherein the enzyme is operable to biodegrade at least one of a biodegradable plastic, a compostable plastic, a petroleum plastic, fat, oil and grease.

36. The method of claim 35, wherein the enzyme is operable to biodegrade food waste with fat content.

37. The method of claim 23, wherein the enzyme comprises one or more of a lipases, proteases, proteinase K, PLA (Polylactic acid) depolymerase, esterase, cutinase, cellulases, amylases, lignases, proteinases, glucosidases, xylanases, peptidases, Phospholipases, chitinases, PLA, PHB (Poly(3-hydroxybutyrate)), PHA (Polyhydroxyalkanoate), PBS (Polybutylene succinate), PBSA (2-phenylbenzimidazole-5-sulfonic acid), and PBAT (polybutylene adipate terephthalate) depolymerase.

38. The method of claim 23, wherein the waste recycler, according to the enzyme-mediated waste processing cycle for processing the waste, applies an air circulation characteristic.

39. The method of claim 38, wherein the air circulation characteristic reduces air flow relative to a food-based processing cycle to maintain moisture in the waste for the enzyme to go into a solution and be operable to biodegrade materials in the waste.

40. The method of claim 23, further comprising:
selecting the enzyme-mediated waste processing cycle for processing the waste from a group of processing cycles comprising a first enzyme-mediated waste processing cycle for processing the waste when the waste includes plastics and a second enzyme-mediated waste processing cycle for processing the waste when the waste includes one of fat, oil and grease.

41. The method of claim 40, wherein the plastics of the first enzyme-mediated waste processing cycle for processing the waste further comprises biodegradable plastic or compostable plastic and wherein the group of processing cycles further comprises a third enzyme-mediated waste processing cycle for processing the waste when the waste includes non-biodegradable plastics.

42. The method of claim 41, wherein the group of processing cycles further comprises a third enzyme-mediated waste processing cycle for processing the waste when the waste includes a combination of two or more of waste food, biodegradable plastics, non-biodegradable plastics, fat, oil and grease.

43. The method of claim 23, further comprising:
receiving the indication that the enzyme will be added to the vessel for processing waste in the vessel based on data from a sensor that senses plastics, fat, oil or grease in the waste.

44. The method of claim 23, further comprising:
receiving user input, via a button, touch-sensitive screen, speech input, motion input, remote input, or multimodal input, providing the indication that the enzyme will be added to the vessel.

45. A waste recycler comprising:
at least one processer;
a vessel;
a temperature control element; and
a computer-readable storage medium storing instructions which, when executed by the at least one processor, cause the at least one processor to be configured to:
determine, based on an indication, an enzyme-mediated waste processing cycle for processing a waste in the vessel, the vessel containing an enzyme of a hydrolase enzyme class; and
process, via the temperature control element, the waste and the enzyme in the vessel according to the enzyme-mediated waste processing cycle.

46. The waste recycler of claim 45, wherein the enzyme is modified to have thermostable properties to remain stable at higher temperatures.

47. The waste recycler of claim 45, wherein the enzyme is chosen to act on bioplastics, compostable plastics, petroleum-based plastics, single-use plastics, fats, oils and grease.

48. The waste recycler of claim 45, wherein the enzyme comprises one or more of a lipases, a proteases, a proteinase K, a PLA (Polylactic acid) depolymerase, esterase, cutinase, cellulases, amylases, lignases, proteinases, glucosidases, xylanases, peptidases, Phospholipases, chitinases, PLA, PHB (Poly(3-hydroxybutyrate)), PHA (Polyhydroxyalkanoate), PBS (Polybutylene succinate), PBSA (2-phenylbenzimidazole-5-sulfonic acid), and PBAT (polybutylene adipate terephthalate) depolymerase.
